(19) United States
(12) Patent Application Publication
(10) Pub. No.: US 2025/0039643 A1
(43) Pub. Date: Jan. 30, 2025

(54) DIGITAL ASSET LOCATION AND VERIFICATION SYSTEM

(71) Applicant: Oshkosh Corporation, Oshkosh, WI (US)

(72) Inventors: David C. Loda, Oshkosh, WI (US); Jacob Klaameyer, Oshkosh, WI (US); Zachary LeMahieu, Oshkosh, WI (US); Robby Lamers, Oshkosh, WI (US); Alex Rotello, Spartanburg, SC (US); Randall Jahnke, Oshkosh, WI (US)

(73) Assignee: Oshkosh Corporation, Oshkosh, WI (US)

(21) Appl. No.: 18/913,787

(22) Filed: Oct. 11, 2024

Related U.S. Application Data
(63) Continuation-in-part of application No. 18/232,049, filed on Aug. 9, 2023.
(60) Provisional application No. 63/544,102, filed on Oct. 13, 2023.
(60) Provisional application No. 63/396,807, filed on Aug. 10, 2022.

(51) Int. Cl. H04W 4/029; G05D 1/60; G05D 105/80; G05D 107/70; G05D 111/10; G06V 20/52; H04B 17/318

(52) U.S. Cl. CPC H04W 4/029; G05D 1/60; G06V 20/52; H04B 17/318; G05D 2105/93; G05D 2107/70; G05D 2111/10

(57) ABSTRACT

A system for locating an asset on a worksite includes one or more processing circuits configured to receive a stored location of a tracking tag, capture data of a field of view including the stored location, determine, based on the data, if an asset is present in the field of view, upon determining that the asset is present in the field of view, compare the stored location to a calculated location of the asset, upon determining that the stored location is different than the calculated location, at least one of (i) update the stored location to be the calculated location or (ii) provide an indication of a difference between the stored location and the calculated location, and upon determining that the asset is missing from in the field of view, generate an indication indicating that the asset is missing from the field of view.

### CROSS-REFERENCE TO RELATED PATENT APPLICATIONS

The present application (a) is a continuation-in-part of U.S. patent application Ser. No. 18/232,049, filed Aug. 9, 2023, which claims the benefit of and priority to U.S. Provisional Patent Application No. 63/396,807, filed on Aug. 10, 2022, and (b) claims the benefit of and priority to U.S. Provisional Patent application No. 63/544, 102, filed Oct. 13, 2023, each of which is hereby incorporated by reference in its entirety.

### BACKGROUND

Work equipment such as lifts and telehandlers, as well as smaller devices including generators, power tools, and unpowered implements sometimes require tracking, tasking, monitoring, and servicing at a manufacturing facility or worksite. Tracking the locations of finished products, components, subassemblies, specialized tooling, and the like can improve the efficiency of manufacturing and other operations. Managers and workers typically rely on memory, work instructions, discrete systems, applications, and methods to perform these functions for each asset or piece of equipment. Additionally, the distribution of tools, assets, and equipment, as well as the location of individuals who need to use said equipment in the workplace, is in a constant state of flux, resulting in significant loss of efficiency as much time is wasted searching for the appropriate items.

### SUMMARY

One embodiment relates to a system for locating an asset on a worksite. The system includes one or more processing circuits configured to receive a stored location of a tracking tag, capture data of a field of view including the stored location, determine, based on the data, if an asset is present in the field of view, upon determining that the asset is present in the field of view, compare the stored location to a calculated location of the asset, and upon determining that the stored location is different than the calculated location, at least one of (i) update the stored location to be the calculated location or (ii) provide an indication of a difference between the stored location and the calculated location.

Another embodiment relates to a system for locating an asset on a worksite. The system includes one or more processing circuits comprising one or more memory devices coupled to one or more processors, the one or more memory devices configured to store instructions thereon that, when executed by the one or more processors, cause the one or more processors to receive a stored location of a tracking tag, capture data from a plurality of vision agents of a field of view including the stored location, the data including a characteristic indicative of a presence or absence of an asset in the field of view, determine, based on the characteristic, if the asset is present in the field of view, upon determining that the asset is present in the field of view, compare the stored location to a calculated location of the asset, and upon determining that the stored location is different than the calculated location, update the stored location to be the calculated location and provide an indication of a difference between the stored location and the calculated location.

Still another embodiment relates to a system for locating an asset on a worksite. The system includes a non-transitory computer-readable medium having instructions stored thereon that, when executed by one or more processors, cause the one or more processors to receive a stored location of a tracking tag, capture data from a plurality of vision agents of a field of view including the stored location, the data including a characteristic indicative of a presence or absence of an asset in the field of view, determine, based on the characteristic, if the asset is present in the field of view, upon determining that the asset is present in the field of view, compare the stored location to a calculated location of the asset, and upon determining that the stored location is different than the calculated location, at least one of (i) update the stored location to be the calculated location or (ii) provide an indication of a difference between the stored location and the calculated location.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a schematic representation of an asset management system, according to some embodiments.

FIG. 2 is a schematic representation of an asset management system, according to some embodiments.

FIG. 3 is a schematic representation of an asset management system, according to some embodiments.

FIG. 4 is an image of two tracking tag assemblies, according to some embodiments.

FIG. 5 is an image of a wrench including one of the tracking tag assemblies of FIG. 4, according to some embodiments.

FIG. 6 is an image of the wrench of FIG. 5.

FIG. 7 is an image of an asset management system gateway mounted on a column, according to some embodiments.

FIG. 8 is an image of asset management system sensor nodes, according to some embodiments.

FIG. 9 is an image of a LoRa WAN sensor, according to some embodiments.

FIG. 10 is an image of various components of an asset management system, according to some embodiments.

FIG. 11 is an image of a high-temperature tracking tag assembly, according to some embodiments.

FIGS. 12-22 are images of a smartphone operating an asset management system application, according to some embodiments.

FIGS. 23-25 are representations of graphical user interface dashboards displayed within an asset management system application, according to some embodiments.

FIG. 26 is a representation of the location timeline and a heatmap of an asset in an asset management system, according to some embodiments.

FIG. 27 is a representation of a longer-range outdoor tracking display in an asset management system, according to some embodiments.

FIGS. 28-32 are representations of graphical user interfaces within an asset management system application, according to some embodiments.

FIG. 33 is a flow diagram of a method 3300 of locating an asset, according to some embodiments.

FIG. 34 is a flow diagram of a method 3400 of moving an asset, according to some embodiments.

FIG. 35 is a flow diagram of a method 3500 of receiving location-based work instructions, according to some embodiments.

FIG. 36 is a flow diagram of a method 3600 of generating an asset tracking heatmap, according to some embodiments.

FIGS. 37-50 are schematic representations of asset management systems, according to some embodiments.

FIG. 51 is a diagram representing the features of an asset management system, according to some embodiments.

FIG. 52 is a schematic representation of an asset management system, according to some embodiments.

FIG. 53 is a schematic representation of an asset management system, according to some embodiments.

FIG. 54 is a schematic block diagram of a vision system, according to some embodiments.

FIGS. 55-59 are various schematic representations of the asset management system of FIG. 52 including one or more vision agents, according to some embodiments.

### DETAILED DESCRIPTION

Industrial assets can often be difficult to find and keep track of on large worksites. It is therefore desirable to provide a means to electronically track assets on a worksite and integrate, tasking, monitoring, and service support functions on a common platform to improve efficiency and reduce costs.

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

One exemplary implementation of the present disclosure relates to system and methods for tracking and managing the geolocation of tagged or untagged industrial assets such as parts, tooling, components, assemblies, products, or vehicles using various wireless tracking technologies. Asset management dashboards and tools are provided on a unified on-premises or cloud-based information technology portal architecture. A digital ecosystem for an asset positioning system is provided, which is capable of tracking any item in real-time, recording past locations, and leveraging artificial intelligence to predict future movements and behavior patterns.

The assets may be tagged with a tracking tag configured to communicate with (e.g., transmit signals to) one or more sensors such that, based on the communication, a vision system is configured to determine a location of the tracking tag. The location of the tracking tag may be indicative of the location of the asset when the tracking tag is coupled with the asset. In some embodiments, the tracking tag may inadvertently detach or other wise be separated from the asset (e.g., during transportation, manufacturing, operation, etc. of the asset). The separation of the tracking tag from the asset may cause a discrepancy in the location of the tracking tag and the true location of the asset. Because of the discrepancy between the locations of the asset and the tracking tag, the vision system may determine, based on the location of the tracking tag in a respective location (e.g., a stored location of the tracking tag or a detected location of the tracking tag), that the asset is located in the respective location when in reality, the location of the asset is not located in the respective location. In such an example, the vision system may undesirably determine that the asset is present in the respective location when in reality, the asset is not present in the respective location. To correct the undesirable determination that the asset is present in the respective location as a result of the tracking tag being separated from the asset, the vision system is configured to verify whether the asset is or is not located in the same location as the detected location of the tracking tag using an asset verification module. The asset verification module may be configured to determine, based on the data acquired from the sensors, a characteristic such as an object detection, an infrared detection, an audible sound detection, or some other electromagnetic spectrum detection, whether the asset is located within a field of view including the respective location of the tracking tag. Upon determining that the asset is present in the field of view, the vision system may compare the respective location of the tracking tag to a calculated location of the asset. Upon determining that the respective location of the tracking tag is different than the calculated location, the vision system may (i) update the respective location of the tracking tag (e.g., the stored location) to be the calculated location or (ii) provide an indication of a difference between the respective location of the tracking tag and the calculated location. The vision system may determine that the asset is not located at the respective location when the asset is not detected (e.g., using the asset verification module) at the respective location, but the tracking tag indicates that the asset is located at the respective location, thereby preventing a false-positive when the tracking tag is separated from the asset. In some embodiments, the vision system includes one or more vision agents including the one or more sensors and configured to monitor the worksite and acquire data used by the vision system to detect and verify the location of the asset. By way of example, the vision agents may include an aerial drone, a ground vehicle, a robotic quadruped, a robotic biped, etc. In such an example, the vision agents may be configured to autonomously navigate throughout the worksite to acquire the data. By way of another example, the vision agents may include stationary cameras such as security cameras variously positioned throughout the worksite and/or body cameras worn by a user (e.g., a security guard, an employee, etc.) and configured to acquire the data as the user navigates throughout the worksite.

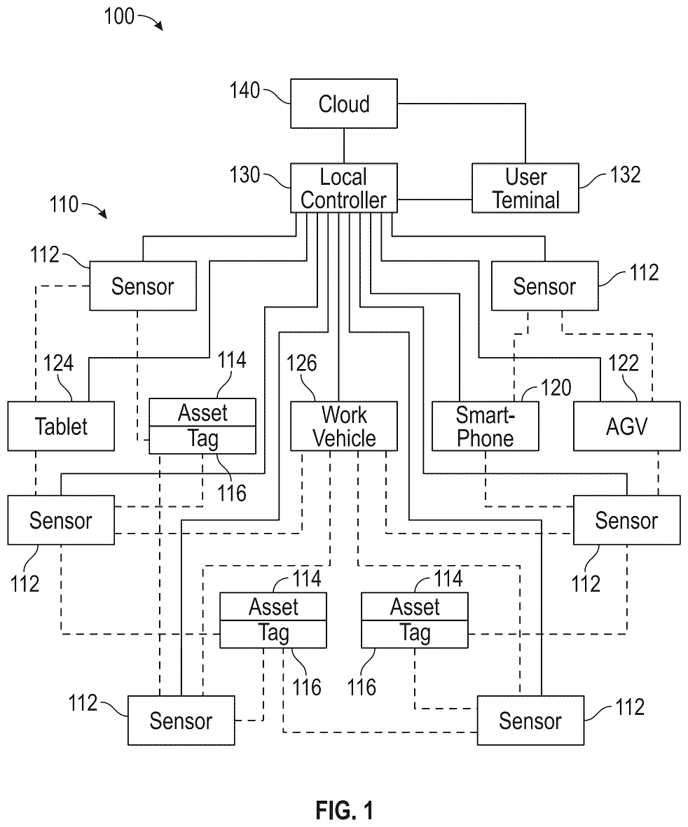

Referring now to FIG. 1, an asset management system 100 is shown, according to some embodiments. The asset management system 100 includes an asset location system 110 including an array of asset sensors 112 (e.g., nodes, sensor nodes, etc.). The sensors 112 are each configured to detect signals from assets on a worksite, such as a factory, warehouse, or construction site. For example, the sensors 112 may detect tracking tags 116 coupled to various assets 114, such as hand tools, workpieces, vehicles, user devices, or any other object to which a tracking tag may be coupled. Each tracking tag 116 emits a signal, such as a radio-frequency identification (RFID) signal or Bluetooth Low Energy (BLE) signal, which can be detected by the sensors 112. The sensors 112 may detect a strength (e.g., may determine a received signal strength indicator or RSSI) of the signal from the tracking tag 116, which can be used to determine the distance from the tracking tag to the sensors 112. When multiple sensors 112 detect a tracking tag 116, the locations of the sensors 112 and the determined distance from each sensor 112 to the tracking tag 116 may be used to determine the specific location of the tracking tag 116, thereby determining the location of the asset 114. The sensors 112 may also detect other assets that include integrated transmitters and therefore do not require a tracking tag 116. For example, the sensors may be able to detect smartphones 120, AGVs 122, tablets 124, and work vehicles 126. Tracking tags 116 may also be used to track employees or other people on a job site. For example, an employee name badge may include a tracking tag 116 such that the employee's movements can be tracked across a jobsite so that the employee can be located quickly and analysis can be performed to assess productivity.

The sensors 112 may be communicatively coupled to a local controller 130 and/or the cloud 140 (e.g., an offsite computing and server system). In some embodiments, the sensors 112 may communicate with the local controller 130, which in turn may communicate with the cloud 140. In some embodiments, the sensors may transmit sensor data to gateways, which relay the data to the local controller 130 and/or the cloud 140. A user may access system information and perform control functions via a user terminal 132. The local controller may be configured to perform processing functions including determining the locations of assets based on data from the sensors. The local controller 130 and/or the cloud 140 may communicate directly with smart assets (e.g., smartphones 120, AGVs 122, tablets 124, work vehicles 126, etc.) that can connect to the asset management system, for example, via Wi-Fi or a cellular connection. Thus, the local controller 130 can receive data from the sensors 112, determine the locations of various assets, and relay the send the locations to, for example, a smartphone 120 or a tablet 124. A user on the job site can then locate the asset using the smart device. In some embodiments, the system 100 may not include a wired user terminal 132, and users may perform control functions via smart devices such as a smartphone 120 or tablet 124 by wirelessly connecting to the local controller. In some embodiments, the system 100 may not include a local controller 130, and processing functions may be performed on the smartphone 120 or tablet 124 rather than the local controller 130. For example, the smartphone 120, may receive data from the sensors 112 (e.g., via a Wi-Fi router) and the smartphone 120 may be configured (e.g., via software installed on the smartphone 120) to determine the locations of the assets 114 and display the results on the display screen.

In some embodiments, the local controller 130, the sensors 112, and/or the smart devices may include machine or computer-readable media that is executable by a processor to perform the functions of the asset management system 100. As described herein and amongst other uses, the machine-readable media facilitate performance of certain operations to enable reception and transmission of data. For example, the machine-readable media on the local controller 130 may provide an instruction (e.g., command, etc.) to, e.g., acquire data from the sensors 112. In this regard, the machine-readable media may include programmable logic that defines the frequency of acquisition of the data (or, transmission of the data). The computer-readable media may include code, which may be written in any programming language including, but not limited to, Java or the like and any conventional procedural programming languages, such as the “C” programming language or similar programming languages. The computer-readable program code may be executed on one or more processors, local and/or remote. Remote processors may be connected to each other through any type of network (e.g., CAN bus, etc.).

In some embodiments, the local controller 130 may be embodied as hardware units, such as electronic control units. As such, the local controller 130 may be embodied as one or more circuitry components including, but not limited to, processing circuitry, network interfaces, peripheral devices, input devices, output devices, sensors, etc. In some embodiments, the local controller 130 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the local controller 130 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The local controller 130 may also include programmable hardware devices such as field programmable gate arrays, programmable array logic, programmable logic devices or the like. The local controller 130 may include one or more memory devices for storing instructions that are executable by the processor(s) of the local controller 130. In some hardware unit configurations, the local controller 130 may be geographically dispersed throughout separate locations in various hardware components. Alternatively, the local controller 130 may be embodied in or within a single unit or housing.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the local controller 130 may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory devices (e.g., memory, memory unit, storage device) used to store instructions for the local controller 130, sensors 112, and/or smart devices may include one or more devices (e.g., RAM, ROM, Flash memory, hard disk storage) for storing data and/or computer code for completing or facilitating the various processes, layers, and modules described in the present disclosure. The memory device may be communicably connected to the processor to provide computer code or instructions to the processor for executing at least some of the processes described herein. Moreover, the memory device may be or include tangible, non-transient volatile memory or non-volatile memory. Accordingly, the memory device may include database components, object code components, script components, or any other type of information structure for supporting the various activities and information structures described herein.

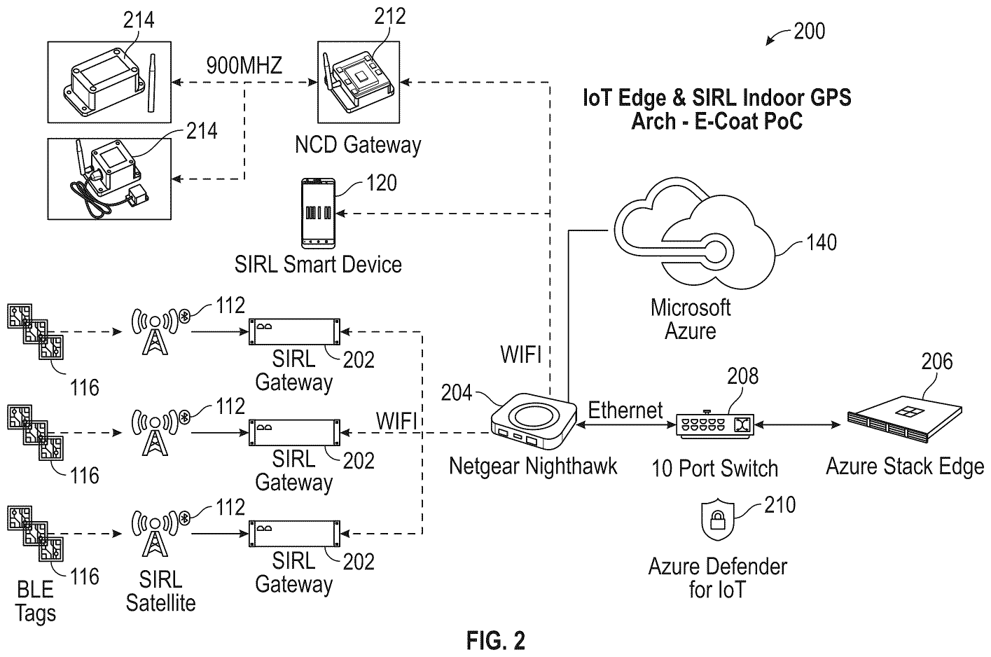

Referring now to FIG. 2, another asset management system 200 (e.g., similar to asset management system 100) is shown, according to some embodiments. Similar to the system 100, the asset management system 200 includes an array of sensors 112 for detecting tracking tags 116 or other radio communication-enabled devices. The system 200 includes several gateways 202 to which the sensors 112 transmit sensor data. Each gateway 202 may be coupled to any number of sensors 112. The gateways 202 are communicatively coupled to a Wi-Fi router 204. The Wi-Fi router 204 may be further communicatively coupled to the cloud 140 (e.g., a cloud computing service such as Microsoft Azure) as well as a local cloud storage gateway 206 (e.g., a Microsoft Azure Stack Edge) that enables redundant local storage and transmission of data to the cloud 140. The Wi-Fi router 204 may be coupled to the local cloud storage gateway 206 via a switch 208 enabled with anti-malware software 210. The Wi-Fi router 204 may also be coupled to a long-range IoT gateway 212. The IoT gateway 212 may communicate with and receive signals from off-site IoT sensors 214. The Wi-Fi router 204 may also be coupled to smart devices such as smartphone 120.

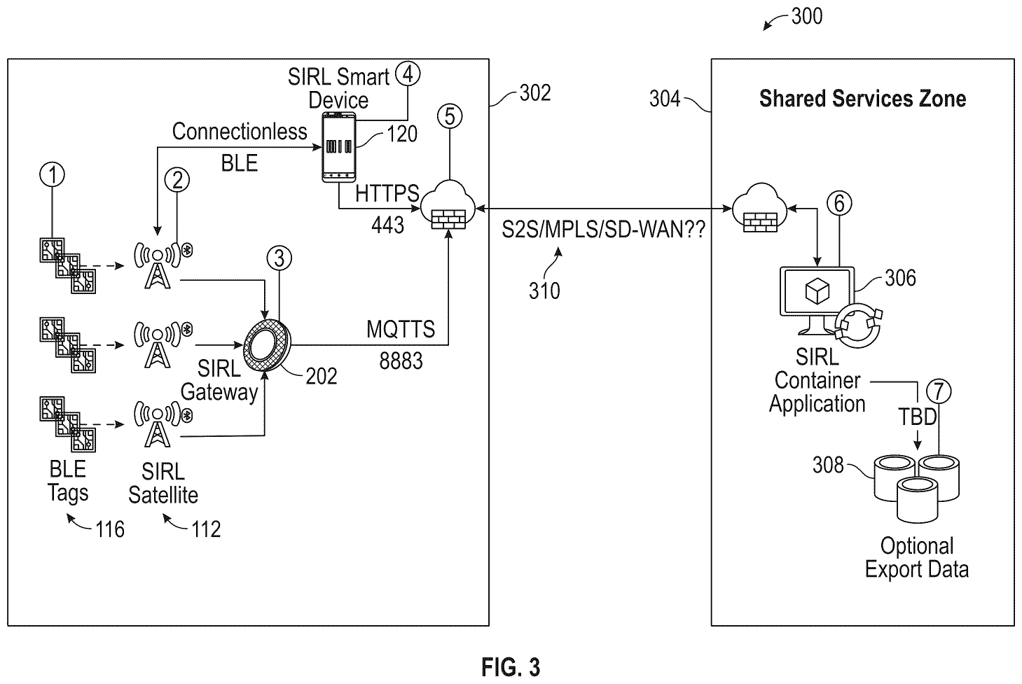

Referring now to FIG. 3, another asset management system 300 (e.g., similar to asset management systems 100, 200) is shown, according to some embodiments. The system 300 shows a worksite 302 (e.g., a first location) including a network of sensors 112 that detect tracking tags 116 and feed sensor data to a gateway 202. The worksite 302 also includes a smartphone 120 enabling user interaction with the system 300. The system 300 includes a shared services site 304 (e.g., a second location) that includes a computing system 306 configured to perform system functions such as determining the locations of tracking tags 116 based on sensor data, performing data analysis, and communicating with the smartphone 120 or other smart devices. The second location 304 also includes a server 308 for storing data, such as historical tracking information and analytics. The system 300 includes a firewall 310 between the shared services site 304 and the worksite 302 to protect data from interception and to prevent unapproved access to the system 300. In some embodiments, the system 300 may include several worksites 302 with similar sensor arrays. Each worksite 302 may transmit data to the shared services site 304 and the computing system 306 may perform system functions for each worksite 302. A user may be able to access tracking information for assets on any of the worksites 302 via the smartphone 120.

### Tool Tracking Tags

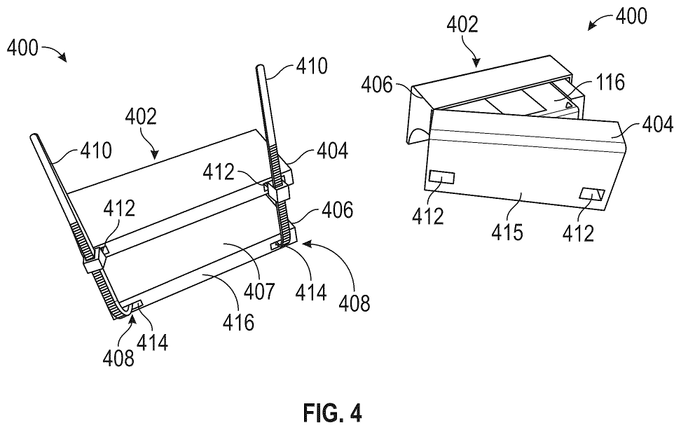

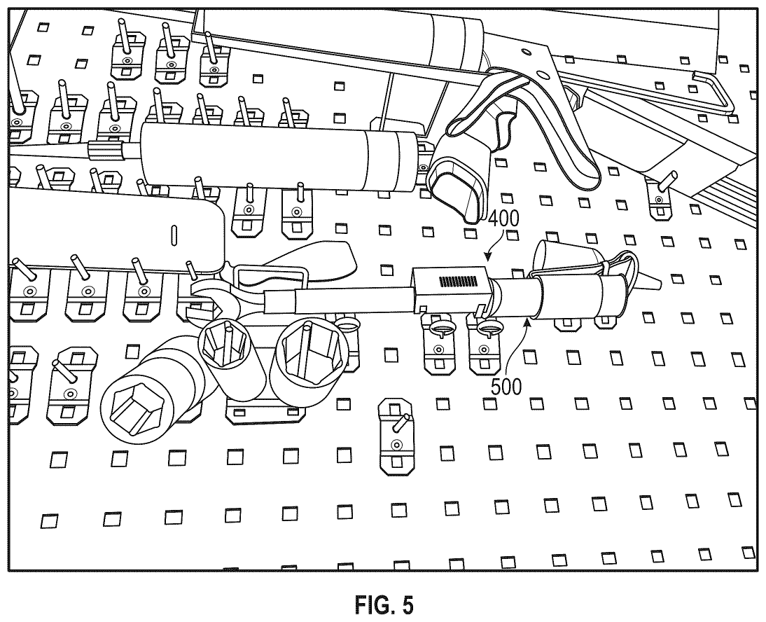

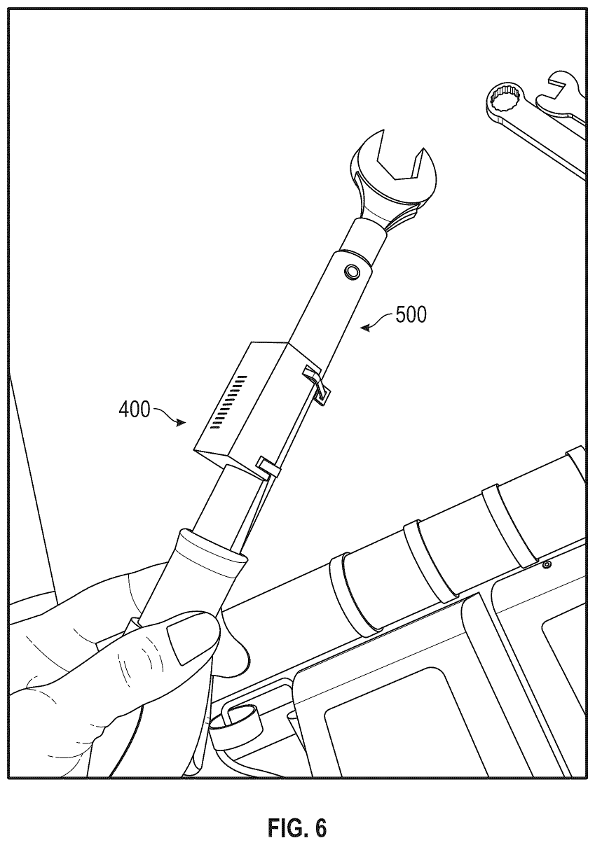

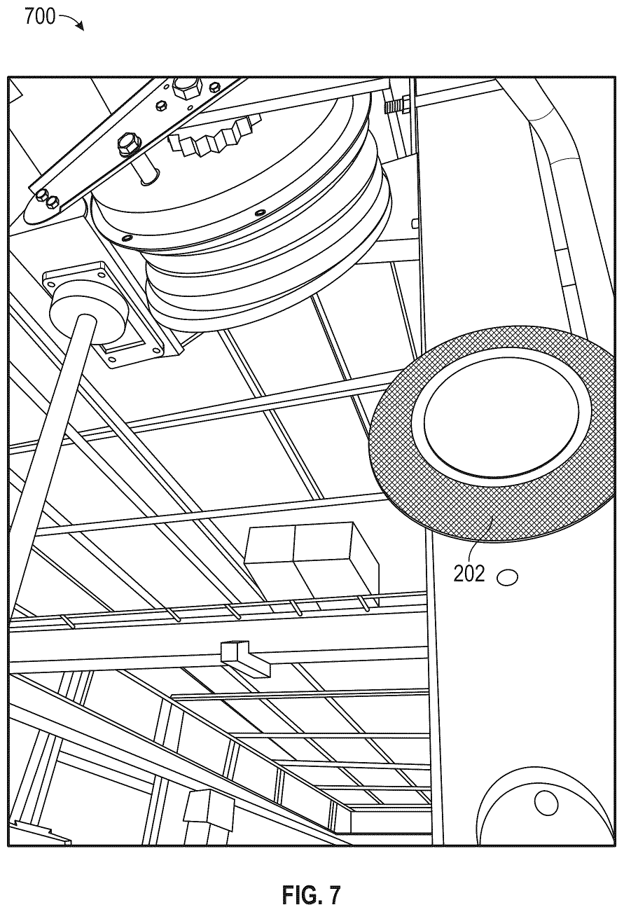

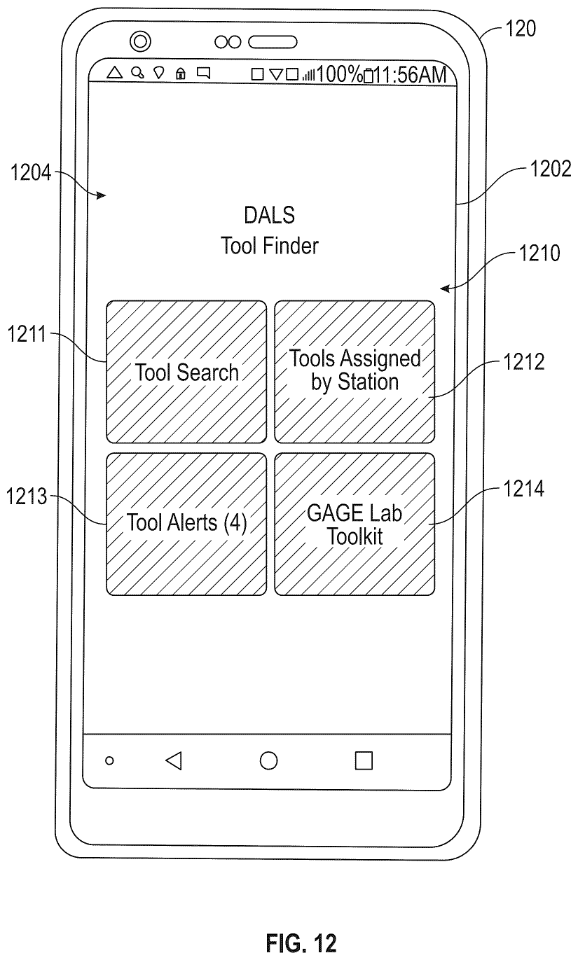

Referring now to FIG. 4, tracking tags assemblies 400 are shown, according to some embodiments. The tracking tag assemblies 400 shown in FIG. 4 are configured to be coupled to a hand tool or to a round member of a larger tool or device. The tracking tag assembly 400 includes a housing 402 including a first portion 404 and a second portion 406. The portions 404, 406 of the housing 402 are configured to enclose a tracking tag 116 (e.g., an RFID tag) that can be detected by the sensors 112. For example, the sensors 112 may transmit signals that activate a transponder in the tracking tag 116. The sensors 112 can then detect the signal generated by the transponder. The portions 404, 406 of the housing 402 may securely snap together, forming a cavity around the tracking tag 116, and may be pulled apart by hand to access the tracking tag 116 when needed. The housing may form a main channel 407 configured to be placed around a cylindrical portion of a hand tool or other device. The portions 404, 406 of the housing 402 may include tie channels 408, each configured to receive a cable tie 410 (e.g., zip tie, etc.). The tracking tag assembly 400 may be positioned on a hand tool or other device with the main channel arranged around a cylindrical or otherwise elongated component of the tool, and cable ties 410 may be inserted into each tie channel around the cylindrical component. The tie channels 408 may extend from a first opening 412 in the first portion 404, through both portions 404, 406 of the housing 402 around the main channel 407, to a second opening 414 in the second portion 406. The cable ties 410 can be inserted through the tie channels 408 and fastened around the cylindrical portion of the tool to secure the tracking tag assembly 400 to the tool. The cable ties 410 also function to secure the two portions 404, 406 of the housing 402 together. In some embodiments, the openings 412, 414 may be positioned on the outside surfaces 415 of the housing 402 rather than on the ends 416 adjacent the main channel 407. FIGS. 5 and 6 show the tracking tag assembly 400 coupled to a torque wrench 500. Small tools like the torque wrench 500 may be difficult to find on a large worksite. The tracking tag 116 in the tracking tag assembly 400 makes it easier for a user to determine the location of a specific tool or other asset. For example, a user may access the asset management system 100 via a smartphone 120 and may use an application on the smartphone 120 to search for a specific asset or type of asset (e.g., the torque wrench 500) or select an asset from a list of assets. The user may select the torque wrench 500 from the search results or the list of assets. The application can then identify the location of the tracking tag 116 coupled to the torque wrench 500 so that the user can more easily locate the torque wrench 500. The application may provide directions to the location of the torque wrench 500 and may indicate the distance from the smartphone 120 to the torque wrench 500. Additional features of an application for interacting with the asset management system 100 are discussed below with reference to FIGS. 12-22.

### Additional System Components

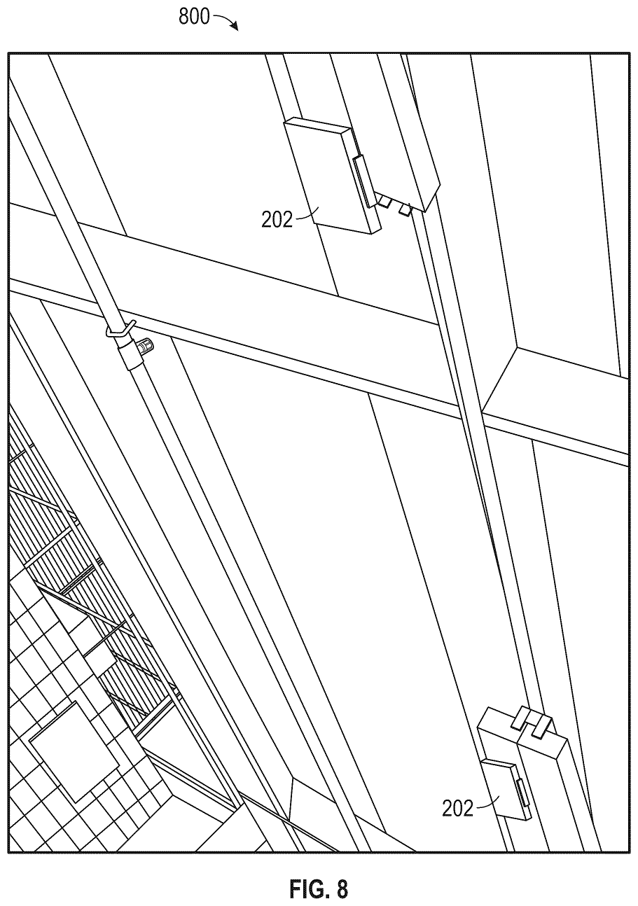

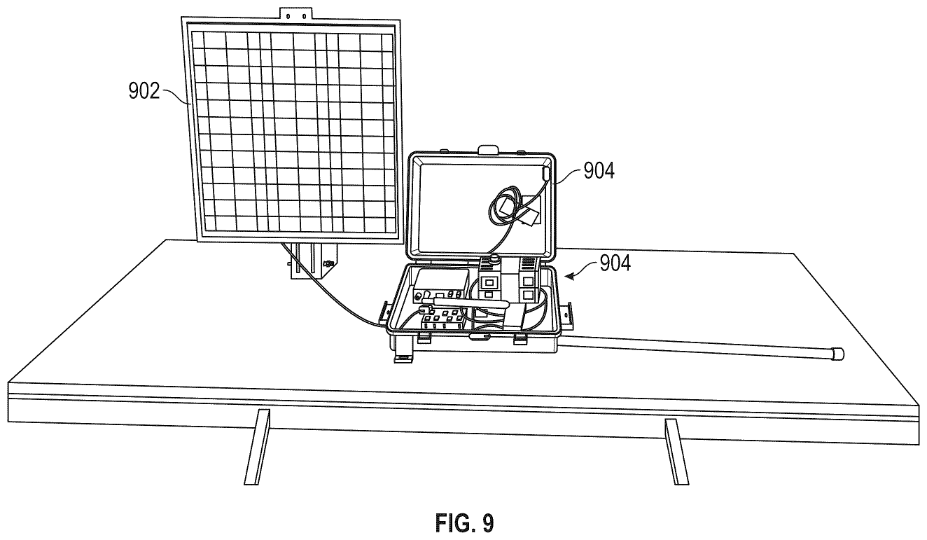

Referring now to FIG. 7, a gateway 202 is shown mounted to a column on a worksite 700, according to some embodiments. The gateway 202 is configured to receive sensor data from a plurality of sensor nodes 112 and to relay the data to the local controller 130, the computing system 306, and/or to another local or offsite computing system, such as the cloud 140 or the local cloud storage gateway 206. The sensor nodes 112 may be relatively low power, and therefore the gateways 202 are positioned near the sensor nodes 112. The gateways 202 may have more processing power and greater signal strength to send the sensor data a greater distance. FIG. 8 shows sensor nodes 112 installed on a worksite 800, according to some embodiments. The sensor nodes 112 may be powered by photovoltaic panels, and as such may be installed below light fixtures where they can be powered by the light emitted from the light fixtures. The sensor nodes 112 are configured to detect asset tracking tags 116 and other radio communication-enabled devices. The sensor nodes 112 may operate at about 3V and about 8 mA. In some embodiments, the nodes may operate using BLE in the 2.4 GHz band (e.g., with a frequency range of 2440 MHz +/−40 MHz). The nodes 112 may be approximately 8.7 inches in length, 8.7 inches in width, and. 6 inches in height. The sensor nodes 112 may transmit the sensor data to the gateway 202 or a local controller 130. The sensor data may include a list of detected tracking tags 116 and devices and their respective detected signal strengths, which may indicate the distance from the tracking tags 116 to the sensor node 112. FIG. 9 shows a LoRa WAN sensor 902 and an enclosure 904 containing processing and signal transmission components 906. The LoRa WAN sensor 902 may be configured to detect tracking tags 116 and other radio communication-enabled devices at a much longer range than the sensor nodes 112. For example, the LoRa WAN sensor 902 may be able to track the locations of vehicles over a several mile radius in outdoor environments. The tracking tags 116 that are detected by LoRa WAN sensors or via GPS may be larger, powered tracking tags 116 that may emit radio frequencies in the range of 900 MHz. In some embodiments, optical or infrared image processing may also be integrated into the system for secondary positioning information or confirmation. For example, assets may include barcodes that are readable by an optical or infrared sensor, and position information from the sensor nodes 112 can be further refined using the optical or infrared sensors. The sensors may determine distance, for example, based on the detected size of the barcode relative to the image capture area. A barcode that occupies a larger portion of the image capture area is likely closer to the sensor than a barcode that occupies a smaller portion of the image capture area.

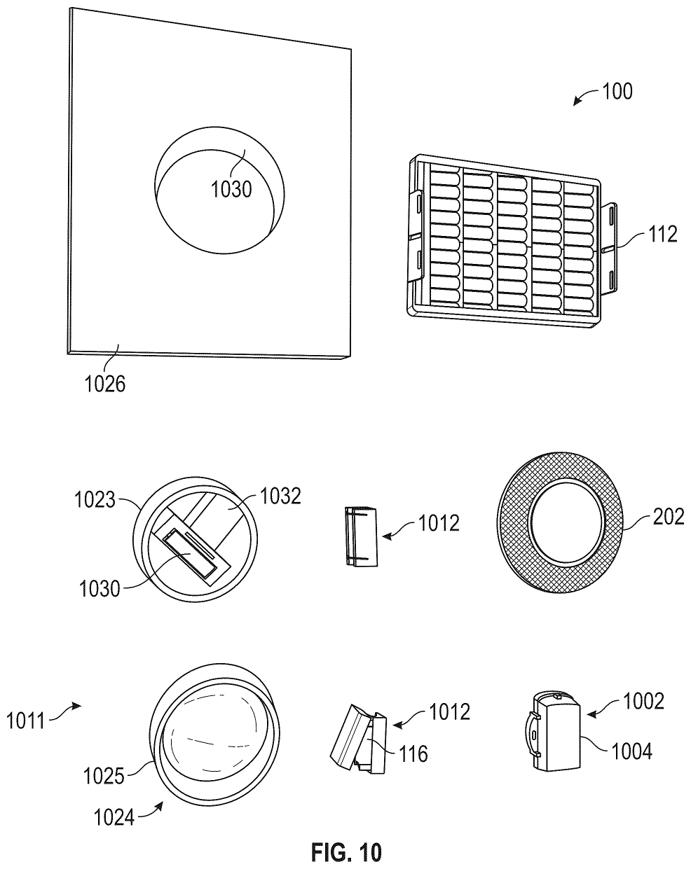

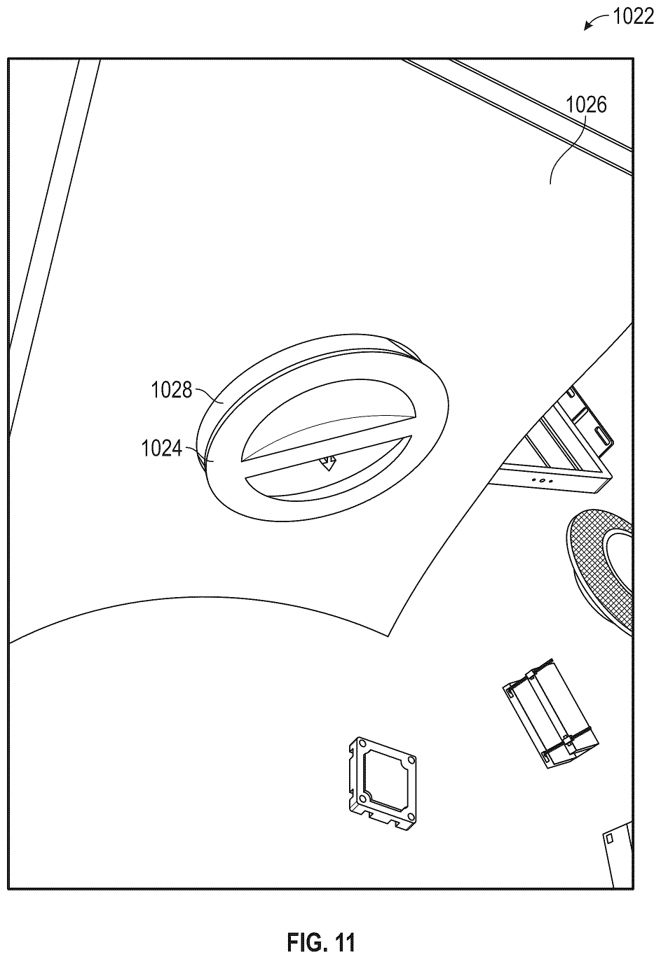

Referring now to FIG. 10, various components of the asset management system 100 are shown, according to some embodiments. FIG. 10 shows a sensor node 112, according to some embodiments, and a gateway 202, according to some embodiments. FIG. 10 also illustrates several embodiments of tracking tag assemblies 1002, 1012, 1022. Tracking tag assembly 1002 includes a housing 1004 that encloses a tracking tag 116 and can be mounted to a surface of a larger asset, such as a vehicle, a weldment or other workpiece, or a work machine, such as a forklift or crane. Tracking tag assemblies 1012 are similar to or the same as the tracking tag assemblies 400 shown in FIGS. 4-6. Tracking tag assembly 1022 is shown disassembled. Tracking tag assembly 1022 is configured to be used in high-temperature environments and includes an enclosure 1024 configured to be inserted in an opening 1028 in an insulated backing 1026. The enclosure 1024 includes an inner portion 1023 and an outer portion 1025. The inner portion 1023 stores a battery 1030 and a tracking tag 1032 (e.g., similar to the tracking tag 116). The tracking tag 1032 may be powered by the battery 1030 (e.g., the tracking tag 1032 may be an active RFID tag), which can improve signal strength. The outer portion 1025 may include heat shielding 1034 to protect the battery 1030 and tracking tag 1032 from the high-temperature environment. The insulated backing 1026 may provide additional heat protection to the battery 1030 and tracking tag 1032. FIG. 11 shows the tracking tag assembly 1022 assembled, with the enclosure 1024 installed in the opening 1028 in the insulated backing 1026.

### System Management Applications

Referring now to FIGS. 12-22, a smartphone 120 is shown illustrating a tool finder application for interacting with the asset management system 100, according to some embodiments. The smartphone 120 includes a display screen 1202 (e.g., a touchscreen) configured to display a graphical user interface 1204 (GUI) that can display information to a user and receive commands from a user (e.g., by selecting buttons on the GUI 1204 by touching the display screen 1202). It should be understood that tablet computers, laptops, wired terminals, and other wired or wireless devices may be used to perform similar functions to those shown in the smartphone 120. FIG. 12 shows a home screen 1210, which may be a primary or main screen of the application that is first shown to the user when the application is opened. The home screen 1210 includes four selectable module buttons. The tool search module button 1211 may be used to locate tools and other devices using the asset location system 110. The tools assigned by station module button 1212 may be used to identify where tools are supposed to be stored. The tool alerts module button 1213 may be used to display alerts to a user when tools are in need of service or have been moved outside of an approved area. The lab toolkit module button 1214 may be used to assign tags to tools and to perform various managerial tasks for the asset management system.

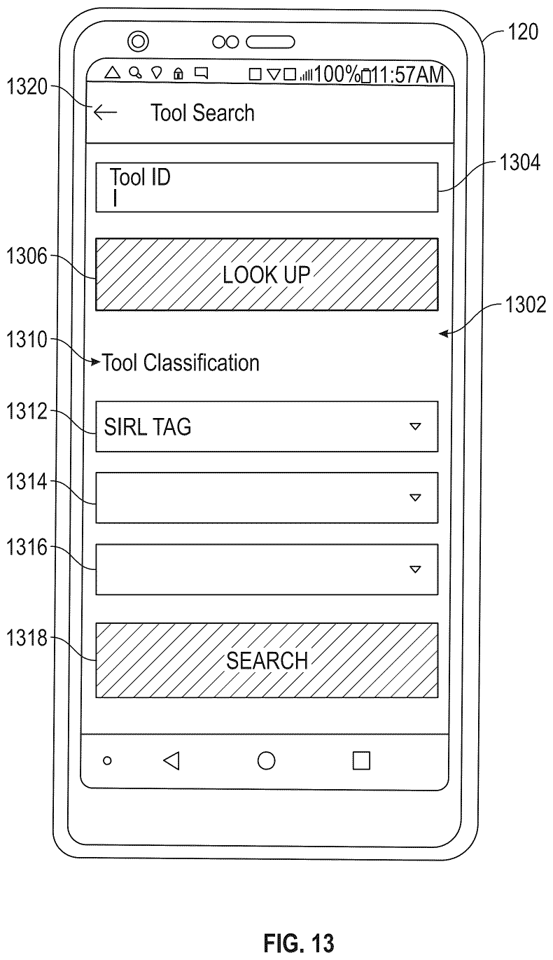

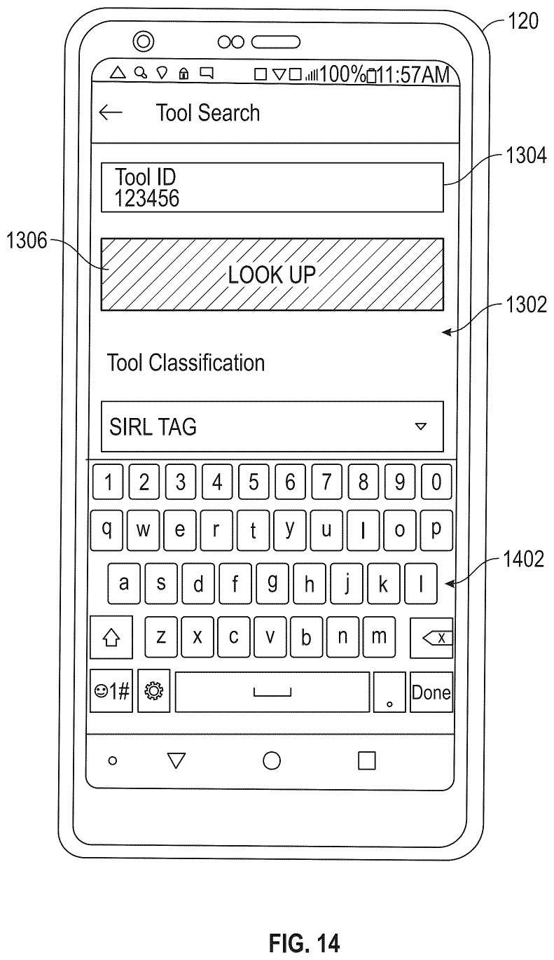

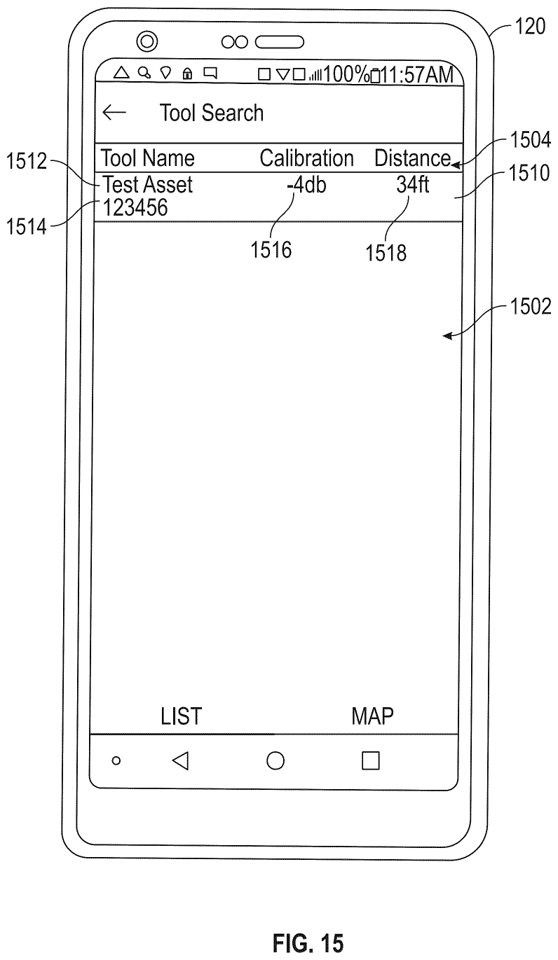

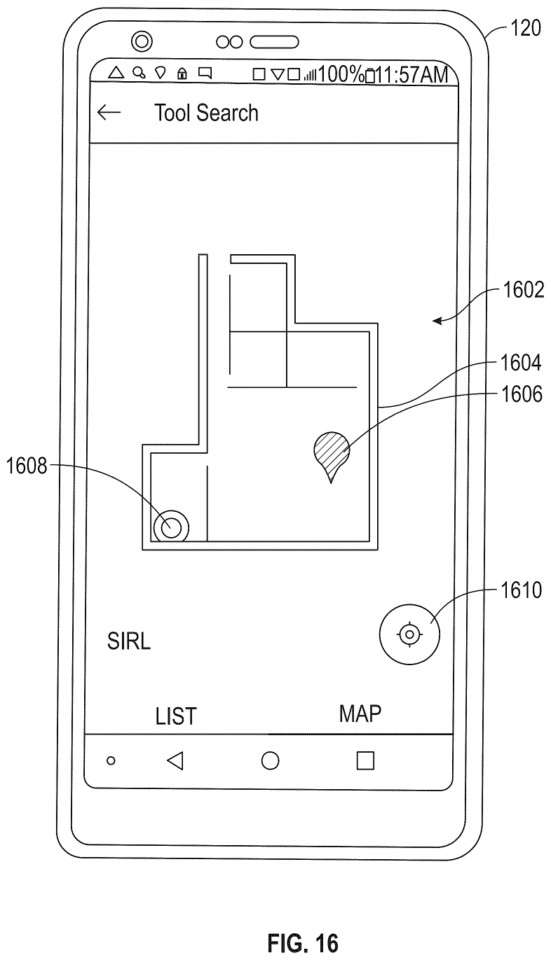

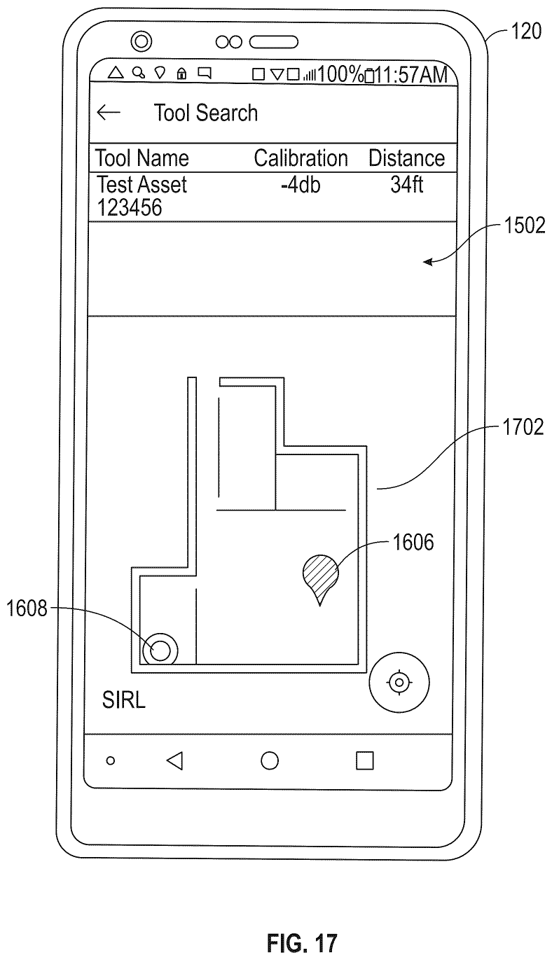

FIG. 13 shows a search screen 1302 of a tool search module, according to some embodiments. The search screen 1302 may be displayed when a user selects the tool search module button 1211 on the home screen 1210. The search screen 1302 includes a Tool ID entry field 1304 and lookup button 1306. A user may enter a specific tool ID into the Tool ID entry field 1304 and select the lookup button to locate a specific tool on a worksite associated with the tool ID. The search screen 1302 also includes a tool classification search feature 1310. A user may select a first search category 1312 via a dropdown menu and may further filter using additional subcategories 1314, 1316 using additional dropdowns. The user may then search using the selected categories 1312, 1314, 1316 by selecting the search button 1318, which may cause the application to identify all of the tools within the selected categories 1312, 1314, 1316 and their locations. The search screen 1302 also includes a return button 1320 that a user may select to return to the home screen 1210. In other portions of the application, the return button 1320 may return the user to the previous screen rather than to the home screen 1210. FIG. 14 shows the search screen 1302 after the user has selected the Tool ID entry field 1304, causing the keyboard 1402 of the smartphone 120 to appear on the display screen 1202. In FIG. 14, the user has entered a Tool ID of “123456” into the Tool ID entry field 1304 using the keyboard 1402. FIG. 15 shows a results screen 1502 including a list of assets 1504 identified in the search after the user enters a search into the Tool ID entry field 1304 and selects the lookup button 1306. As shown in FIG. 15, the user has entered a complete Tool ID (e.g., “123456”) which has identified only a single asset, shown as entry 1510. In some embodiments, the user may enter a portion of a Tool ID and the list of assets 1504 may include each asset with Tool IDs that include that portion. The list of assets 1504 may include an entry 1510 for each asset including the name 1512 of the asset, the Tool ID 1514 of the asset, calibration information 1516, and the distance 1518 from the smartphone 120 to the asset. The results screen 1502 may also include a list/map toggle 1520 that allows the user to switch between a list view of the search results and a map view. FIG. 16 shows a map view 1602 of the results after the map view has been selected from the list/map toggle 1520. The map view 1602 shows a map 1604 of the worksite, and indicates the locations 1606 of the assets from the search results, as well as the location 1608 of the smartphone 120. The user may use the map view 1602 to find the assets from the list 1504 by following the map 1604 to the indicated location 1606 of the asset. The map view 1602 includes a recenter button 1610 that recenters the map on the location of the smartphone 120, which may be useful on large worksites in which the entire worksite map 1604 may not fit on the display screen 1202. The user may track his or her own movements by monitoring the smartphone location 1608. The user may return to the results screen 1502 by selecting the list view from the list/map toggle 1520. Referring now to FIG. 17, the user may also view a pop-up map 1702 by selecting an asset from the list of assets 1504 on the results screen. The pop-up map 1702 may overlay the results screen 1502, and the user can return to the results screen 1502 by touching the display screen 1202 above from the pop-up map 1702. In some embodiments, the pop-up map 1702 may indicate the location 1606 of only the selected asset and the location 1608 of the smartphone 120, rather than indicating the location 1606 of every asset in the list of assets 1504.

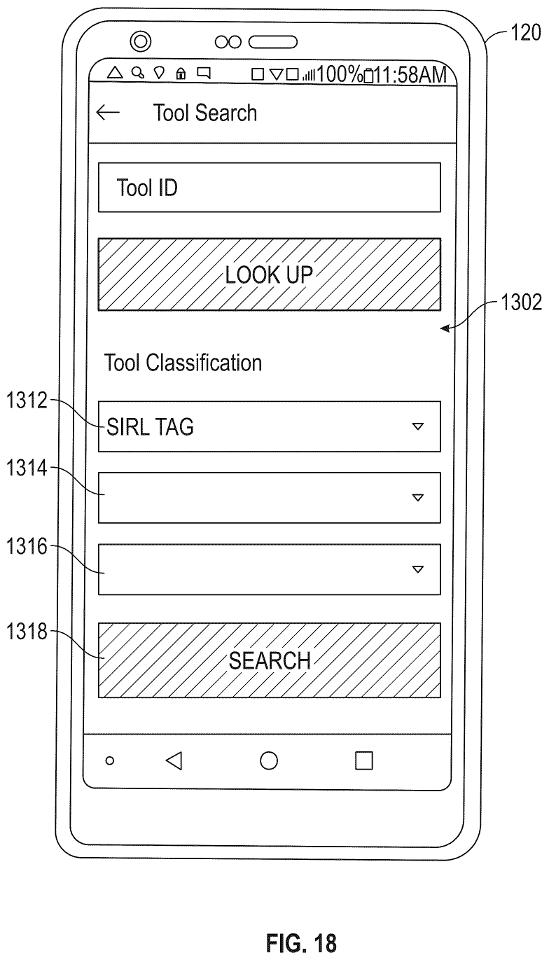

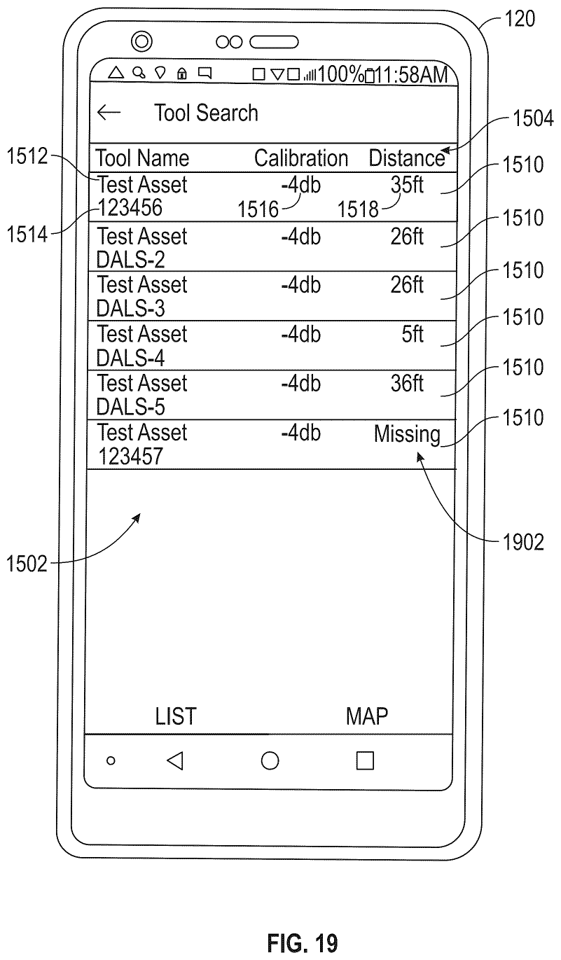

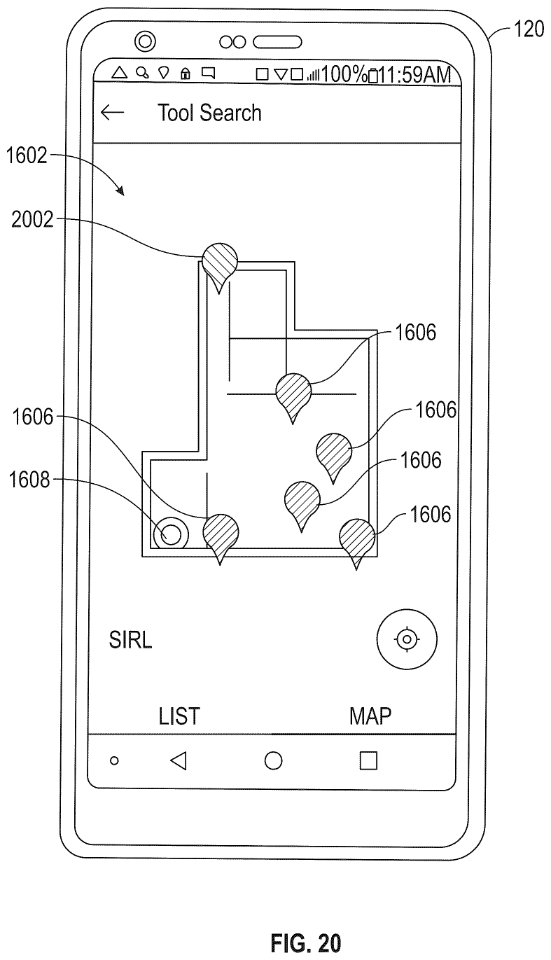

FIG. 18 shows the search screen 1302 of the tool search module with a first search category 1312 selected from a drop-down menu. The search may be further narrowed by selecting additional subcategories 1314, 1316. After the category or categories, 1312, 1314, 1316 are selected, a user may select the search button 1318 to view the results screen 1502 with the list of assets 1504 within the selected categories 1312, 1314, 1316. FIG. 19 shows the results screen 1502 for the category 1312 selected in FIG. 18. The list of assets 1504 includes entries 1510 for each asset within the selected category 1312, including the name 1512 of the asset, the Tool ID 1514 of the asset, calibration information 1516, and the distance 1518 from the smartphone 120 to the asset. When an asset is not located on the worksite, the entry 1510 for that asset may include a “missing” indicator 1902 rather than the distance 1518. FIG. 20 shows the map view 1602 of the results of the search from FIG. 19 after the map view has been selected from the list/map toggle 1520. The map view 1602 shows a map 1604 of the worksite and indicates the locations 1606 of the assets from search results, as well as the location 1608 of the smartphone 120. Each asset location indicator 1606 may be selectable on the map 1604, and selecting an asset location indicator 1606 may cause information about the associated asset (e.g., the asset name, Tool ID, distance, etc.) to appear on the screen 1202. The map view 1602 includes a missing asset indicator 2002, which indicates the most recently detected location of a missing asset before it was no longer detected. A user may search the area near this location for the missing asset or may infer that the asset was taken off of the worksite based on the location of the missing asset indicator 2002 (e.g., if the missing asset indicator points to a driveway leading away from the worksite).

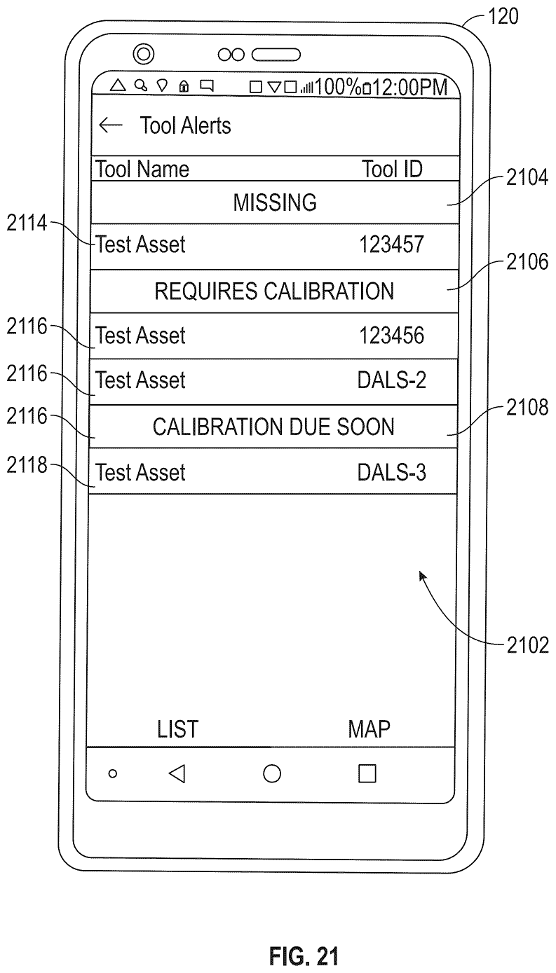

FIG. 21 shows a tool alerts screen 2102, according to some embodiments. The tool alerts screen 2102 may be displayed when the tool alerts module button 1213 is selected from the home screen 1210. The tool alerts screen 2102 shows alerts (e.g., notifications) for assets that may need service or are missing from the system. The tool alerts screen 2102 may include a list of missing assets 2104, a list of assets that require calibration 2106, and a list of assets that have upcoming calibration, inspection, or maintenance due dates 2108. The list of missing assets 2104 includes an entry 2114 for each asset that is not detected by the asset location system 110. A user may switch to a map view using the list/map toggle 1520 to view the “missing” indicator 1902 for any missing assets, indicating the most recent location where the missing asset was detected. The list of assets that require calibration, inspection, or maintenance 2106 may include an entry 2116 for each asset that requires calibration, and the locations of those assets can be displayed on the map view, similar to search results as shown in FIG. 19. The locations of the entries 2118 in the list of assets that have upcoming calibration due dates 2108 can also be displayed on the map view, similar to search results as shown in FIG. 19. Each entry 2114, 2116, 2118 can also be selected to view a pop-up map, similar to the pop-up map 1702 shown in FIG. 17.

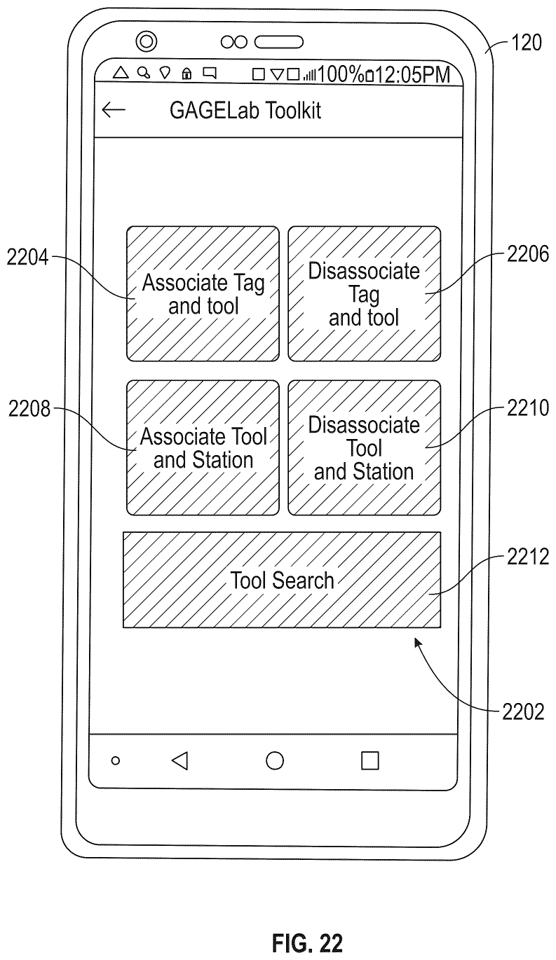

FIG. 22 shows a lab toolkit screen 2202, according to some embodiments. The lab toolkit screen 2202 may be displayed when the lab toolkit module button 1214 is selected from the home screen 1210. The lab toolkit screen 2202 may include an associate tag and tool button 2204, which, when selected, opens an entry screen in which a tracking tag 116 can be associated with the tool or other asset to which it is attached. For example, a user may couple a tracking tag 116 with a Tool ID number of “123456” to a wrench. The user may then select the associate tag and tool button 2204 and enter the Tool ID number and the name of the asset to which it is coupled. A new asset may be added to the asset management system 100 using this process, or the user may select an existing tool in the system 100 and associate it with a tracking tag 116. The user may select the disassociate tag and tool button 2206 to disassociate the asset with the tracking tag 116, for example, if the tracking tag 116 is damaged and needs to be replaced. The user may then use the associate tag and tool button 2204 to assign a different tracking tag 116 to the tool. The lab toolkit screen 2202 may include an associate tool and station button 2208 which, when selected, opens an entry screen in which a tool can be associated with a workstation on a worksite. A disassociate tool and station button 2210 can be used to disassociate the tool from the workstation so that it can be assigned to a different workstation. The lab toolkit screen 2202 may also include a tool search button 2212 that may open the search screen 1302 so that a user can confirm that any newly associated tracking tags 116 are detected by the asset location system 110.

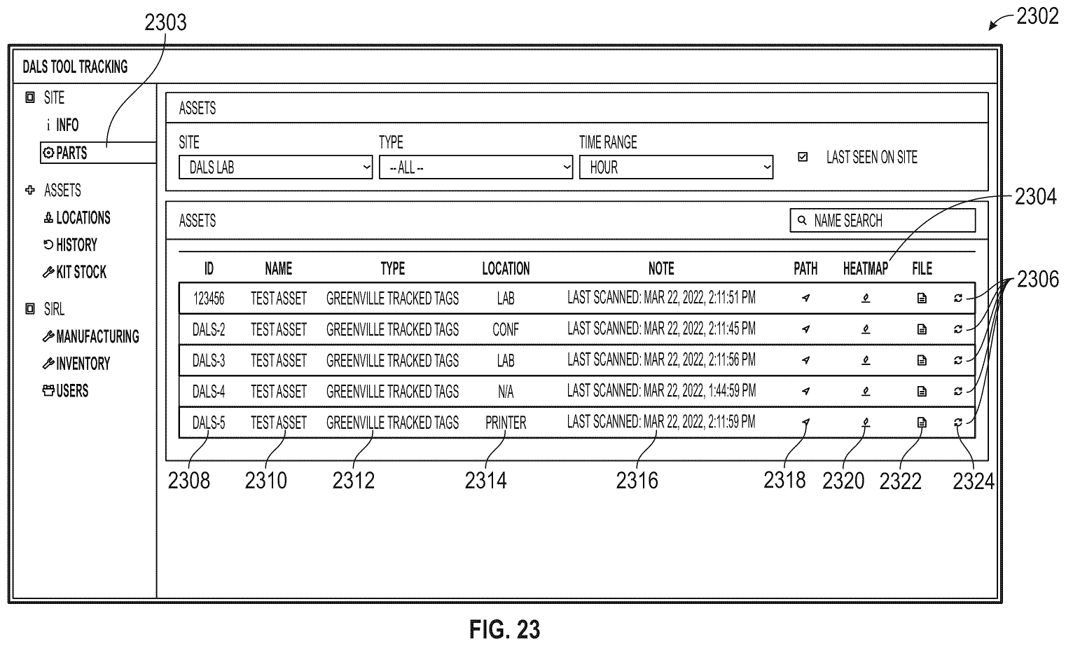

Referring now to FIGS. 23-25, asset management dashboards 2302, 2402, 2502 are shown, according to some embodiments. The dashboards may be displayed in the smartphone application shown in the application of FIGS. 12-22 or may be part of a separate management application. Dashboard 2302, accessible by selecting the parts button 2303, shows a list 2304 of assets, each asset having an entry 2306 on the list 2304. Each entry 2306 includes a Tool ID 2308, the name 2310 of the asset, an asset type 2312, a general location 2314 (e.g., a workstation, a room within a larger worksite), a last-scanned time 2316, a path button 2318, and a heatmap button 2320, a file button 2322, and a refresh button 2324. Selecting the path button 2318 may cause the application to display a path from the user device on which the application is running to the selected asset on a map, similar to the map 1604. Selecting the heatmap button 2320 may cause the map 1604 to appear with a heatmap indicating the locations where the selected asset has been during a predetermined period of time. For example, areas where the asset has been located for long periods of time may be indicated with dark marks on the map 1604, while areas where the asset has been located for brief periods of time may be indicated with lighter marks on the map 1604. The heatmap can be used to track where the tool is commonly moved, which can help worksite operators improve efficiency. For example, if a forklift is commonly used in two work areas on opposite sides of a worksite, the operators may determine that adding a second forklift to the worksite may be beneficial to improve efficiency. Alternatively, the operators may determine that the work done at the two work areas can all be done at a single location, and can move one of the work areas and the associated tools closer to the other work area.

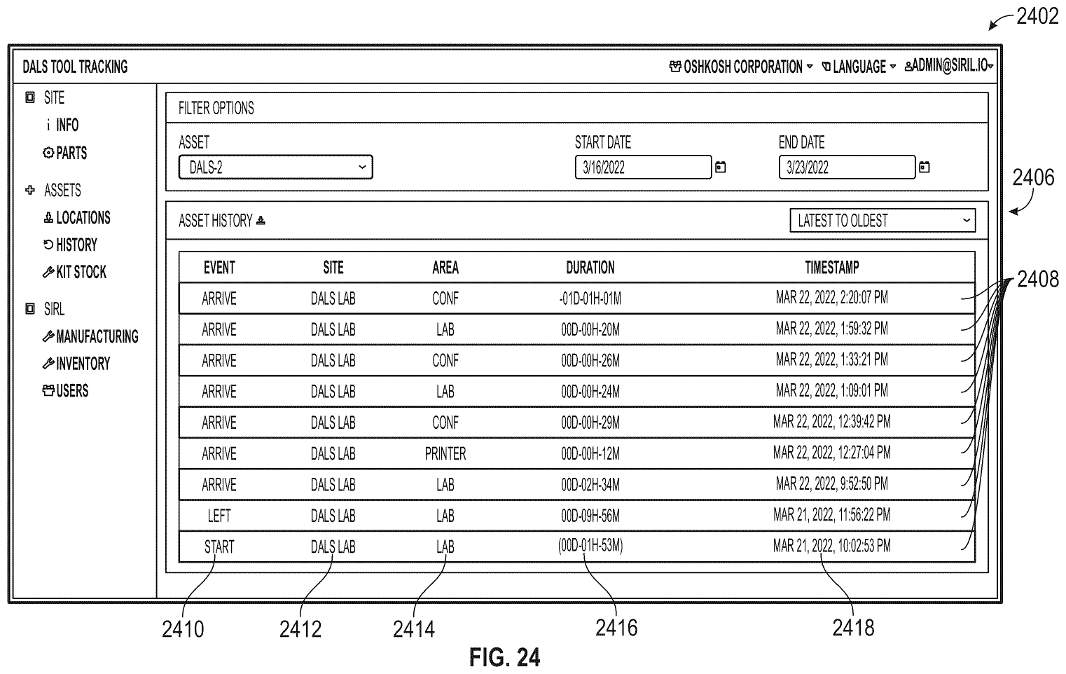

FIG. 24 shows the dashboard 2402, accessible by selecting the history button 2403, which shows the tracking history 2406 for a specific asset. Each entry 2408 in the tracking history 2406 indicates a tracking update for the selected asset. The entries indicate the action 2410, the worksite 2412, the location 2414, the duration 2416 that the asset was in the location 2414, and a timestamp 2418 indicating the time and date that the action occurred. The actions 2410 may include a START action indicating that the tracking tag 116 coupled to the asset has been detected by the asset tracking system 110 for the first time, a LEFT action indicating that the tracking tag 116 is no longer detected by the asset tracking system 110, and an ARRIVE action indicating that the tracking tag 116 has arrived in a location 2414. The location 2414 may indicate a workstation or specific room within the worksite 2412. The user may view the tracking history 2406 to see how long an asset spends in each location 2414. For example, the asset may be a workpiece that goes through several steps of machining and coating in various locations 2414 within the worksite 2412. The tracking history 2406 may be used to determine how long each step of the process takes so that analysis can be performed to improve efficiency and to create accurate estimates of completion dates.

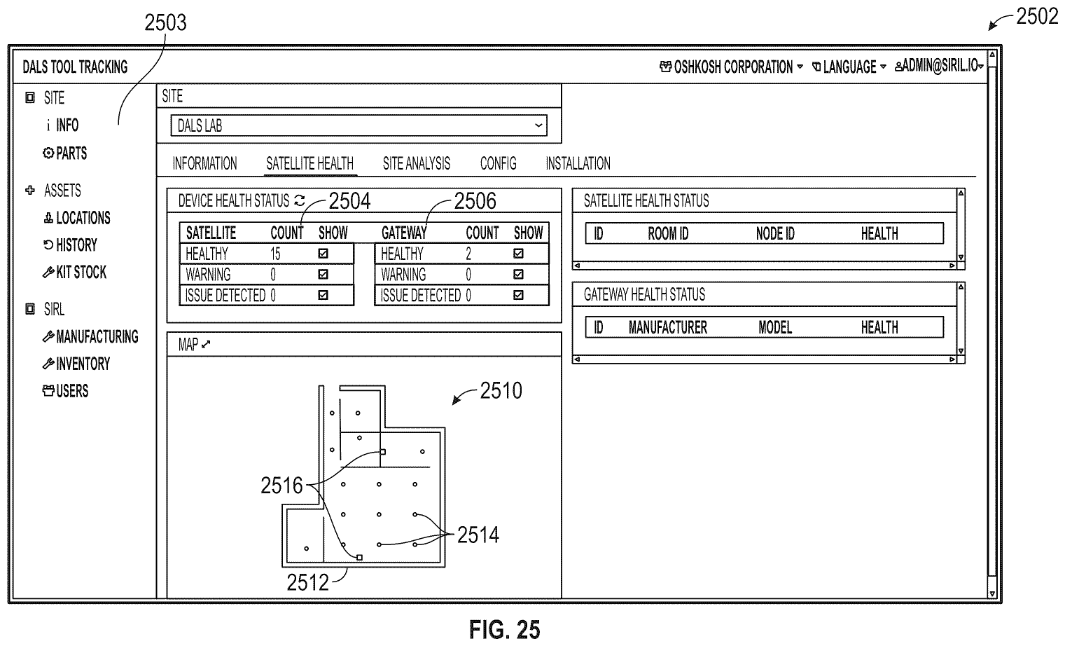

FIG. 25 shows the dashboard 2502, accessible by selecting the info button 2503, which shows information regarding the asset tracking system 110. The dashboard 2502 includes a sensor health window 2504 that shows the operational status of sensors 112 in the asset tracking system 110. For example, the sensor health window 2504 may indicate whether the sensors 112 are operating normally (e.g., are healthy), have a warning indicating a potential problem, or have issues detected that need to be addressed. For example, if a sensor 112 is not detected in the system 110, it may be included in the warning tab. If a sensor is in need of maintenance, it may be included in the issues detected tab. A user may select the tabs to see which sensors 112 are listed in each category so that issues or warnings can be addressed. The dashboard similarly includes a gateway health window 2506 showing similar information for each gateway 202. The dashboard 2502 also includes a map 2510 that shows a layout 2512 of a worksite with a sensor icon 2514 for each sensor 112 and a gateway icon 2516 for each gateway 202. The sensor icons 2514 and gateway icons 2516 may be color coded to indicate whether the corresponding sensor 112 or gateway 202 is fully operational or whether it has warnings or issues detected.

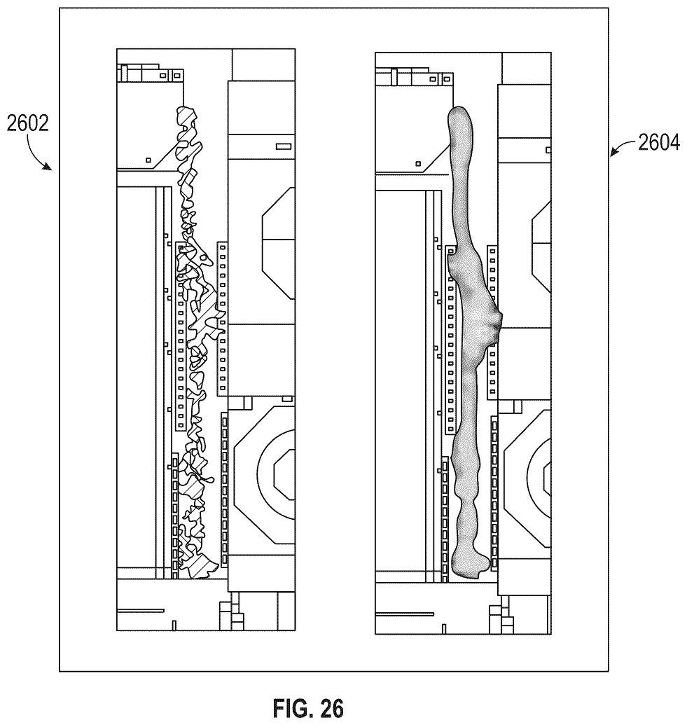

Referring now to FIG. 26, two data visualizations 2602, 2604 are shown, according to some embodiments. The data visualizations 2602, 2604 may be accessible via the applications described above (e.g., via a smartphone 120 or tablet 124). The first visualization 2602 shows discrete points of locations where an asset was detected over a predetermined time period. The second visualization 2604 shows a heatmap of locations where an asset was detected over a predetermined time period. In some embodiments, the visualizations 2602, 2604 may be for a particular asset or a collection of similar assets. For example, if the assets are identical or similar manufacturing workpieces, the visualizations 2602, 2604 may show the average time that workpieces spent in a particular location, rather than data for one specific workpiece. Using several of the same or similar workpieces rather than a single workpiece can help identify how long each step of a manufacturing process takes and whether any improvements can be made. Changes over time can be used to identify productivity issues. For example, if one workstation on the heatmap 2604 becomes darker over time, it may indicate that the employees in that station are becoming less productive or the tools used in that station are wearing out over time. The manager of the manufacturing site can then perform further investigation to determine the source of the slowdown.

In some embodiments, the data visualizations 2602, 2604 may include overlaying the tracking data on an up-to-date image of the worksite, rather than a diagram of the worksite or a static image of the worksite. For example, a photograph of the worksite may be taken periodically (e.g., daily, hourly, every minute, etc.) or on-demand while the data from the tracking devices is received. Alternatively or additionally, a video stream of the worksite may be recorded. The photograph or video may be taken by static cameras placed at elevated locations on the worksite or a drone (e.g., a quad-copter drone, an unmanned aerial vehicle), may be flown above the worksite and take overhead pictures of the worksite. The photographs may provide additional information that can be used to contextualize the movements of the tracked assets. For example, a large truck not being tracked by the system may block the normal path of assets across a worksite from a first location to a second location. The system may then determine an optimal path to the second location taking into account the blocked path. The system may use image processing techniques to identify objects that may not be tracked by the system, for example, assets owned by third parties that are not connected to the system via an asset tag or other wireless connection.

Artificial intelligence may be used to predict future movements and behavior patterns based on changes in the heatmap and other tracking data. The system can execute a machine learning model that is configured or trained to predict future movements of assets on the worksite. The machine learning model can be a support vector machine, a neural network, a random forest algorithm, etc. For example, the asset tracking data, as well as the overhead photographs, can be input into the machine learning model, and the system can execute the machine learning model, applying learned weights and/or parameters to the tracking data to output predicted future movements of the assets. New tracking and image data can periodically or continuously be provided to the machine learning model. Over time, the machine learning model can be repeatedly executed to predict future movements of assets within the warehouse.

The machine learning model may be trained using supervised, semi-supervised, or unsupervised training methods. For example, a user can input labeled training data into the model. The labeled training data can include ground truth information regarding the movements of assets on the worksite including the location of the assets before and after the movements. The machine learning model may output predictions of movements for the items based on the input data, which may be compared to the recorded tracking information. The machine learning model can be trained using a loss function and backpropagation techniques, such as based on differences between the tracked movements and the labeled training data. The machine learning model can be trained in this manner until it is determined that the machine learning model is accurate to a threshold (e.g., an accuracy threshold). Responsive to determining that the machine learning model is accurate to within the threshold, the machine learning model can be deployed to predict future movements of assets on the worksite in real-time. As discussed above, the model may be continuously or periodically updated and trained with new tracking information. Referring again to the example discussed above, the system may determine based on the tracking measurements and photographs that the large truck blocking the path has been present in that location every morning from 9:00 am to 11:00 am. The machine learning model may update to expect that the truck will be present each morning in the future between 9:00 am to 11:00 am. The system may identify a new route from the first location to the second location that will be recommended between 9:00 am to 11:00 am, while a different, primary route may be recommended outside of those hours. On a specific morning, the system may receive an updated drone photograph indicating that the truck is not present and may revise the recommended route based on the path not being presently blocked. If the truck is not present for several days in a row, the model may be updated to predict that the path will no longer be blocked between 9:00 am to 11:00 am and may recommend the primary route during those hours. Thus, the system may predict the optimal route from the first location to the second location while adapting to changes in the environment in real-time.

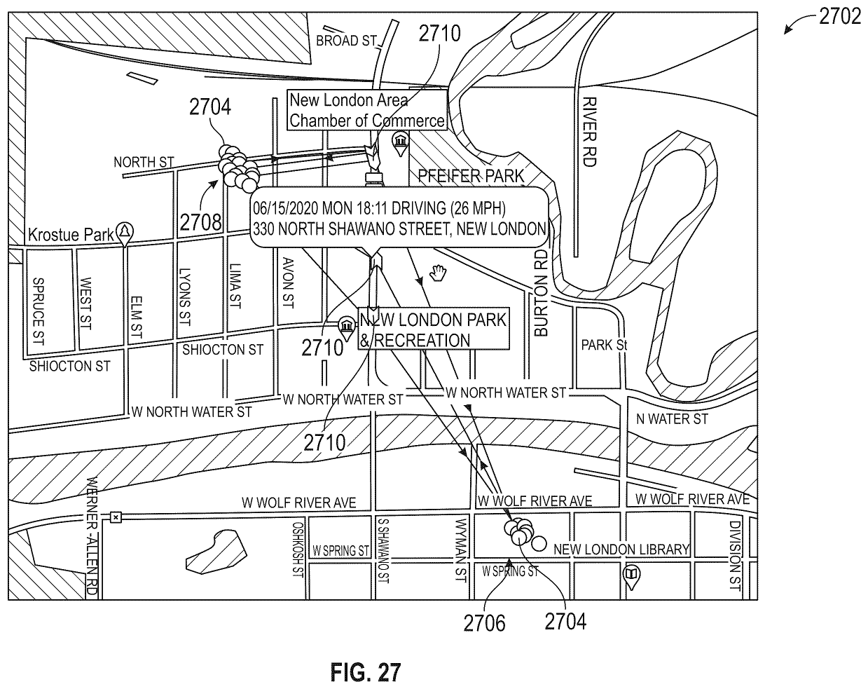

FIG. 27 is an additional dashboard 2702 illustrating assets on multiple worksites, according to some embodiments. Various asset icons 2704 are shown at two worksites 2706, 2708. Additional asset icons 2710 are shown representing assets (e.g., vehicles) moving between the worksites 2706, 2708 or elsewhere in the vicinity of the worksites 2706, 2708. LoRa WAN sensors 902 may be used to track the assets at longer distances outside of the worksites 2706, 2708.

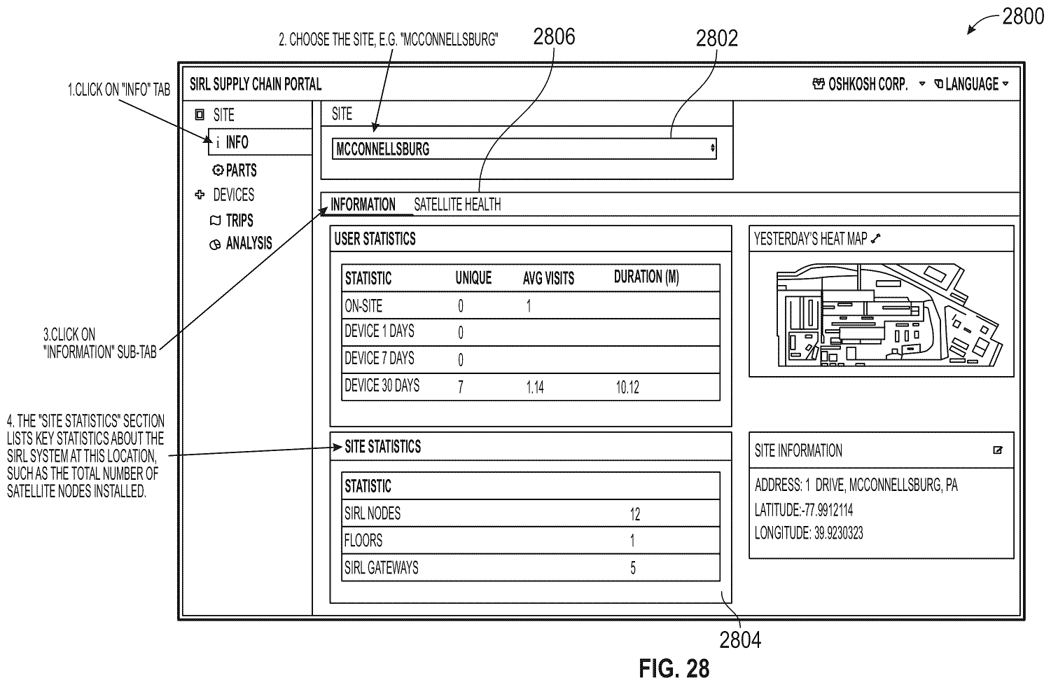

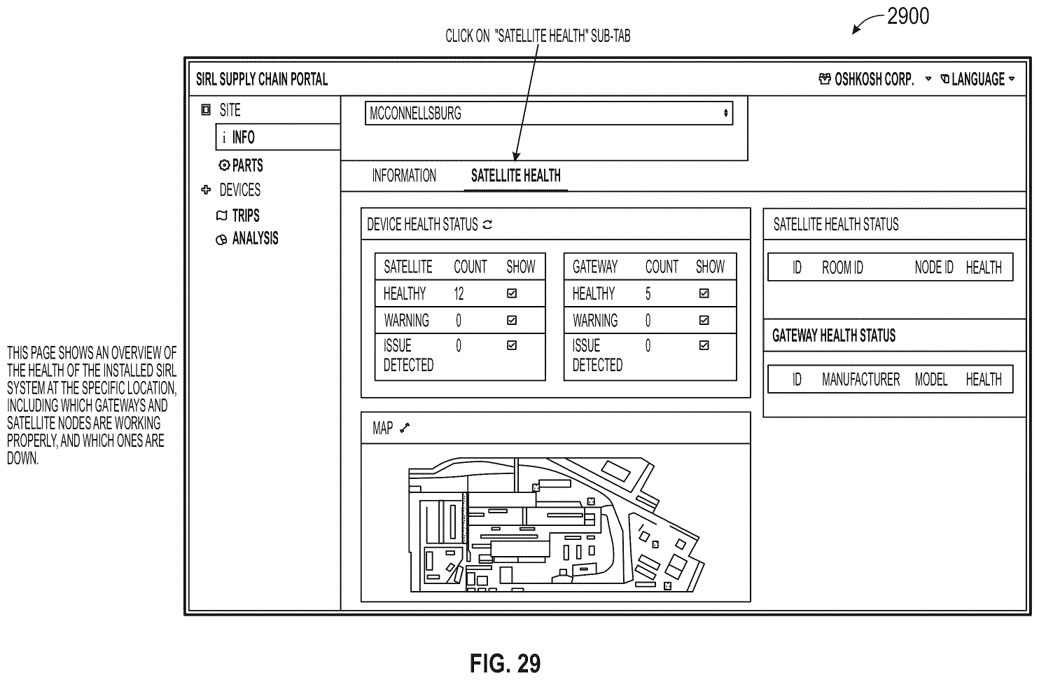

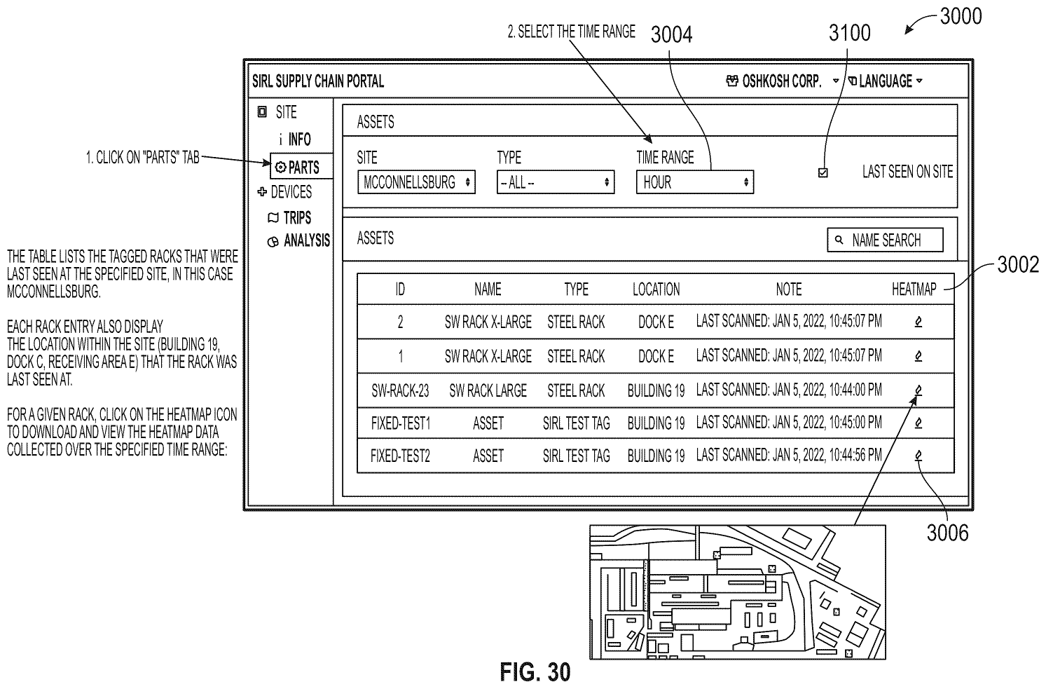

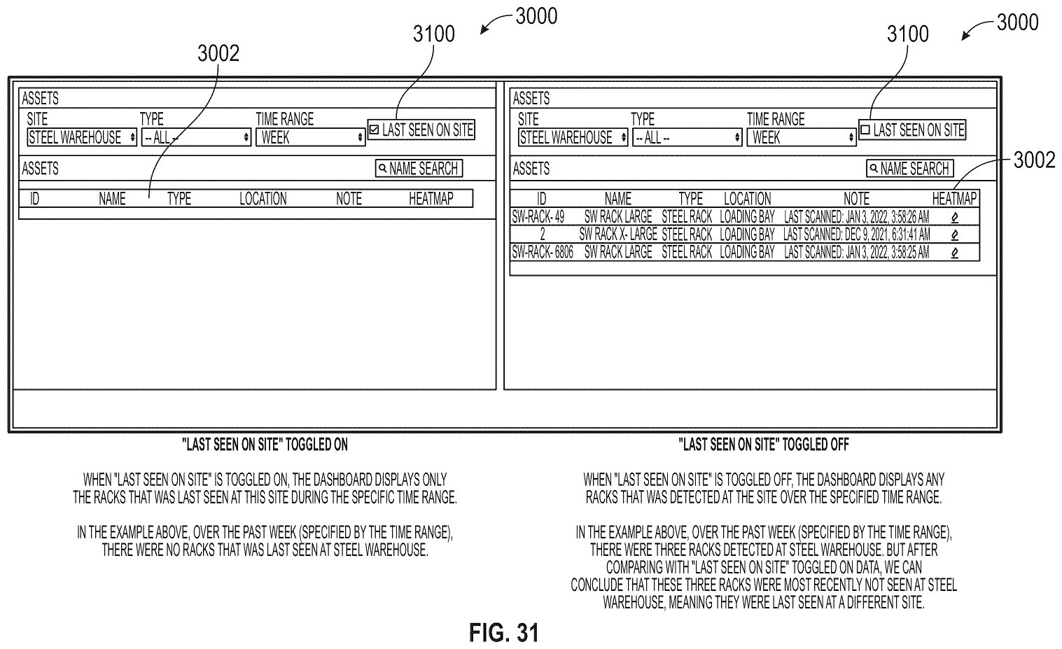

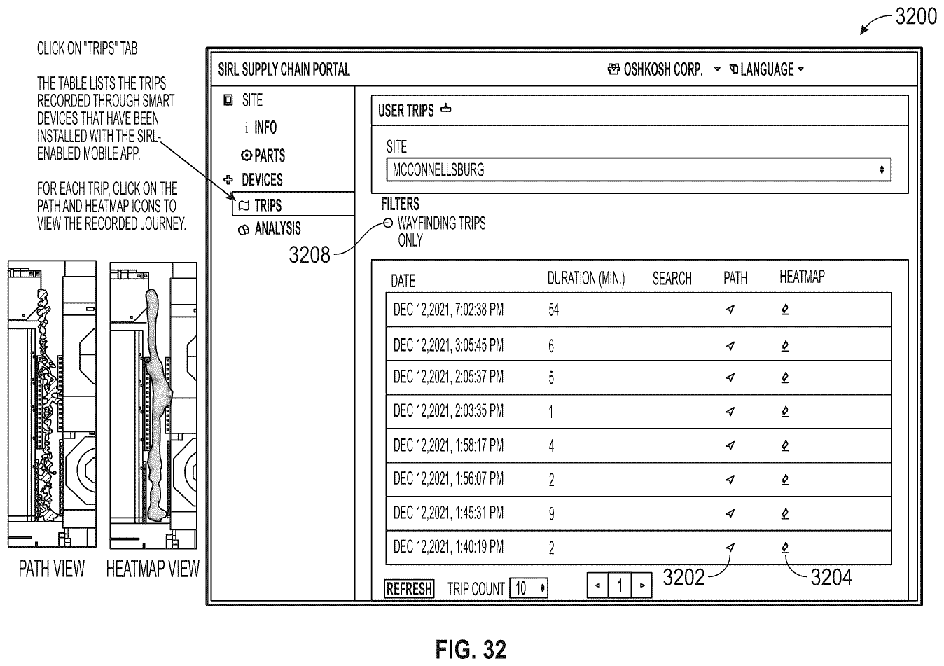

FIGS. 28-32 illustrate an application for interacting with the asset management system 100 similar to the application shown in FIGS. 23-27, according to some embodiments. FIG. 28 shows an info page 2800 where a user can select a worksite from a worksite dropdown 2802 and can review statistics relating to the equipment in the asset location system 110 in the site statistics window 2804. The user can select the satellite health button 2806 to view the operational statuses of the sensors 112 and gateways 202. FIG. 29 shows the satellite health page 2900 (e.g., similar to the dashboard 2502) where the operational statuses of the sensors 112 and gateways 202 can be monitored after selecting the satellite health button 2806. FIG. 30 shows an asset info page 3000 (e.g., similar to the dashboard 2402) including a list of assets 3002 on the selected worksite. The user may select a time range from the time range dropdown 3004 to see all assets that have been detected on the worksite within the selected time range. The user may select a heatmap button 3006 to view a heatmap (e.g., similar to the heatmap 2604) for the selected asset within the selected time range. FIG. 31 illustrates the functionality of a last seen on site toggle 3100 on the asset info page 3000, according to some embodiments. When the last seen on site toggle 3100 is selected, the list of assets 3002 includes only the assets most recently seen on the selected worksite. Assets that were more recently detected on a different worksite are excluded from the list of assets 3002. When the last seen on site toggle 3100 is deselected, all assets detected at the selected worksite within the selected time range are included in the list of assets 3002, even if they were more recently detected on a different worksite. FIG. 32 illustrates a trips dashboard 3200, according to some embodiments. The trips dashboard 3200 shows the movement of mobile devices (e.g., smartphone 120, tablet 124, etc.) on the worksite. Each trip taken by a mobile device is recorded on a list of trips 3202. A user may select a path icon 3204 to view the path of the mobile device (e.g., similar to the visualization 2602) or may select a heatmap icon 3206 to view a heatmap of the location of the mobile device (e.g., similar to the heatmap 2604). The user may select the wayfinding trips filter 3208, which may cause the list of trips 3202 to show only trips in which the application provided wayfinding directions to the user (e.g., directions to a specific asset).

### System Functionalities

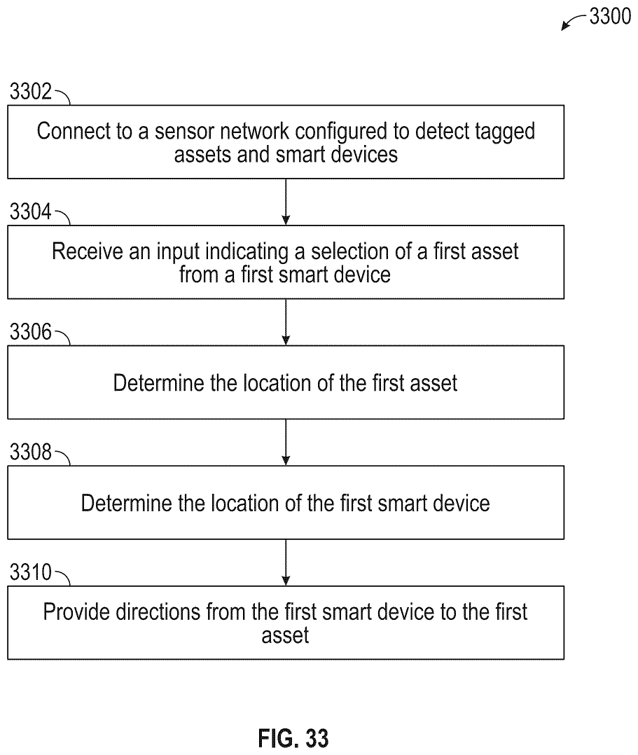

Referring now to FIG. 33, a method 3300 of locating an asset is shown, according to some embodiments. The method may be performed, for example, by the local controller 130, a smart device such as a smartphone 120 or tablet 124, or by a cloud computing system 140 of the asset management system 100. At operation 3302 of the method 3300, a connection is made to a sensor network (e.g., asset location system 110). The sensor network may include a plurality of sensors (e.g., sensors 112) that are configured to detect assets (e.g., assets 114 coupled to tracking tags 116, etc.) and smart devices (e.g., smartphones 120, tablets 124, etc.). For example, the sensors may detect radio frequency signals from the tracking tags and the smart devices. The sensors may be configured to detect a signal strength from the tracking tags 116. A stronger signal from a tracking tag 116 may correlate to the tracking tag being closer to a sensor. Thus, the distance from a tracking tag 116 to a sensor may be estimated based on the signal strength (e.g., the RSSI). At operation 3304 of the method 3300, an input is received from a first smart device (e.g., a smartphone 120) indicating a selection of a first asset. The first asset may be selected from a list of assets that may be narrowed by category and subcategory (e.g., asset type, operational status, asset weight, etc.). In some embodiments, a user may search for the first asset via search field. At operation 3306 of the method 3300, the location of the first asset is determined based on sensor data from the sensor network. For example, multiple sensors 112 may detect the presence of a tracking tag 116 coupled to an asset 114, and a RSSI for the tracking tag 116 may be determined for each sensor 112 that detects the tracking tag 116. The location of the tracking tag 116 may be determined based on the RSSIs from each sensor 112 that detects the tracking tag 116. For example, a strong RSSI indicates that the tracking tag 116 is close to the sensor 112 and a weak RSSI indicates that the tracking tag 116 is farther from the sensor 112. With data from enough sensors 112, the specific location of the tracking tag can be determined.

In some embodiments, the location of each smart device or other asset with a tracking tag may be continuously or periodically determined and stored in a database. Thus, when an asset is selected at operation 3304, the database can be queried to determine the location of the asset. Additionally or alternatively, as discussed above, new measurements from the sensors 112 can be used to detect the current location of the asset. If the asset cannot be detected at the time of the request, a message may be displayed by the smart device indicating that the asset cannot be found, and the most recent location stored in the database can be provided. In still other embodiments, the selected asset may not include a tracking tag or any way for the sensors 112 to detect the location of the asset at all. Instead, the location may be determined based on predefined storage locations. For example, a warehouse may include various assets that are stored in specific storage locations (e.g., on a specific shelf in a specific bay in a specific aisle in a row of aisles). In this case, determining the location of the asset may include identifying the specific storage location by querying a database of storage locations rather than receiving data from the sensors 112. If the asset is stored in the correct location, identifying the storage location will also identify the location of the asset. At operation 3308 of the method 3300, the location of the first smart device is determined. The location of the first smart device can be determined in essentially the same way that the location of the first asset was determined in operation 3306. At operation 3310 of the method 3300, directions from the first smart device to the first asset are provided to the first smart device. The directions may be displayed as a list (e.g., turn-by-turn directions) and/or as a map with an arrow or path indicator highlighting the path from the smart device to the selected asset. In some embodiments, any other means of wayfinding can be provided to the smartphone to guide the user to the determined location of the asset. Using the method 3300, a user may choose an asset that the user wishes to find, and directions to the asset may be provided via the smart device. In some embodiments, a GUI may be generated and provided to the first smart device. The GUI may include a map showing the location of the smart device and the asset, as well as directions from the location of the smart device to the location of the asset.

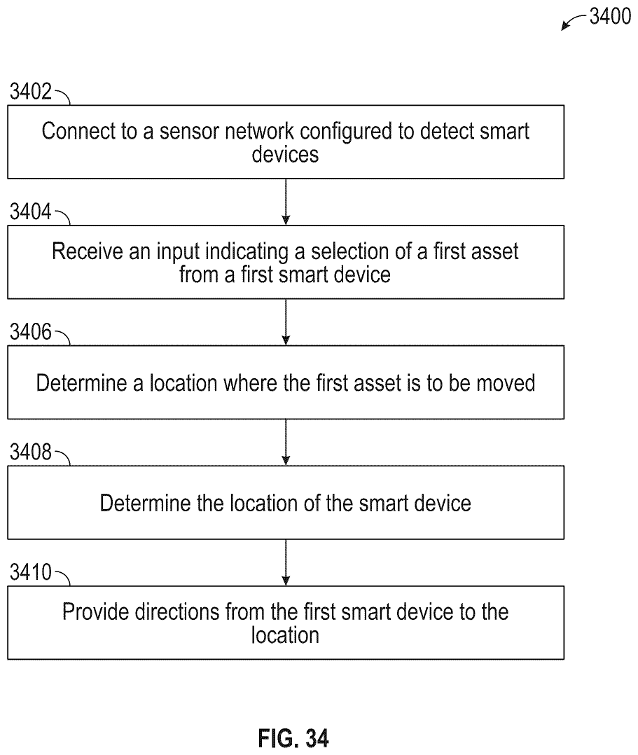

Referring now to FIG. 34, a method 3400 of moving an asset is shown, according to some embodiments. The method may be performed, for example, by the local controller 130, a smart device such as a smartphone 120 or tablet 124, or by a cloud computing system 140 of the asset management system 100. At operation 3402 of the method 3400, a connection is made to a sensor network (e.g., asset location system 110). The sensor network may include a plurality of sensors (e.g., sensors 112) that are configured to detect smart devices (e.g., smartphones 120, tablets 124, etc.). For example, the sensors may detect radio frequency signals from the smart devices. At operation 3404 of the method 3400, an input is received from a first smart device indicating a selection of a first asset. In some embodiments, the first asset may be a machine, a tool, a vehicle, a manufacturing workpiece, or another piece of equipment. In some embodiments, the first asset may not include a tracking tag (e.g., a tracking tag 116). However, the first asset may be identifiable by name, by asset type (e.g., a wrench, a hammer, a forklift, etc.), or by an asset number (e.g., a serial number). The first asset may be selected by a user using the first smart device. For example, the user may enter the asset name or serial number into a search field and may select the first asset from a list of search results. In some embodiments, the user may be able to use a camera of the smart device to scan a serial number or barcode on the first asset to indicate the selection of the asset. At operation 3406 of the method 3400, a location where the first asset is to be moved is determined. For example, a user may be relocating tools to their workstations at the end of a workweek. A database relating tools to workstations may be queried to determine the workstation where the selected tool belongs. In other embodiments, the first asset may be a workpiece that is moved from station to station where different machining and coating processes may be performed. A database indicating which processes have been performed on a specific workpiece may be queried, and the next station in the manufacturing process may be determined to be the location where the workpiece is to be moved. For example, a workpiece may have a laser cutting process, a hole tapping process, and an anodizing process. The database may indicate that the laser cutting process and the hole tapping process have already taken place, and it may be determined that the location that the workplace is to be moved to is the anodizing station. At operation 3408 of the method 3400, the location of the first smart device is determined. Operation 3408 may be the same as or similar to operation 3308. At operation 3410 of the method 3400, directions from the first smart device to the determined location are provided to the first smart device. As discussed above with respect to operation 3310 of the method 3300, the directions may be provided in the form of turn-by-turn directions, a map with an arrow or path indicator leading to the determined location, or any other method that can be used to guide the user to the determined location. Thus, the user may receive the directions via the smart device and use them to bring the first asset to the determined location. Using the method 3400, a user may identify an asset, and directions to a location to which the asset is to be moved may be provided via the smart device. In some embodiments, a GUI may be generated and provided to the first smart device. In some embodiments, the GUI may include a map showing the location of the smart device and the asset.

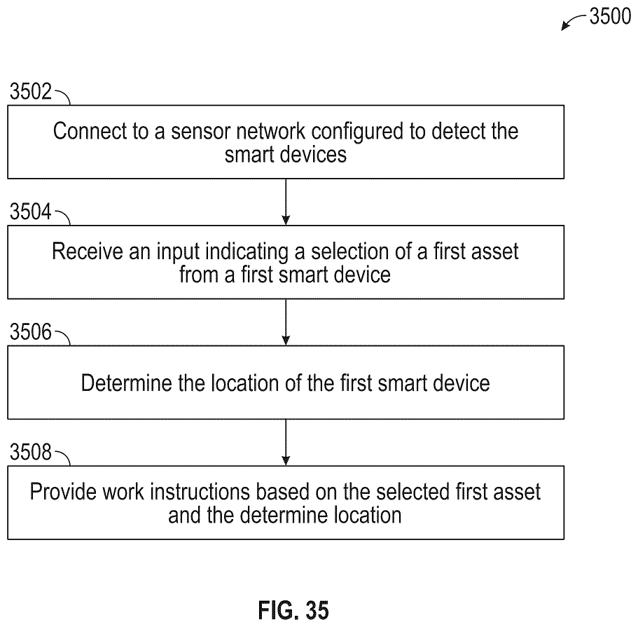

Referring now to FIG. 35, a method 3500 of receiving location-based work instructions is shown, according to some embodiments. The method may be performed, for example, by the local controller 130, a smart device such as a smartphone 120 or tablet 124, or by a cloud computing system 140 of the asset management system 100. At operation 3502 of the method 3500, a connection is made to a sensor network (e.g., asset location system 110). The sensor network may include a plurality of sensors (e.g., sensors 112) that are configured to detect smart devices (e.g., smartphones 120, tablets 124, etc.). For example, the sensors may detect radio frequency signals from the smart devices. At operation 3504 of the method 3500, an input is received from a first smart device indicating a selection of a first asset. Operation 3504 may be the same as or similar to operation 3404. At operation 3506 of the method 3500, the location of the first smart device is determined. Operation 3506 may be the same as or similar to operations 3308 and 3408. At operation 3508 of the method 3500, work instructions are provided based on the selected first asset and the location. For example, a user may identify a workpiece that requires a manufacturing process including a laser cutting process, a hole tapping process, and an anodizing process. If the location of the first smart device is determined to be a hole tapping station, hole tapping instructions specific to the identified workpiece may be provided. In another example, the user may identify a forklift as the selected first asset and the location may be determined to be a storage area. The instructions provided may be to lift a specific pallet of material in the storage area using the forklift and to bring the material to another location. In some embodiments, a GUI including the instructions may be generated and provided to the first smart device. The GUI may include a map indicating the location of the smart device and the destination for the pallet of material and directions to the location. In some embodiments, the work instructions may include moving the selected asset to another location. For example, the user may input the selected asset in operation 3504, and the instructions provided in operation 3508 may be to take the selected asset to a second location and use the asset in that location. The instructions may include directions to the second location and/or a map guiding the user to the second location. Upon arriving at the second location, the GUI may update from showing the directions or map to showing instructions for using the asset at the second location.

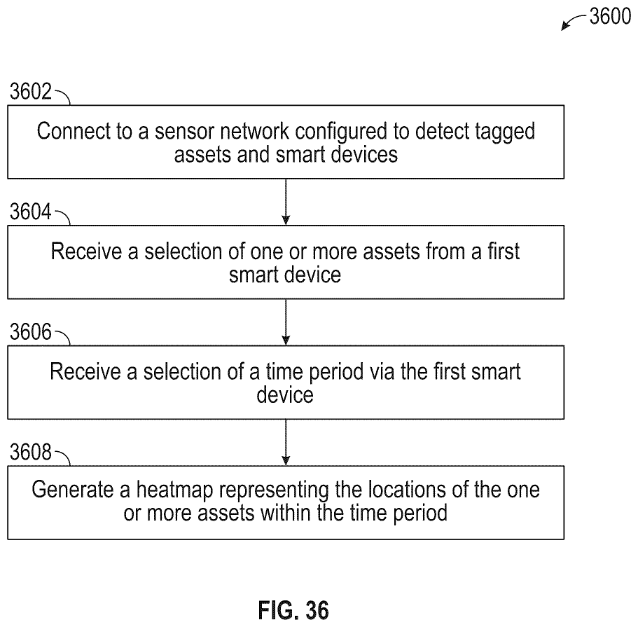

Referring now to FIG. 36, a method 3600 of generating an asset tracking heatmap is shown, according to some embodiments. The method may be performed, for example, by the local controller 130, a smart device such as a smartphone 120 or tablet 124, or by a cloud computing system 140 of the asset management system 100. At operation 3602 of the method 3600, a connection is made to a sensor network (e.g., asset location system 110). The sensor network may include a plurality of sensors (e.g., sensors 112) that are configured to detect assets (e.g., assets 114 coupled to tracking tags 116, etc.) and smart devices (e.g., smartphones 120, tablets 124, etc.). For example, the sensors may detect radio frequency signals from the tracking tags and the smart devices. The locations of the assets may be determined based on the signals and continuously monitored. At operation 3604 of the method 3600, a selection of one or more assets is received from a first smart device (e.g., a smartphone 120). For example, a user may select a group of similar workpieces or tools from a list of assets, or may search a list of assets by asset name, asset type, or asset number, etc. At operation 3606 of the method 3600, a selection of a time period is received from a first smart device. For example, a user may select a time period such as the past week, the past hour, a specific date, a specific range or list of dates, etc. At operation 3608 of the method 3600, a heatmap (e.g., heatmap 2604) is generated (e.g., on a GUI provided to the smart device) representing the locations of the one or more assets within the selected time period. Locations where assets spent more time within the time period may appear darker, while locations where the assets spent little or no time may appear lighter (or vice versa). This heatmap can be used to determine where assets are remaining for long periods of time in order to identify issues and improve efficiency.

### Additional Asset Management System Embodiments

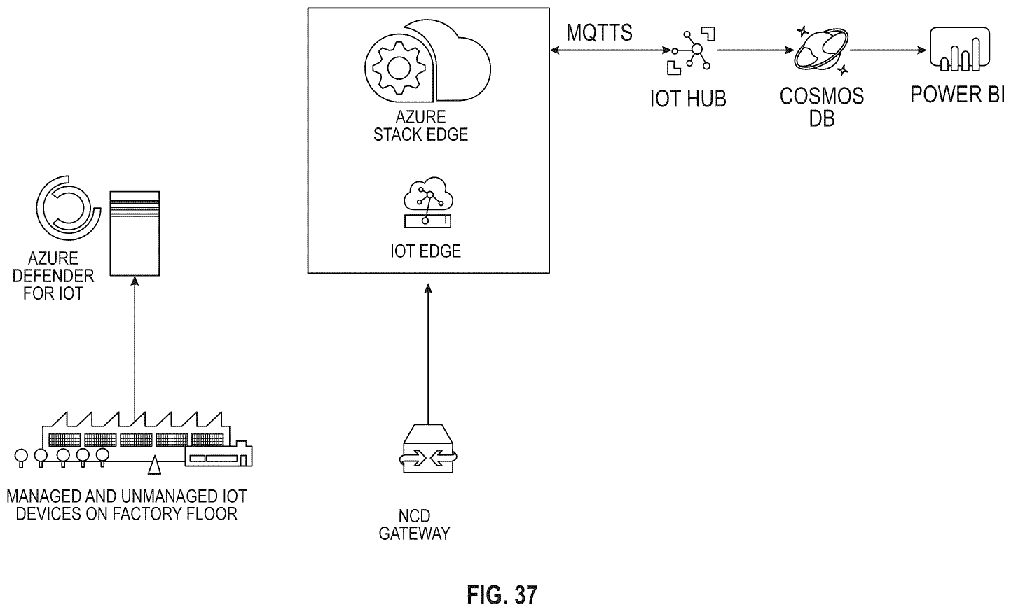

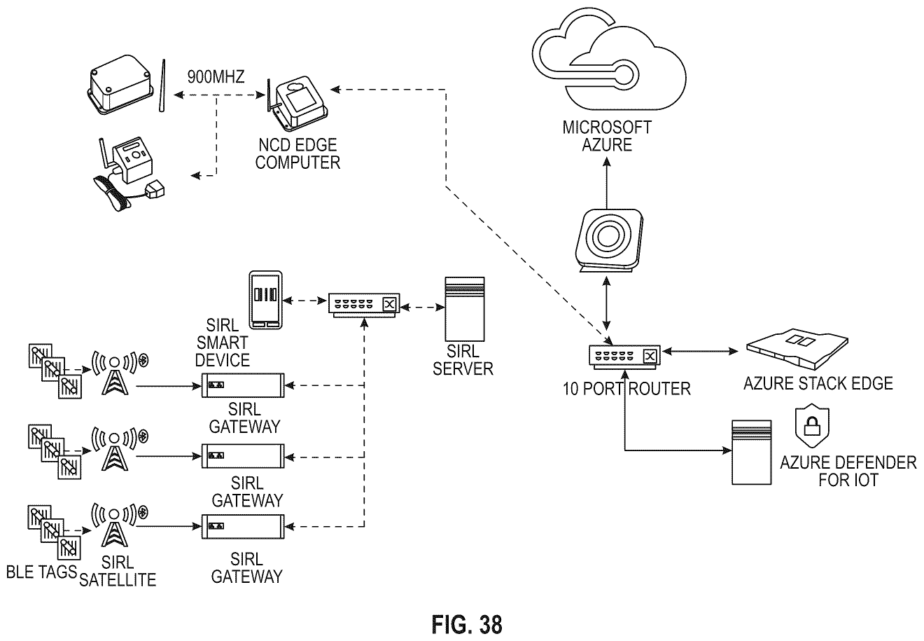

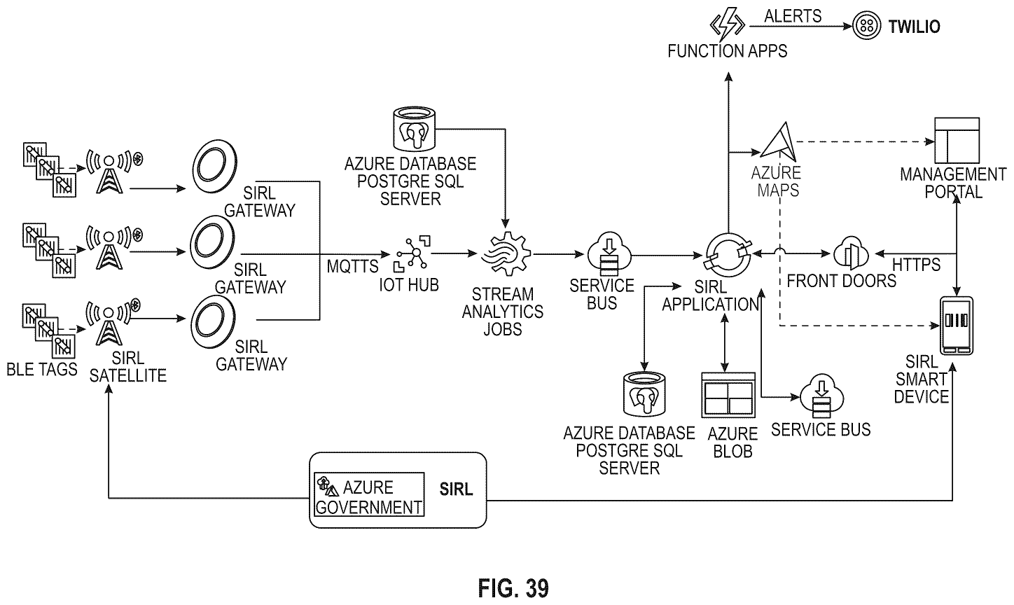

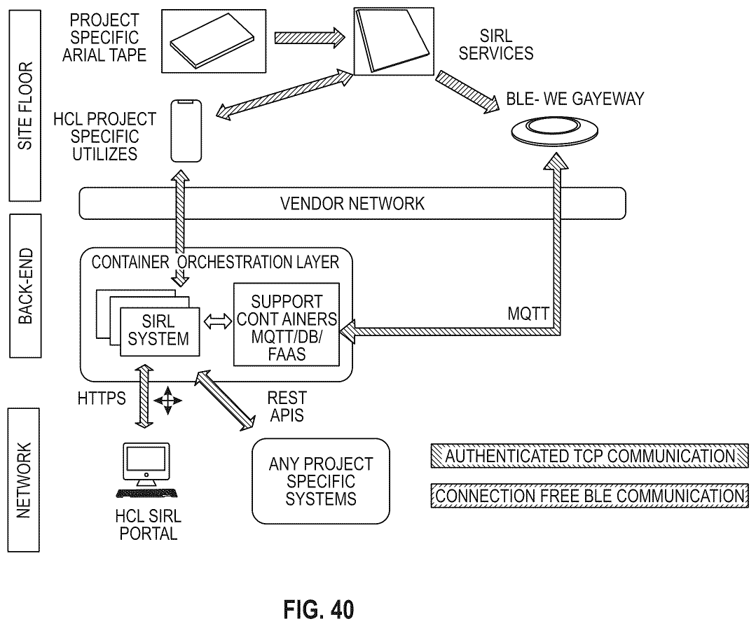

FIGS. 37-40 show additional schematic diagrams of asset management systems (e.g., similar to the asset management system 100) including short-range sensors, according to some embodiments.

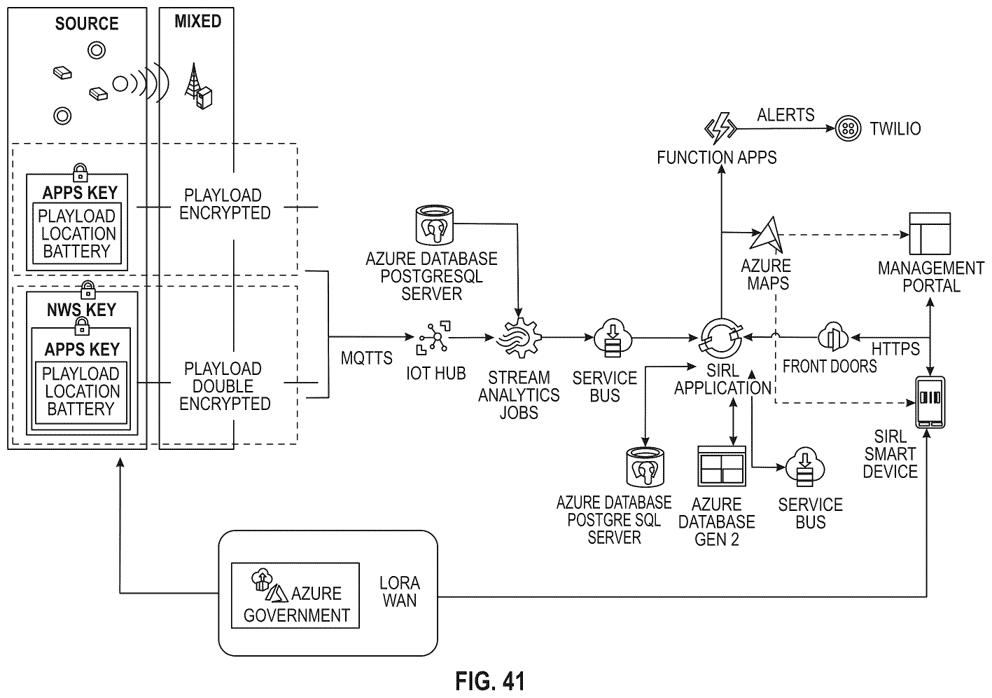

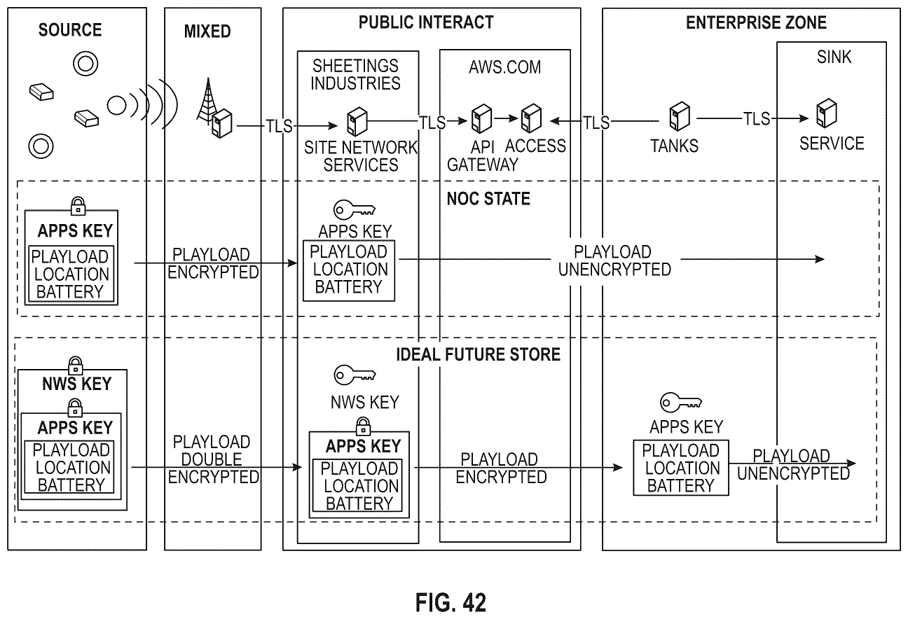

FIGS. 41 and 42 show additional schematic diagrams of asset management systems (e.g., similar to the asset management system 100) including long-range sensors (e.g., LoRa WAN sensors, according to some embodiments.

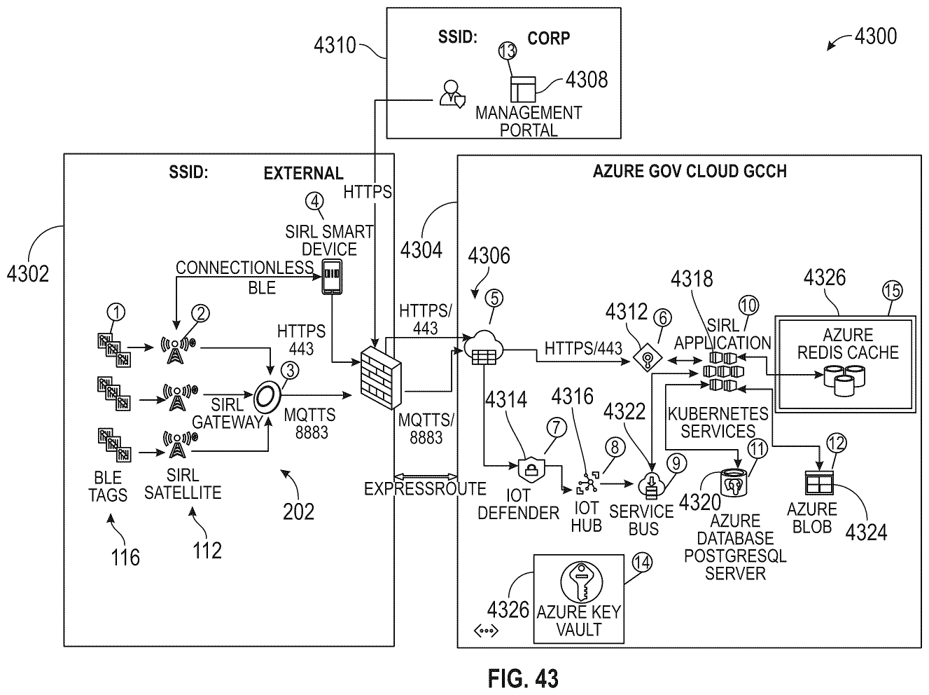

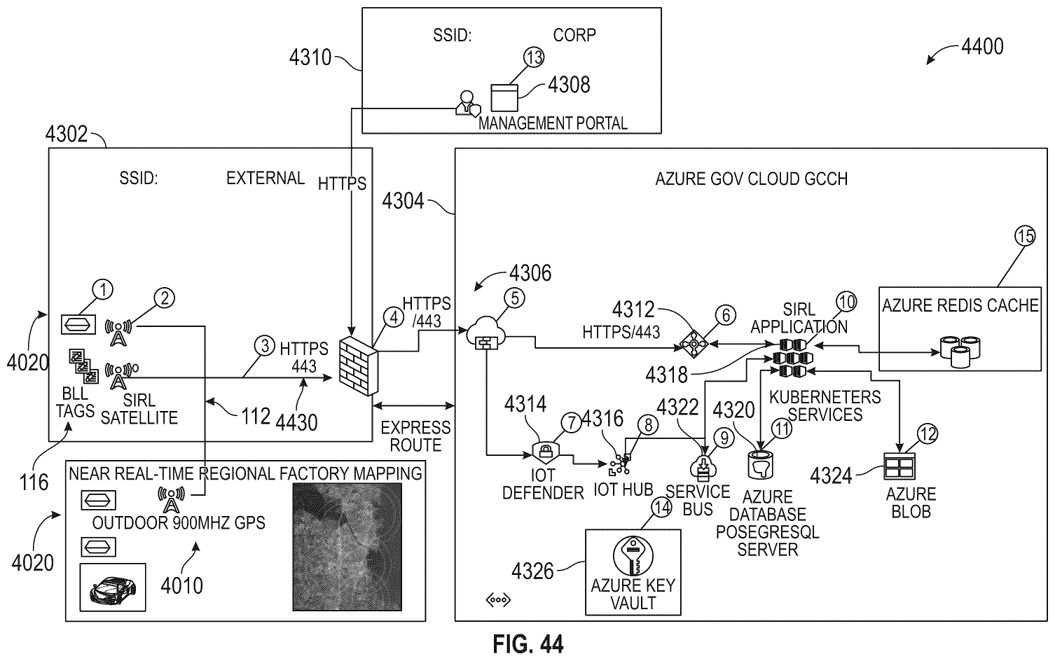

FIG. 43 show a schematic diagram of an asset management system 4300 (e.g., similar to the asset management system 100), according to some embodiments. The system 4300 includes a first service set 4302 including tracking tags 116, sensors 112, and smart devices (e.g., smartphone 120) as described above in a first service set 4302. The computing functions of the system 4300 are performed by components in a second service set 4304, which is separated from the first service set 4302 by a firewall 4306. A management portal dashboard 4308 is provided in a third service set 4310 provides advanced analytics and control functions via one or more dashboards to a user via an application. The second service set 4304 includes a load balancer 4312 and balancing network traffic and an IoT defender 4314 for malware protection. The second service set 4302 further includes an IoT Hub 4316 for managing messages between the management application 4318 and the on-premises assets (e.g., smartphone 120, tablet 124, etc.). The management application 4318 may be deployed to the Azure RedHat OpenShift (ARO) platform, which complements Kubernetes orchestration, simplifies platform support, and enhances container security. The two container types deployed in the Azure Kubernetes Service cluster consist of Backend/Worker Containers that service application requests and listen to IoT traffic, and a Frontend NGINX Container application hosting the Angular App. The second service set 4304 further includes a Post GRE SQL server 4320 for structured storage workloads and a service bus 4322, which provides a common messaging service to handle event and job processing in an asynchronous manner allowing both containers and functions to utilize queuing services as both producers and consumers. The storage device 4324 (e.g., an Azure Blob storage device) stores and retrieves mapping data, image files, etc. The key vault 4326 (e.g., Azure Key Vault or Hashicorp Vault, etc.) will be used to store, track, manage, and rotate security keys/certificates and other services. The Redis Cache 4326 is a data structure store configured for performance improvements.

FIG. 43 shows a schematic diagram of an asset management system 4400 (e.g., similar to the asset management system 4300), according to some embodiments. The asset management system 4400 includes most of the same components as system 4300, but also includes long-range detection sensors 4010 (e.g., LoRa WAN sensors, GPS) for detecting the movement of assets outdoors and between worksites. The assets may include larger, powered tracking tags 4020 that may emit radio frequencies in the range of 900 MHz to be detected by the long-range detection sensors 4010 at distances up to several miles away. The tracking tags 4020 may include short-range communications capability (e.g., via BLE) in addition to long-range communications capability.

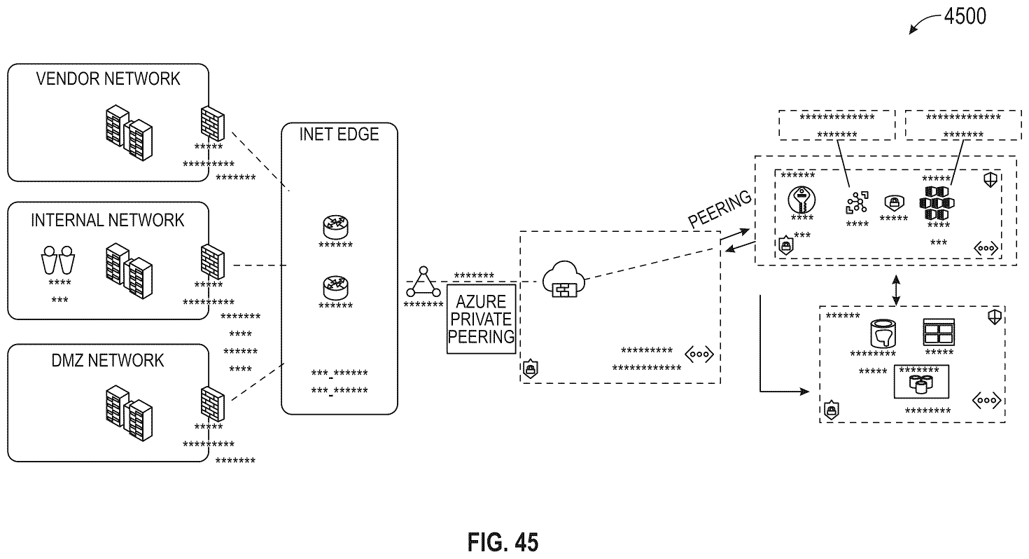

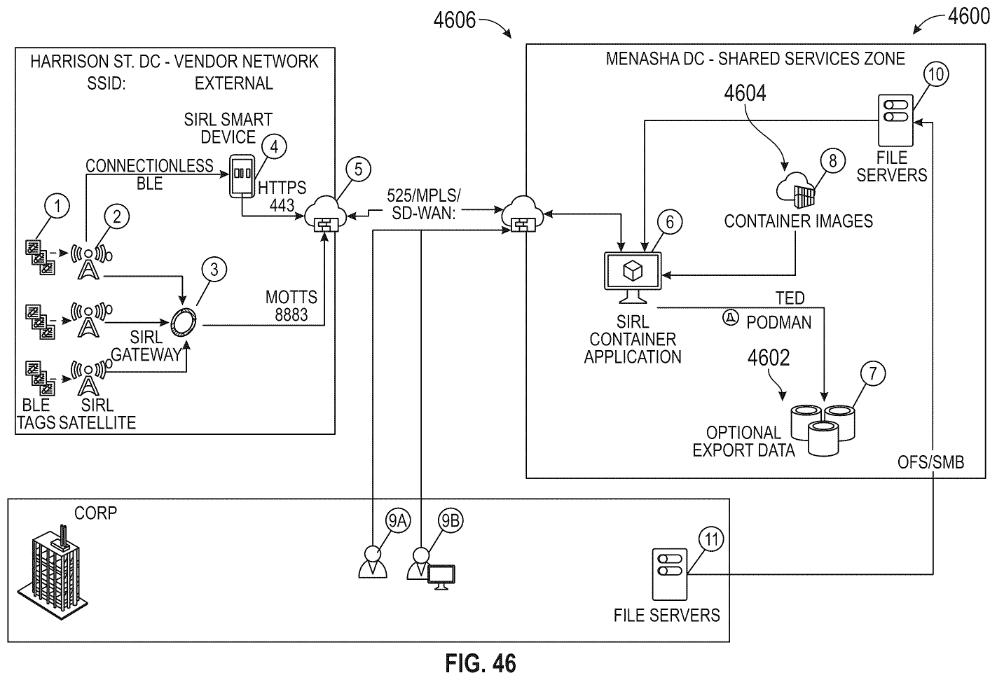

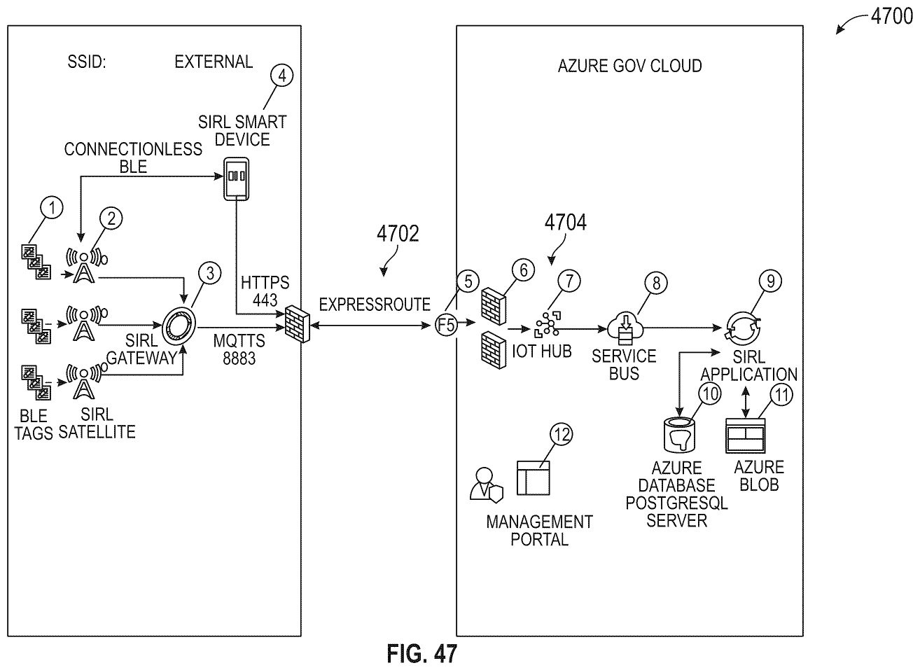

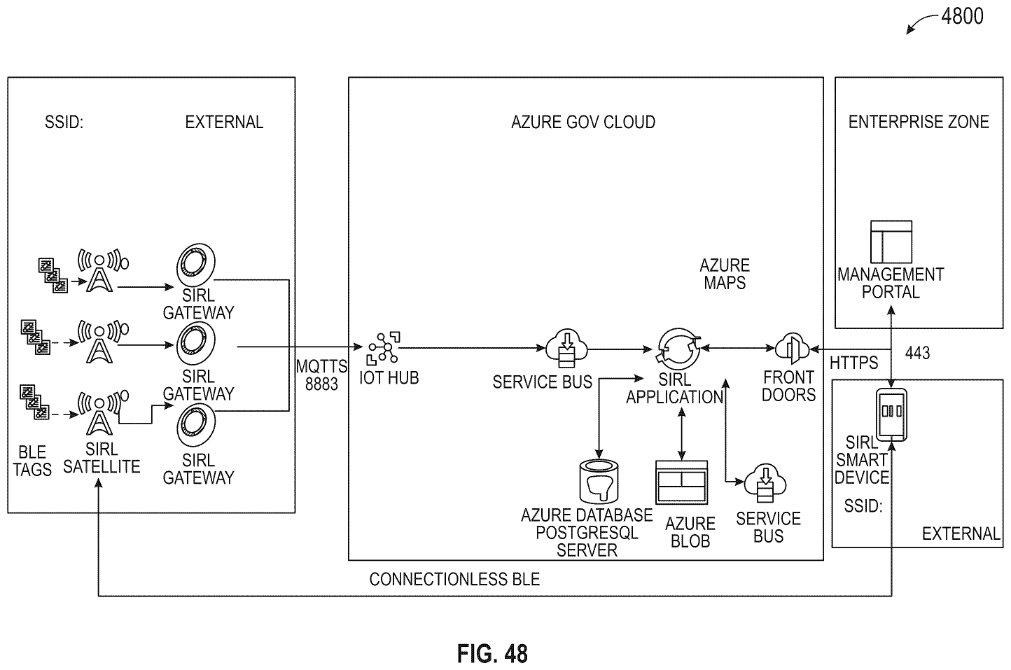

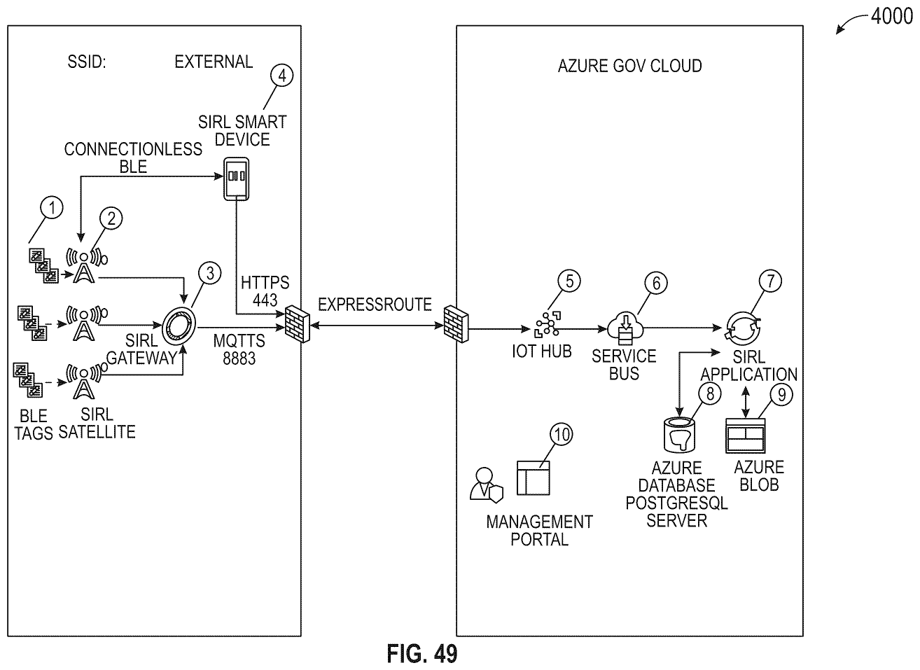

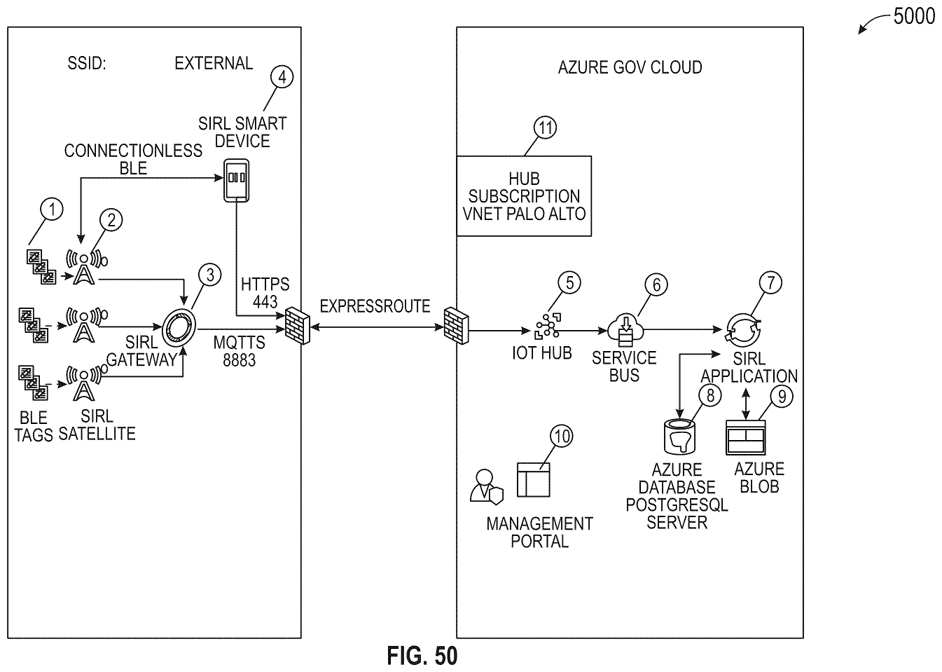

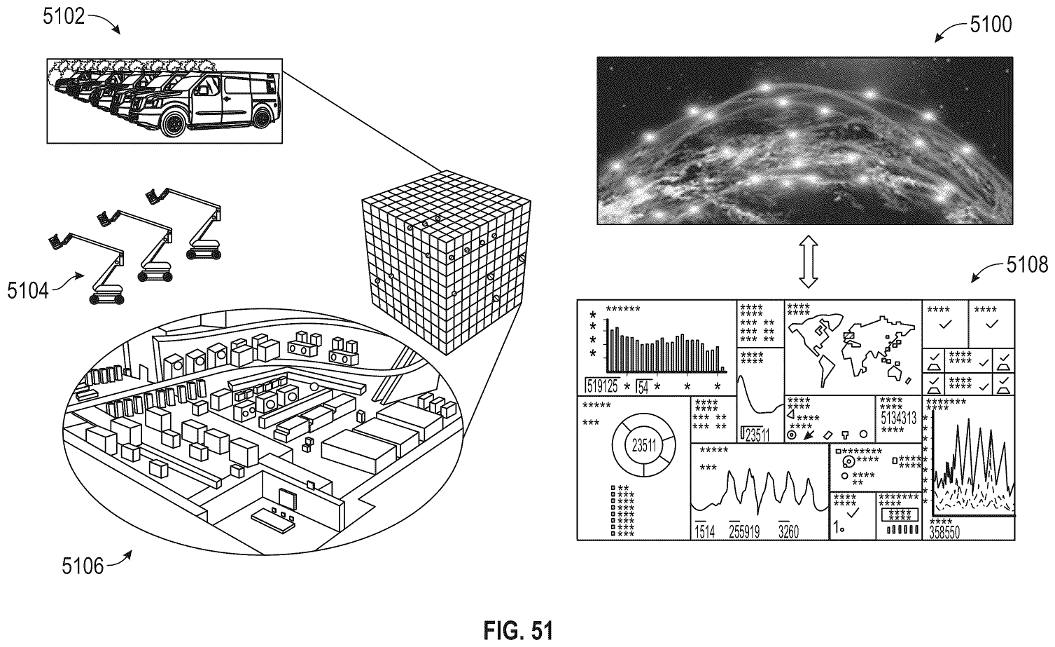

FIG. 45 shows a schematic diagram of an asset management system 4500 (e.g., similar to the asset management system 4300), according to some embodiments. FIG. 46 shows a schematic diagram of an asset management system 4600 (e.g., similar to the asset management system 4300), according to some embodiments. The system 4600 includes an additional export data storage 4602 for additional analytics and a storage directory 4604 for container images in a shared services zone 4606. FIG. 47 shows a schematic diagram of an asset management system 4700 (e.g., similar to the asset management system 4300), according to some embodiments. The system 4700 includes a load-balancing layer 4702 and a load-balanced firewall 2704. FIG. 48 shows a schematic diagram of an asset management system 4800 (e.g., similar to the asset management system 4300), according to some embodiments. FIG. 49 shows a schematic diagram of an asset management system 4900 (e.g., similar to the asset management system 4300), according to some embodiments. FIG. 50 shows a schematic diagram of an asset management system 5000 (e.g., similar to the asset management system 4300), according to some embodiments. FIG. 51 shows a diagram 5100 representing the features of an asset management system (e.g., similar to the asset management system 4300). The system 4300 may be used to track the locations of vehicles (including military vehicles 5102), work machines 5104 (e.g., forklifts, man lifts, excavators, etc.), and tracking tags 116 coupled to assets 114 on worksites (e.g., worksite 5106). The system 4300 can collect and data from multiple worksites across the globe, conduct analysis (including, e.g., algorithms, automated scripts, advanced analytics, artificial intelligence and or other techniques) on the data, and provide dashboards (e.g., dashboard 5108) providing human-readable analysis (e.g., charts, timelines, heatmaps, other visualizations, etc.) to enable improved decision support.

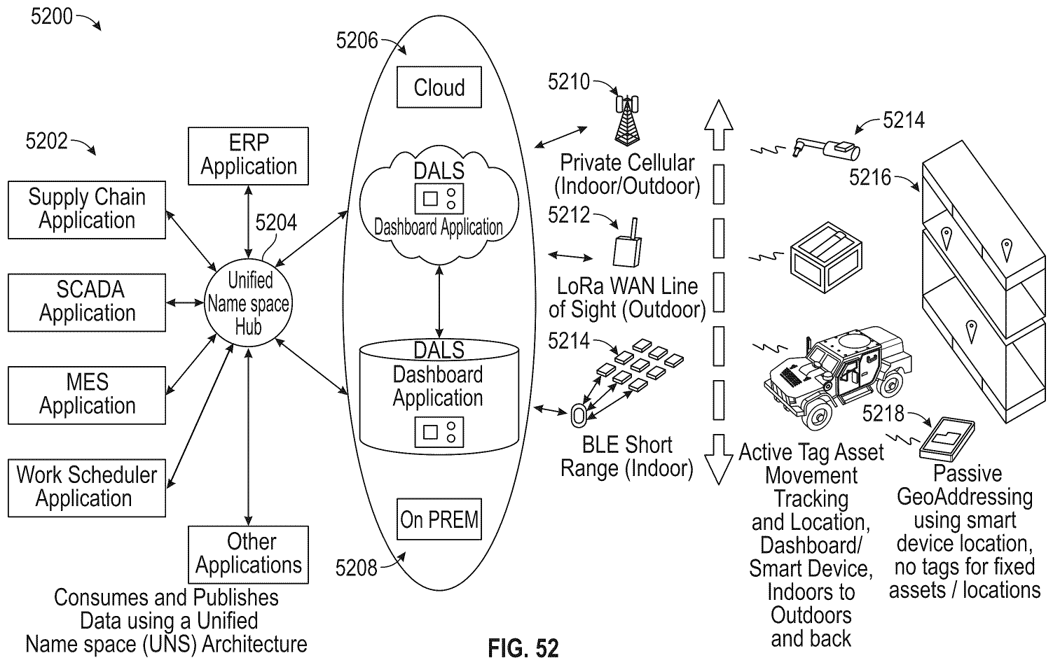

Referring now to FIG. 52, a schematic diagram of an asset management system 5200 is shown, according to some embodiments. The asset management system 5200 may be substantially similar to the asset management systems described above. The system 5200 may include multiple applications 5202 configured to communicate with a Unified Namespace System (UNS) 5204. The UNS 5204 is an architecture configured to receive and distribute data to and from a variety of systems and applications (e.g., applications 5202), acting as a centralized repository of asset management information. The applications 5202 may include an enterprise resource planning (ERP) application for managing various business activities such as accounting, procurement, project management, risk management and compliance, and supply chain operations. Other applications 5202 may include a dedicated supply chain application and a dedicated work scheduling application. The applications 5202 may also include a supervisory control and data acquisition (SCADA) application for gathering and analyzing real-time data to monitor and control equipment and a manufacturing execution system (MES) application for optimizing manufacturing processes by monitoring, tracking, documenting, and controlling the entire production lifecycle. Each application 5202 communicates with the UNS 5204, which receives data from each application and publishes the data for access by the other applications.

The UNS 5204 also communicates with a digital asset location system (DALS), which may include a cloud-based application 5206, a on-premises application 5208, or both. The DALS application 5206, 5208 may perform asset location tracking procedures as discussed above. For example, the DALS application 5206, 5208 may provide active asset tag tracking of assets 5214, such as tools, materials, and equipment. The DALS application 5206, 5208 may provide dashboards, including directions, instructions, and maps, to a smart device 5218. The DALS application 5206, 5208 may store and provide locations of fixed assets, such as locations on shelves 5216 where assets are to be stored and where those assets can be found later. The DALS application 5206, 5208 may communicate with the assets (e.g., via the asset tags) and/or smart devices via a cellular network 5210, via a LoRa WAN system 5212, or via a BLE connection 5214.

### Digital Asset Location System for Hazard Detection

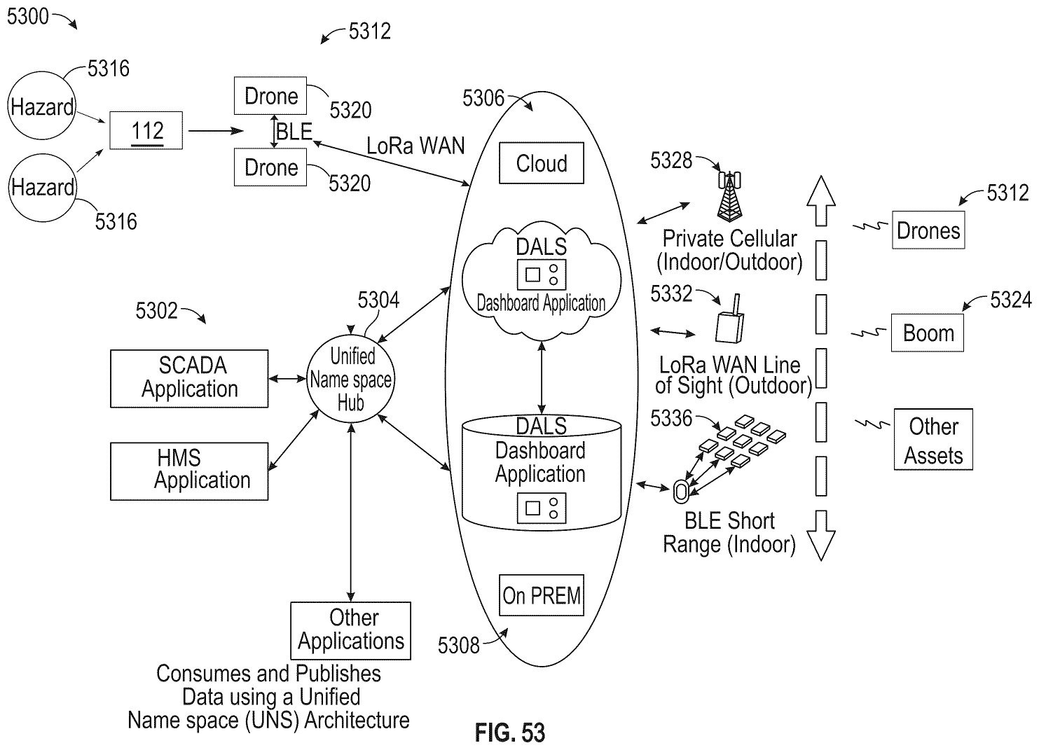

Referring now to FIG. 53, a schematic diagram of an asset management system 5300 is shown, according to some embodiments. The asset management system 5300 may be substantially similar to the asset management systems described above. The system 5300 may include multiple applications 5302 configured to communicate with a Unified Namespace System (UNS) 5304. The UNS 5304 is an architecture configured to receive and distribute data to and from a variety of systems and applications (e.g., applications 5302), acting as a centralized repository of asset management and location information. The applications 5302 may include an a supervisory control and data acquisition (SCADA) application for gathering and analyzing real-time data to monitor and control equipment and a hazard management system (HMS) application for monitoring, tracking, and documenting information relating to detected hazards. Each application 5302 communicates with the UNS 5304, which receives data from each application and publishes the data for access by the other applications.

The UNS 5304 also communicates with a digital asset location system (DALS), which may include a cloud-based application 5306, a on-premises application 5308, or both. The DALS application 5306, 5308 may perform asset location tracking procedures as discussed above. For example, the DALS applications 5306, 5308 are centralized and remotely accessible for displaying current, past, and predicting future geolocation of wirelessly tagged assets such as tools, components, finished goods, etc., throughout an organization's digital ecosystem. The DALS application 5306, 5308 integrates geolocation technologies to determine three-dimensional positioning information of assets with Bluetooth low energy (BLE), LoRa WAN, private cellular networks and/or any other wireless technologies. The information relating to the positioning of the assets may be published to a centralized data pool that can be accessed by a variety of systems and applications (e.g., applications 5302). As discussed in greater detail above, the DALS application 5306, 5308 can identify, store, and provide three-dimensional geolocations of fixed assets. Assets can be found using any system device connected to the DALS application 5306, 5308.

According to an exemplary embodiment, the DALS application 5306, 5308 is configured to perform location tracking of hazards detected by a fleet of drones 5312 (e.g., unmanned aerial vehicles (UAVs), autonomously guided vehicles (AGVs), deployable ground vehicles, unmanned reconnaissance units, etc.). The fleet of drones 5312 can be deployed from a convoy (e.g., one or more combat units deployed on a mission) during dangerous situations, high-risk scenarios, and contested environments to provide forewarning to the convoy of any potential hazards 5316 in the surrounding area. Deploying the fleet of drones 5312 reduces personnel exposure to the potentially dangerous hazards 5316, increases the area capable of being covered by the convoy, and increases the speed at which the convoy can search (e.g., provide reconnaissance for) the area. The asset management system 5300 utilizes a low cost, rapidly deployable IoT system architecture.

The DALS application 5306, 5308 is configured to perform various tasks and identify valuable information that provides various advantages to the convoy during dangerous situations (e.g., combat, reconnaissance, etc.). The DALS application 5306, 5308 may identify a geolocation of hazards 5316 near the convoy and along a route being traveled by the convoy. The hazards 5316 may include enemy assets (e.g., enemy vehicles, systems, camps, improvised explosive devices (IEDs), etc.). The DALS application 5306, 5308 may perform Explosive Ordnance Disposal after the identification (e.g., via the fleet of drones 5312) of a hazard 5316. The DALS application 5306, 5308 may report, monitor, and/or direct the fire of projectiles. The DALS application 5306, 5308 may provide Battle Damage Assessment (BDA). The various tasks and capabilities of the DALS application 5306, 5308 are made possible by providing an open architecture low power radio frequency (RF) mesh network and an IoT Edge system designed to communicate with one or more fleets of drones 5312 and ground assets to receive data gathered by sensors 112.

The fleet of drones 5312 includes one or more individual drones 5320 including short-range communications capabilities (e.g., via BLE) to facilitate communications with nearby drone 530 to thereby establish an intra-mesh network communication within the fleet of drones 5312. The intra-mesh network communication may be realized using a phased array direction antenna system. The phased array direction antenna system may include one or more antennas (e.g., sensor nodes or satellite nodes positioned on the drones 5320) that phase a 360 degree view into individual segments in a phased array. In some embodiments, the phased array direction antenna system splits the 360 degree view into 15 degree or 30 degree directional segments. In other embodiments, the phased array direction antenna system splits the 360 degree view into directional segments that are more or less than 15 degrees or 30 degrees. In some embodiments, the phased array direction antenna system operates similarly to an aviation navigational aide such as Very High Range Omni-directional Range/Tactical Air Navigation (VORTAC) systems.

The drones 5320 in the fleet of drones 5312 communicate in the intra-mesh network via directional two-way BLE transmission. The intra-mesh network utilizing BLE directional two-way transmissions facilitates low radio frequency (RF) observability, reduces an overall electromagnetic (EM) emission of the fleet of drones 5312, and enables low power communications between nearby drones 5312 within the fleet of drones 5312. Low RF observability of the communications between the drones 5312 and low EM emission of the fleet of drones 5312 facilitates stealth of the fleet of drones 5312 during deployment.

The drones 5320 may be equipped with sensors 112 configured to detect hazards 5316. The sensors 112 may include one or more proximity sensors, infrared sensors, ultrasonic sensors, a vision system (e.g., cameras, etc.), Lidar sensors, radar sensors, metal detectors, and/or any other sensor configured to detect the hazards 5316. In some embodiments, the sensors 112 are configured to detect a strength of nearby RF sources and EM sources, which can be used to determine a distance from the hazard 5316 to the drone 5320. The sensors 112 may be communicatively coupled to the DALS application 5306, 5308 to transmit sensor data. In some embodiments, the sensors 112 may transmit sensor data to gateways, which relay the data to the DALS application 5306, 5308.

The drones 5320 may include IoT Edge processors configured to interpret signals (e.g., short-range wireless signals, sensor data, etc.) received from nearby drones 5320. Based on (i) a time delay between broadcasting (e.g., transmitting) and receiving the signals and (ii) a direction of the signals, a drone 5320 can determine its own position relative to other drones 5320 in the fleet of drones 5312. The IoT Edge onboard processors may be configured to optimize sensor data before being transmitted to the DALS application 5306, 5308. The asset management system 5300 facilitating the intra-mesh network of BLE to BLE communication between drones 5320 of the fleet 5312 may include one or more shepherd “gateway” vehicles configured to translate BLE communication to LoRa WAN communication.

In some embodiments, the drones 5320 can transmit position data and sensor data to the DALS application 5306, 5308 using a LoRa WAN communication system. Using and processing the position data of the fleet of drones 5312 and the sensor data collected by the sensors 112 of the drones 5320, the DALS application 5306, 5308 can generate a real-time map of the area surrounding the convoy (e.g., a battlefield, a route, etc.) including geolocations and three-dimensional representations of the detected hazards 5316. The DALS application 5306, 5308 may incorporate GPS data to enhance the generation of the map. In some embodiments, the DALS application 5306, 5308 operates to generate the map without using GPS data (e.g., in an environment where GPS is denied).

The DALS application 5206, 5208 may provide dashboards, including directions, instructions, and maps, to a user device, the fleet of drones 5312, a boom 5324, and/or any other piece of equipment or component of the convoy. The DALS application 5206, 5208 may store and provide locations of the drones 5320 and the hazards 5316 detected by the drones 5320. The DALS application 5306, 5308 may communicate with the fleet of drones 5312, the boom 5324, and/or any other assets and/or smart devices via a cellular network 5328, via a LoRa WAN system 5332, or via a BLE connection 5336. Similarly, the fleet of drones 5312, the boom 5324, and/or any other assets and/or smart devices may directly or indirectly communicate with each other via the cellular network 5328, via the LoRa WAN system 5332, or via the BLE connection 5336.

The boom 5324 can be used as a mobile communications tower for BLE, LoRa, cellular communication and/or any other electromagnetic communication system. In some embodiments, the boom 5324 uses a standard electro-optical or a phase array Synthetic aperture radar (SAR) approach in addition to the BLE, LoRa WAN, and/or cellular communication systems. By way of example, the boom 5324 may implement multi-sensor electro-optical targeting pods from FLIR for copters and UAVs. The boom 5324 may be configured to datalink (e.g., transmit information, signals, etc.) to overhead assets such as satellites or aircraft.

The boom 5324 may be configured to receive a signal (e.g., via LoRa WAN from DALS application 5306, 5308) relating to the location of one or more detected hazards 5316. The boom 5324 may include a phased array system to obtain angle of arrival and time distance information by having multiple sensors 112 on the boom 5324 or an extender included in the boom 5324. The phased array system may be used to detect and track the locations of one or more vehicles deployed in the convoy, the fleet of drones 5312, and or any other asset. In some embodiments, the boom 5324 may utilize an optical and/or radar system to detect and track the locations of one or more vehicles deployed in the convoy, the fleet of drones 5312, and or any other asset.

By utilizing a meshed network across multiple spectrums, the asset management system 5300 can determine multiple alternatives for triangulation, positioning, navigation, and timing. In some embodiments, the LoRa WAN system 5332 may be capable of data transmission of 1 to 3 miles and up to 10 miles of range with line of sight having a physical dimension of 1.0 inch by 1.47 inch. In some embodiments, the average power at maximum transmit power setting is 0.21 watts. The long range, small size, and low power of the LoRa WAN system 5332 is has a bandwidth of 293 bps to 20 Kbps suitable for data packets and condensed information from IOT edge processing. In some embodiments, the LoRa WAN system 5332 is configured having different dimensions and specifications. For higher bandwidth and lower range to support intra-mesh network communication between the fleet 5316, the BLE connection 5336 has a bandwidth up to 24 Mbps and a range of up to 175 feet with lower power consumption and size than LoRa WAN system 5332. In some embodiments, the BLE connection 5336 is configured having different dimensions and specifications.

The asset management system 5300 may implemented in combat situations. By way of example, before moving valuable assets (e.g., personnel, equipment, vehicles, etc.) into an area suspected to be dangerous, the fleet of drones 5312 can be deployed (e.g., from the Joint Light Tactical Vehicle (JLTV), from another asset, etc.) around the assets (e.g., forward, backward, along a perimeter, etc.) to expand the range of deployment of the convoy. The fleet of drones 5312 may be instructed to explore (e.g., drive, fly, etc.) the area. Using autonomy and pathfinding (e.g., via sensors 112), the fleet of drones 5312 spreads out into a commanded formation and scans the area to detect any potential hazards 5316. In some embodiments, the area is a predetermined perimeter around the convoy. In the event a drone 5320 detects a hazard 5316 (e.g., detects an IED using a metal detector), the drone 5320 transmits a location of the detected hazard 5316 to the DALS application 5306, 5308, the boom 5324, and/or any other centralized data pool (e.g., via the LoRa WAN system 5332).

By way of another example, one or more drones 5320 may lose communication (e.g., with the DALS application 5306, 5308, the boom 5324, etc.) while scanning an area. In such an example, the DALS application 5306, 5308 determines that the one or more drones 5320 have disappeared, been destroyed, or are otherwise lost. The area in which the one or more drones 5320 lost communication may be flagged as ‘HIGH RISK’ by the DALS application 5306, 5308, the boom 5324, and/or any other asset. A signal relating to the identification of an area as being flagged ‘HIGH RISK’ may be transmitted between the DALS application 5306, 5308, the boom 5324, and/or any other asset.

By way of another example, the scan of the area by the fleet of drones 5312 may identify and geolocate one or more hazards 5316 in the area. Analyzing the map generated based on the data collected by the fleet of drones 5312, the DALS application 5306, 5308, the boom 5324, and/or any other asset makes a determination that in a path (e.g., a route) that should be traveled to avoid the area identified as ‘HIGH RISK’ intersects with (e.g., includes) one or more of the hazards 5316 (e.g., IEDs) detected by the fleet of drones 5312. One or more drones 5320 may be commanded to travel over the detected hazards 5316 (e.g., IEDs) to detonate the hazards 5316. Upon detonation, the convoy may travel the route determined to avoid the area identified as ‘HIGH RISK’. In some embodiments, a drone 5320 commanded to travel over a detected hazard 5316 may not detonate. In such an embodiment, the convoy may travel to the location of the hazard 5316 that did not detonate and make a determination that the detected hazard 5316 was not a hazard 5316. The convoy may continue to travel along the route determined to avoid the area identified as ‘HIGH RISK’. In some embodiments, one or more drones 5320 may be commanded to be positioned between a detected hazard 5316 (or a suspected enemy) and the route of the convoy to provide active and passive reconnaissance (e.g., should the enemy begin moving in a direction towards the convoy).

The implementation of the asset management system 5300 provides various advantages. For example, without utilizing the fleet of drones 5312 to detect and communicate locations of hazards 5316, soldiers may have to travel into potentially dangerous areas and possibly encounter a hazard 5316 (e.g., an enemy, a undetected mine, etc.). The asset management system 5300 enables high mobility capabilities due to its small form factor. In some embodiments, the systems of the intra-mesh network included on the drones 5320 weigh less than 0.5 pounds which enables the platform that the system is mounted on to be highly maneuverable. In some embodiments, the drones 5320 weigh less than 25 pounds. In other embodiments, the drones 5320 are another weight (e.g., less than 20 pounds, 10 pounds, etc.). Rather than communicating to assets (e.g., the DALS application 5306, 5308, the boom 5324, etc.) over long ranges, the asset management system 5300 enables linking short-range communications (e.g., BLE to BLE communication between the drones 5320 of the fleet 5312) with long-range communications (e.g., LoRa WAN communication between the fleet 5312 and the DALS application 5306, 5308) into a mesh communication network that reduces an overall EM footprint of the asset management system 5300. High bandwidth BLE enables fleet 5312 coordination while LoRa WAN transmits key information at longer range from the fleet 5312 to the DALS application 5306, 5308, the boom 5324, and/or any other asset. Due to the commercial availability and well-defined standards of interfacing with DALS components, the asset management system 5300 can integrate on a plurality of host platforms. The asset management system 5300 is configured to be networked with asset management systems, other fleet systems, etc. to facilitate secure and safe communications within contested spaces (e.g., dangerous areas).

Traditional communication systems rely on high power and or directional systems to communicate in contested EM environments and over long distances. These traditional communication systems must be carried by large platforms that can accommodate the associated weight. Additionally, high power communications increase detectable signatures and decrease survivability of assets. Therefore, low power, lightweight, short range communication systems as discussed herein are more difficult to detect and are able to be integrated on any platform due to their low weight and energy requirements.

In some embodiments, a defense implementation of the DALS application 5306, 5308 with the fleet 5312 may decentralize the data pool (e.g., the cloud-based application 5306 and the on-premises application 5308). By distributing cloud-based application 5306 and the on-premises application 5308 across transmission and receiving capable nodes, a consensus model can be employed and displayed on the existing dashboard application. In such embodiments, the data pool may also enable a wider range of frequencies to be utilized across the variety of locations and potentially contested environments.

In some embodiments, the asset management system 5300 utilizes a Command & Control (C2) Network and Data Links system for data transmission between the fleet 5312 and other assets. A chain of transmitters and receivers can be used as a data network for command and control. Similarly, in highly contested spaces, a chain of transmitters and receivers can be used for tactical communication networks to reduce detection by enemies.

### Digital Asset Location and Verification System

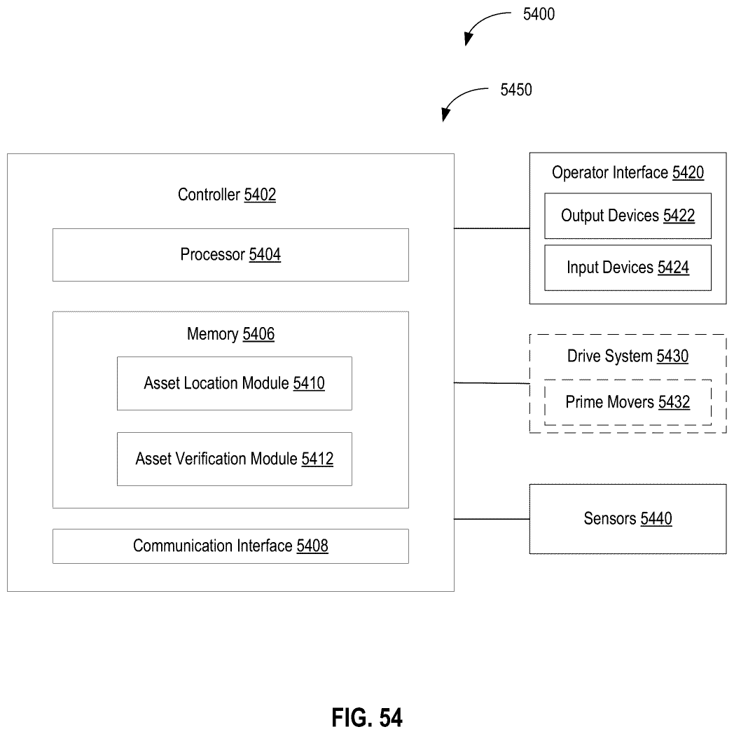

Referring to FIG. 54, a digital asset location and verification system (e.g., a control system) is shown as vision system 5400. The vision system 5400 includes a controller 5402; operator input and output devices, shown as operator interface 5420; a drivetrain, shown as drive system 5430; one or more sensors 5440; and one or more vision data collection devices (e.g., aerial drones, ground vehicles, stationary cameras, autonomous robots, autonomous dogs, robotic quadrupeds, robotic humanoids, robotic bipeds, robotic arms, etc.), shown as vision agents 5450. The operator interface 5420, the drive system 5430, the sensors 5440, and the vision agents 5450 may be in communication with the controller 5402 to control operation of the operator interface 5420, the drive system 5430, the sensors 5440, and the vision agents 5450. In some embodiments, the vision system 5400 (e.g., the vision agents 5450) omits the drive system 5430. By way of example, the vision agents 5450 configured as cameras (e.g., cameras 5456) may not include the drive system 5430, while the vision agents 5450 configured as aerial drones (e.g., drones 5452), ground vehicles (e.g., vehicles 5454), robotic quadrupeds (e.g., robotic quadrupeds 5458), robotic bipeds (e.g., robotic bipeds 5460) may include the drive system 5430. In some embodiments, the vision system 5400 includes more or fewer components.

As shown in FIG. 54, the vision agents 5450 include the controller 5402 and are configured to perform any of the functions or processes described herein with respect to the vision system 5400 and the controller 5402 locally. However, it should be understood that any of the functions or processes described herein with respect to the vision system 5400 (e.g., the controller 5402) may be performed by the vision system 5400, the asset management system 100, 200, 300, 4300, 4400, 4500, 4600, 4700, 4800, 4900, 5000, 5200, and/or 5300. By way of example, data collection may be performed by the vision system 5400 and data analytics may be performed by one or more of the asset management system 100, 200, 300, 4300, 4400, 4500, 4600, 4700, 4800, 4900, 5000, 5200, and/or 5300. By way of another example, data collection may be performed by the vision system 5400, a first portion of data analytics may be performed by the vision system 5400, and a second portion of data analytics may be performed by one or more of the asset management system 100, 200, 300, 4300, 4400, 4500, 4600, 4700, 4800, 4900, 5000, 5200, and/or 5300. By way of still another example, a first portion of data collection may be performed by the vision system 5300, a second portion of data collection may be performed by one or more of the asset management system 100, 200, 300, 4300, 4400, 4500, 4600, 4700, 4800, 4900, 5000, 5200, and/or 5300, and data analytics may be performed by the vision system 5300 and/or one or more of the asset management system 100, 200, 300, 4300, 4400, 4500, 4600, 4700, 4800, 4900, 5000, 5200, and/or 5300.

According to an exemplary embodiment, the operator interface 5420 is configured to provide an operator with the ability to control one or more functions of and/or provide commands to the vision system 5400 and the components thereof (e.g., turn the vision agents 5450 ON or OFF, control navigation of the vision agents 5450, etc.). As shown in FIG. 54, the operator interface 5420 includes one or more output devices 5422 and one or more input devices 5424. The output devices 5422 may include one or more displays such as a touchscreen, a LCD display, a LED display, gauges, warning lights, etc. The input devices 5424 may be or include buttons, switches, knobs, levers, dials, keyboards, mouses, remote controllers, etc.

According to an exemplary embodiment, the drive system 5430 is configured to move (e.g., propel, steer, navigate, actuate, position, orient, etc.) the vision agents 5450. In some embodiments, the drive system 5430 includes one or more tractive elements (e.g., wheel and tire assemblies, tracked assemblies, etc.) rotatably coupled to the vision agents 5450. The tractive elements are configured to engage a support surface (e.g., the ground) to support the vision agents 5450. In some embodiments, the drive system 5430 includes one or more lift elements (e.g., propulsive elements, rotors, propellers, props, wings, etc.) configured to facilitate aerial flight. The drive system 5430 may include one or more steering assemblies configured to steer or otherwise control a direction of motion of the vision agents 5450. By way of example, the steering assembly may include an actuator that pivots one or more of the tractive elements relative to a body of the vision agents 5450. By way of another example, the steering assembly may include one or more actuators configured to pivot one or more components or implements (e.g., arms, legs, support members, etc.) of the vision agents 5450.

The drive system 5430 includes one or more actuators, drive motors, or prime movers, shown as prime movers 5432, coupled to a body of the vision agents 5450. In some embodiments, the prime movers 5432 include one or more electric motors (e.g., AC motors, DC motors, etc.). In some embodiments, the prime movers 5432 include one or more internal combustion engines (e.g., gasoline engines, diesel engines, etc.). In some embodiments, the prime movers 5432 include one or more internal combustion engines and one or more electric motors (e.g., forming a hybrid drivetrain). The prime movers 5432 are configured to drive one or more of the tractive elements, lift elements, actuators, etc. to propel (e.g., navigate, position, orient, etc.) the vision agents 5450. In some embodiments, the vision agents 5450 omit the drive system 5430.

The sensors 5440 may include one or more location or environment sensors such as one or more accelerometers, gyroscopes, compasses, position sensors (e.g., global positioning system (GPS) sensors, etc.), inertial measurement units (“IMU”), suspension sensors, wheel sensors, audio sensors or microphones, cameras, optical sensors, proximity detection sensors, and/or other sensors to facilitate acquiring information or data regarding operation of the vision agents 5450 and/or the location thereof. In some embodiments, the sensors 5440 provide sensor data relating to the vision agents 5450 (e.g., a current status of the vision agents 5450) and the components thereof. In some embodiments, the sensors 5440 provide sensor data relating to the surroundings of the vision agents 5450 (e.g., detecting signals from assets on a worksite, detecting tracking tags 116, detecting assets, detecting nearby objects, detecting a slope of a support surface, etc.). The data acquired by the sensors 5440 may be used (e.g., by the vision system 5400) to facilitate determining a location of an asset (e.g., based on a detection of a tracking tag 116) and verifying that the asset associated with the tracking tag 116 is present in (e.g., corresponds to, matches, etc.) a detected location of the asset. In some embodiments, the data acquired by the sensors 5440 is used (e.g., by the vision system 5400) to facilitate autonomous or semi-autonomous operation of the vision agents 5450 (e.g., autonomous or semi-autonomous navigation and driving) and the components thereof (e.g., autonomous or semi-autonomous operation of the drive system 5430, etc.).

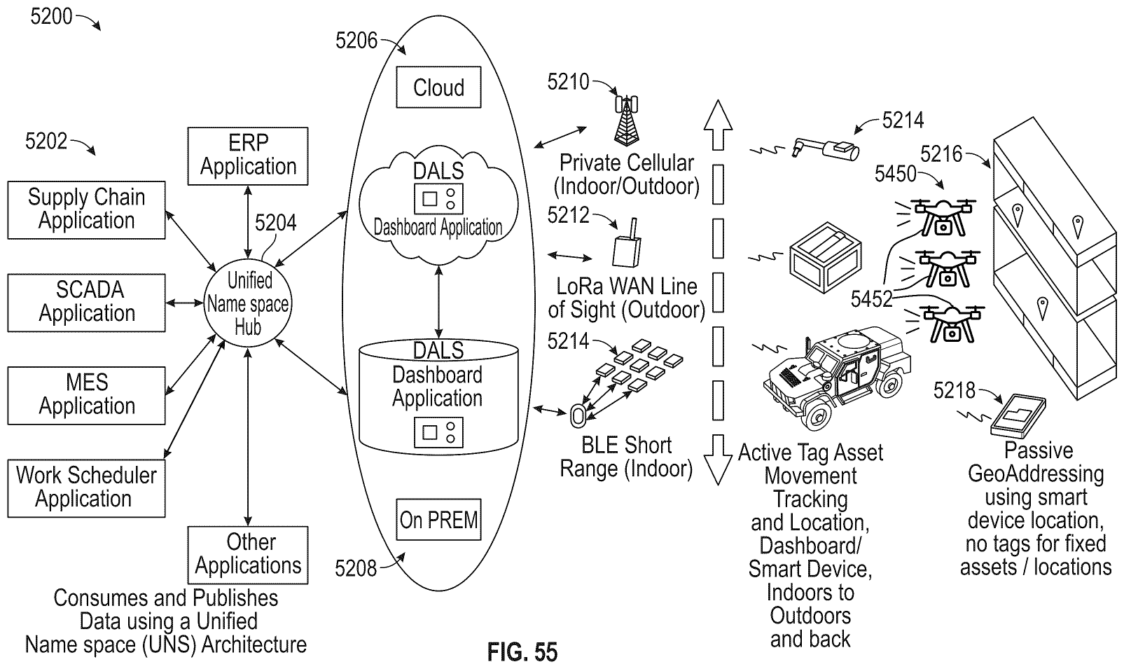

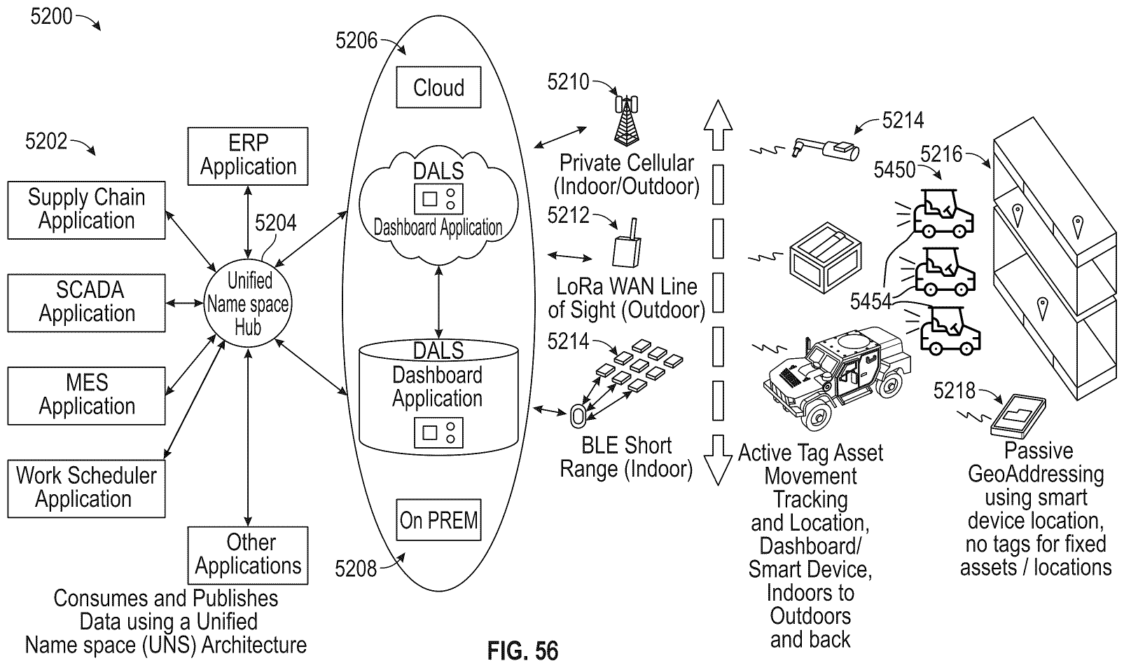

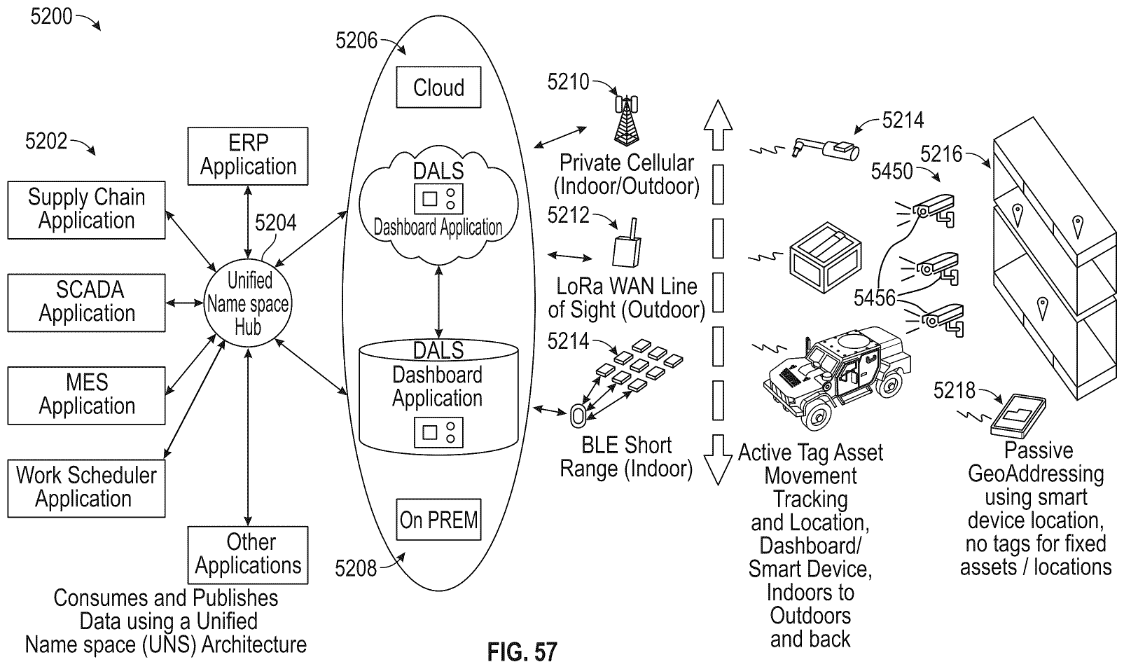

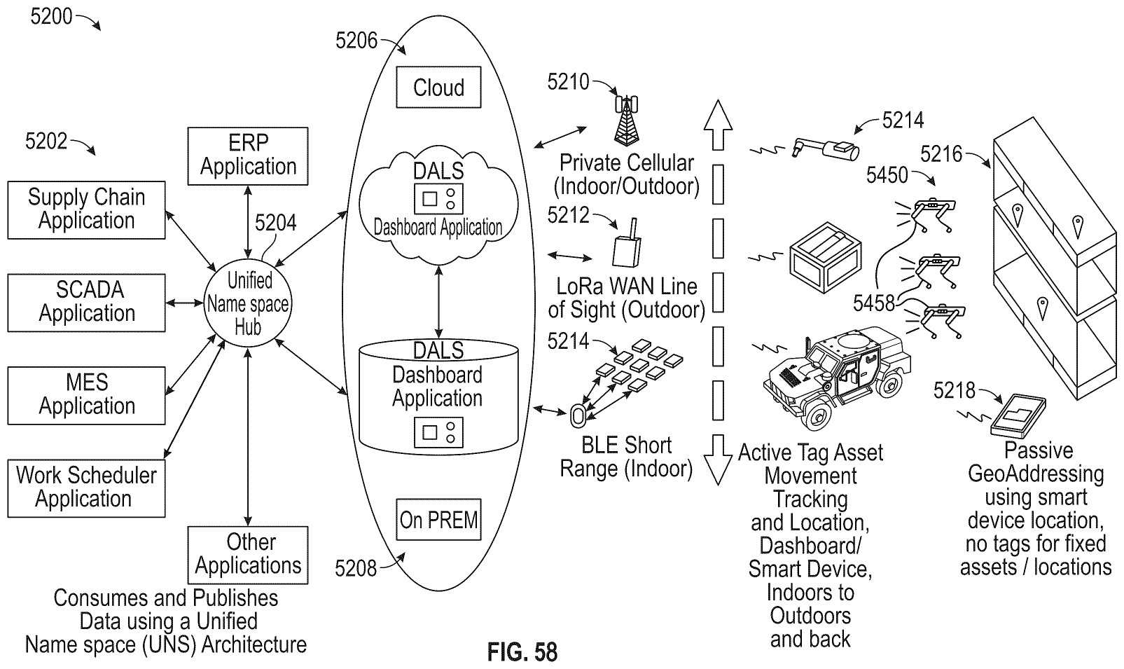

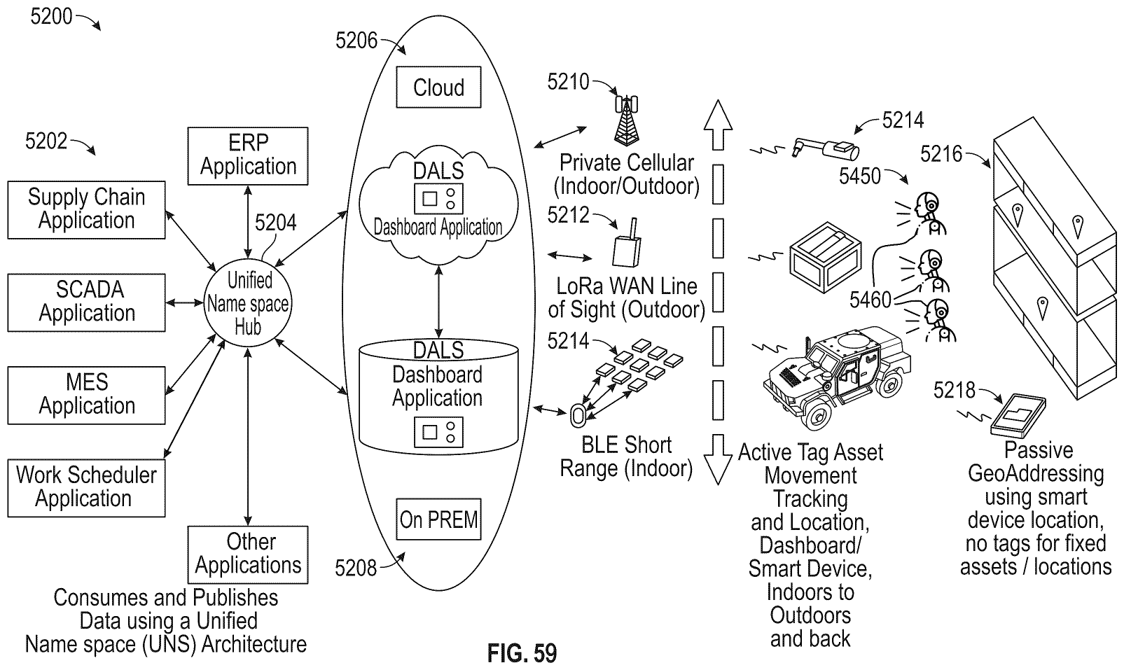

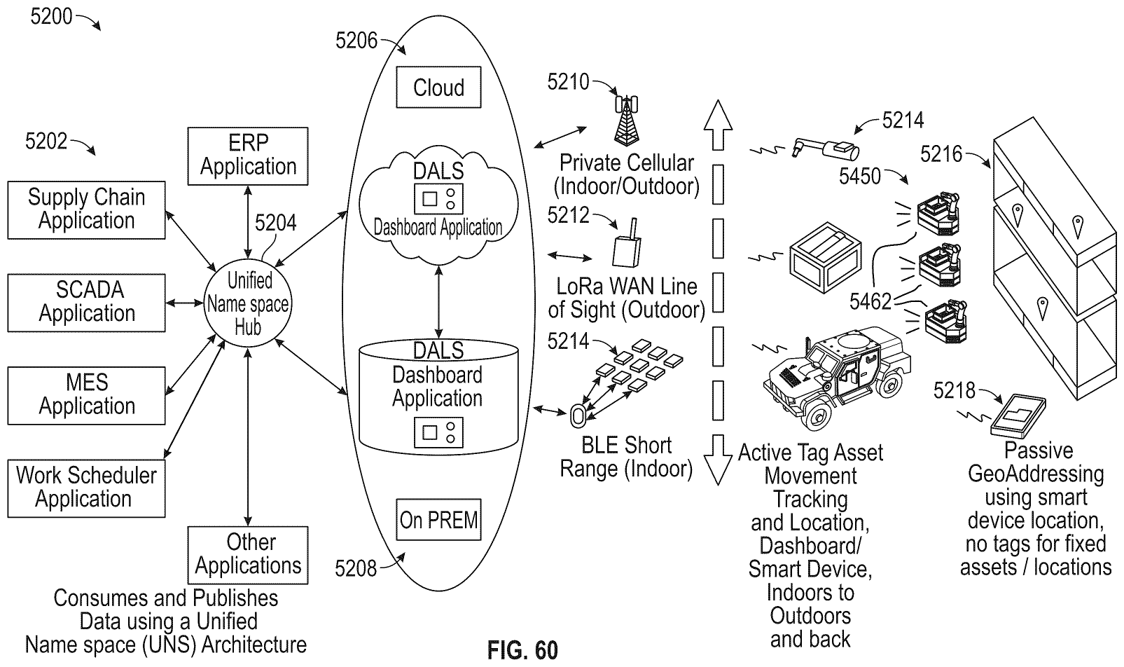

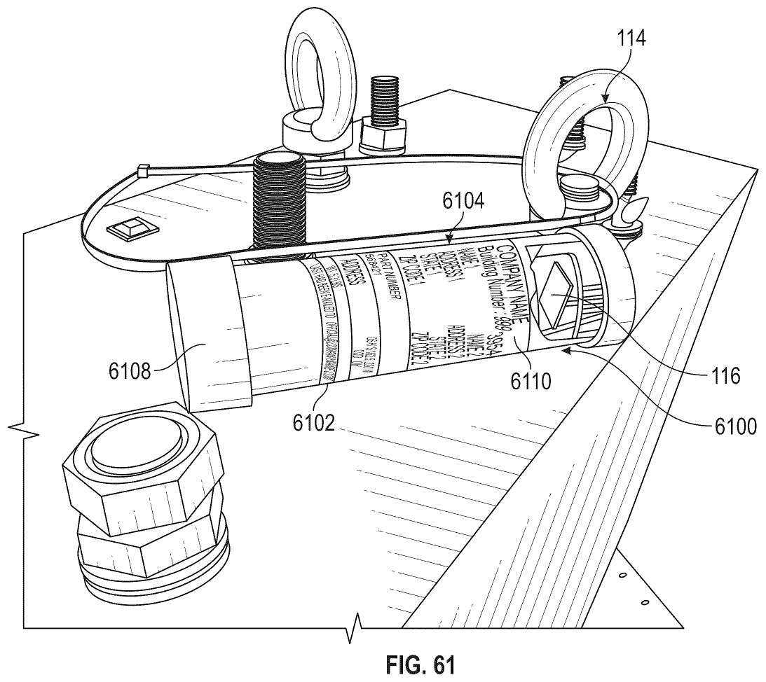

According to an exemplary embodiment, the vision agents 5450 are configured to be variously positioned about a worksite, such as a factory, warehouse, or construction site. As shown in FIGS. 55-59, the vision agents 5450 may include or be configured as aerial drones (e.g., unmanned aerial vehicles), shown as drones 5452, ground vehicles (e.g., autonomous ground vehicles, lift devices, such as a boom lift, a telehandler, an aerial work platform, a scissor lift, a vertical lift, a compact crawler boom, a forklift, a crane, a bucket truck, or another type of lift device, a military vehicle, a cement truck, a refuse vehicle, a fire apparatus, a tow truck, a golf cart, a personal transport vehicle, etc.), shown as vehicles 5454, cameras (e.g., security cameras, stationary cameras, body cameras, etc.), shown as cameras 5456, robotic quadrupeds (e.g., autonomous dogs), shown as robotic quadrupeds 5458, robotic humanoids (e.g., robots), shown as robotic bipeds 5460, and/or robotic implements (e.g., actuatable arms, actuatable grabbers, etc.), shown as robotic arms 5462.

The drones 5452, the vehicles 5454, the robotic quadrupeds 5458, and the robotic bipeds 5460 may include the drive system 5430 to facilitate navigating (e.g., propelling, driving, moving, etc.) the drones 5452, the vehicles 5454, the robotic quadrupeds 5458, and the robotic bipeds 5460 throughout the worksite. By way of example, the prime movers 5432 may be configured to drive rotational movement of the one or more lift elements of the drones 5452 to generate the necessary thrust to lift the drones 5452. In such an example, the prime movers 5432 can drive each of the lift elements independently to facilitate hovering, forward/backward movement, left/right movement, vertical movement, and rotational (e.g., roll, pitch, yaw) movement. By way of another example, the prime movers 5432 may be configured to move (e.g., actuate) one or more members (e.g., legs) of the robotic quadrupeds 5458 and the robotic bipeds 5460 independently to facilitate forward/backward movement and left/right movement thereof. In some embodiments, the cameras 5456 do not include the drive system 5430. By way of example, the cameras 5456 may be stationary cameras (e.g., security cameras, closed-circuit television (CCTV) cameras, etc.), LiDAR sensors, light sensors, etc. variously positioned throughout the worksite at fixed locations and orientations (e.g., a fixed field of view (FOV)). By way of another example, the cameras 5456 may be body cameras coupled with a user such as an operator at the worksite, a security guard, administrative personnel, etc. and configured to acquire vision data as the user navigates throughout the worksite. In other embodiments, the cameras 5456 include the drive system 5430 such as an actuator configure to move the cameras 5456 to adjust the orientation (e.g., the FOV) thereof. In some embodiments, the robotic arms 5462 include the drive system 5430 such as one or more actuators configured to actuate one or more members of the robotic arms 5462 relative to other members of the robotic arms 5462. In some embodiments, the sensors 5440 are coupled to the robotic arms 5462 such that actuation of the robotic arms 5462 moves the sensors 5440 (e.g., changes an FOV of the sensors 5440). In some embodiments, the robotic arms 5462 are coupled with and supported by the vehicles 5454 such that the vehicles 5454 transport the robotic arms 5462 throughout the worksite.

The vision system 5400 may be configured to control operation of the drive system 5430 of the vision agents 5450 to facilitate autonomously navigation thereof. By way of example, based on the sensor data acquired by the sensors 5440, the vision system 5400 may facilitate autonomous or semi-autonomous navigation and driving of the drones 5452, the vehicles 5454, the robotic quadrupeds 5458, and the robotic bipeds 5460 and the components thereof. By way of another example, based on the sensor data acquired by the sensors 5440, the vision system 5400 may facilitate autonomous or semi-autonomous control of an orientation of the cameras 5456. By way of still another example, the based on the sensor data acquired by the sensors 5440, the vision system 5400 may facilitate autonomous or semi-autonomous control of a position and orientation of the robotic arms 5462 and the components thereof. In such an example, the vision system 5400 may actuate a first actuator to move the robotic arms 5462 and may actuate a second actuator to move an implement (e.g., forks, grabbers, clamps, etc.) of the robotic arms 5462 to selectively engage with one or more objects (e.g., selectively engage with an asset 114 to reposition the asset 114).

In some embodiments, the vision system 5400 includes a plurality of vision agents 5450 variously positioned and navigable throughout the worksite. In such embodiments, the vision system 5400 includes vision agents 5450 of different types. By way of example, the vision system 5400 may include a plurality of stationary cameras 5456 configured to monitor the worksite and a plurality of vehicles 5454 navigating throughout the worksite and configured to monitor the worksite.

According to an exemplary embodiment, the controller 5402 is configured to control operation of the vision agents 5450. The controller 5402 includes a processing circuit, shown as processor 5404, and a memory device, shown as memory 5406. The memory 5406 may contain one or more instructions that, when executed by the processor 5404, cause the controller 5402 to perform the processes described herein. While some processes may be described as being performed by the controller 5402, it should be understood that those processes may be performed by any other controller of the vision system 5300, the asset management system 100, 200, 300, 4300, 4400, 4500, 4600, 4700, 4800, 4900, 5000, 5200, and/or 5300 or distributed across multiple controllers of the vision system 5300, the asset management system 100, 200, 300, 4300, 4400, 4500, 4600, 4700, 4800, 4900, 5000, 5200, and/or 5300. The controller 5402 may control the operator interface 5420 and the drive system 5430 to move the vision agents 5450 autonomously (e.g., without any directional control by an operator).

The vision system 5400 further includes a network interface, shown as communication interface 5408, operatively coupled to the controller 5402. The communication interface 5408 is configured to transfer data between the vision agents 5450 and other components of the vision system 5400 (e.g., other vision agents 5450, assets 114, tracking tags 116, controllers, user devices, servers, networks, etc.). The communication interface 5408 may facilitate wired and/or wireless communication. By way of example, the communication interface 5408 may facilitate communication with the assets 114 (e.g., directly with the assets 114, indirectly via the tracking tags 116), smart devices, and/or the DALS application 5206, 5208 via the cellular network 5210, via the LoRa WAN system 5212, or via the BLE connection 5214.

The memory 5406 may be any volatile or non-volatile computer-readable storage medium capable of storing data or computer code relating to the activities described herein. According to an exemplary embodiment, the memory 5406 includes computer code modules (e.g., executable code, object code, source code, script code, machine code, etc.) configured for execution by the processor 5404. As shown in in FIG. 54, the memory 5406 of the vision system 5400 includes an asset location module 5410 and an asset verification module 5412.

The asset location module 5410 is configured to perform asset location tracking procedures as discussed above. For example, the asset location module 5410 may be centralized and remotely accessible for displaying current, past, and predicting future geolocation of wirelessly tagged (e.g., by a tracking tag 116) assets (e.g., assets 114) such as tools, components, finished goods, etc., throughout an organization's digital ecosystem. The asset location module 5410 integrates geolocation technologies to determine three-dimensional positioning information of assets 114 with Bluetooth low energy (BLE), LoRa WAN, private cellular networks and/or any other wireless technologies. The information relating to the positioning of the assets 114 may be published to a centralized data pool that can be accessed by a variety of systems and applications. As discussed in greater detail above, the asset location module 5410 can identify, store, and provide three-dimensional geolocations of fixed assets 114. In some embodiments, the asset location module 5410 is configured to receive a location (e.g., a stored location) of a tracking tag 116 stored by the DALS application 5206, 5208. By way of example, the DALS application 5206, 5208 may store locations of tracking tags 116 associated with assets 114 and provide the stored locations to the vision system 5400 (e.g., to the asset location module 5410 via the communication interface 5408).

In some embodiments, the asset location module 5410 is configured to perform asset location tracking based on the data acquired from the sensors 5440 of the vision agents 5450. The sensors 5440 of the vision agents 5450 are configured to acquire data of the environment surrounding the vision agents 5450 as the vision agents navigate throughout the worksite. By way of example, the sensors 5440 may detect radio frequency signals from the tracking tags 116 and the smart devices (e.g., smartphones 120, tablets 124, etc.). The sensors 5440 may be configured to detect a signal strength from the tracking tags 116. A stronger signal from a tracking tag 116 may correlate to the tracking tag 116 being closer to a sensor 5440. Thus, the distance from a tracking tag 116 to a sensor may be estimated based on the signal strength (e.g., the RSSI). In some embodiments, vision system 5400 is configured to monitor the locations of two or more vision agents 5450 (e.g., based on data acquired by the sensors 5440) within the worksite and determine the location of an asset 114 by triangulating signals between the vision agents 5450 and the asset 114 (e.g., a tracking tag 116 couple with the asset 114). Based on the communication between the tracking tag 116 and the vision agents 5450, the asset location module 5410 may determine the location of the tracking tag 116. Based on the location of the tracking tag 116 (e.g., the stored location of the tracking tag 116 and/or the detected location of the tracking tag 116 based on the data acquired from the sensors 5440), the vision system 5400 may determine that the asset 114 corresponding with the tracking tag 116 is located at the location (e.g., the stored location or the detected location) of the tracking tag 116 (e.g., correlate the location of the tracking tag 116 with the location of the asset 114).

The asset verification module 5412 is configured to determine, based on the data acquired from the sensors 5440 (e.g., one or more sensors 5440 from one or more vision agents 5450), whether the asset 114 is located at the location of the tracking tag 116. The asset verification module 5412 may detect a characteristic or absence of a characteristic to determine whether the asset 114 is located at the location of the tracking tag 116. In some embodiments, the asset verification module 5412 is configured to perform object recognition on the data to verify whether the asset 114 is located at the location of the tracking tag 116. By way of example, the asset verification module 5412 may use an artificial intelligence model (e.g., convolutional neural network, etc.) trained on a dataset of known asset image data (e.g., known contours, edges, shapes, textures, colors of an asset) to perform the object recognition. The asset verification module 5412 may compare characteristics (e.g., visual features) from the data acquired from the sensors 5440 such as contours, edges, shapes, textures, colors, etc. against the features of the known asset image data to recognize the object (e.g., recognize the asset 114). In some embodiments, the asset verification module 5412 is configured to process the data acquired from the sensors 5440 using one or more other techniques (e.g., pose estimation, depth sensing, occlusion handling, etc.) to verify whether the asset 114 is located at the location of the tracking tag 116.

In some embodiments, the sensors 5440 are configured to detect one or more characteristics associated with an operation of the asset 114, and the asset verification module 5412 is configured to determine, based the characteristic (e.g., the presence or absence of the characteristic, the intensity of the characteristic, the type of the characteristic, etc.) whether the asset 114 is located at the location of the tracking tag 116. By way of example, the sensors 5440 may be configured to detect infrared radiation and the characteristic may include an infrared radiation signature such that the asset verification module 5412 may determine whether the asset 114 is located at the location of the tracking tag 116 based on the infrared radiation signature in the location. In such an example, responsive to a detection of a presence of an infrared radiation signature (e.g., indicative of assets 114 such as vehicles, tools, assets 114 capable of turning ON and OFF, assets 114 capable of generating heat, etc.) in the location exceeding a threshold level, the asset verification module 5412 may determine that the asset 114 is located at the location. By way of another example, the sensors 5440 may be configured to detect an asset 114 (e.g., a location of the asset 114, a presence or absence of the asset 114) based on establishing communication with (e.g., based on an RFID or BLE signal from the asset 114, detecting a signal sent from the asset 114, detecting etc.) the asset 114. In such an example, the asset verification module 5412 may determine that the asset 114 is located at the location based on the communication with the asset 114. By way of still another example, the sensors 5440 may be configured to detect an audible sound (e.g., ultrasonic sounds, the sound of a motor of the asset 114 running, a sound of a component of the asset 114 moving, etc.). In such an example, the asset verification module 5412 may determine that the asset 114 is located at the location based on a detection of an audible sound associated with the asset 114 emitted from the location. In yet other examples, the sensors 5440 may be configured to detect other radiation types, wavelengths, frequencies, etc. along the electromagnetic spectrum for the asset verification module 5412 to determine whether the asset 114 is located at the location.

In some embodiments, the asset verification module 5412 is configured to determine, based on the data acquired from the sensors 5440, a type of the asset 114. By way of example, the asset verification module 5412 may determine whether the asset 114 is a work machine (and what type of work machine such as a boom lift, a telehandler, an aerial work platform, a scissor lift, a vertical lift, a compact crawler boom, a forklift, a crane, a bucket truck, or another type of lift device, a military vehicle, a cement truck, a refuse vehicle, a fire apparatus, a tow truck, a golf cart, a personal transport vehicle, etc.), a tool, a piece of equipment (e.g., a motor, an actuator, a chassis, a door, etc.), a piece of inventory stored on the worksite, or any other type of asset. Based on the results from the techniques described above, the asset verification module 5412 is configured to verify whether the asset 114 is located in the location indicated by the location of the tracking tag 116 (e.g., the tracking tag 116 associated with the asset 114). By way of example, the asset verification module 5412 may verify that the asset 114 is located in the location of the tracking tag 116 responsive to a detection of the asset 114 in the location of the tracking tag 116.

The tracking tag 116 may undesirably or inadvertently detach from (e.g., be removed from, decouple from, fall off of, etc.) the asset 114. By way of example, the tracking tag 116 may detach from the asset 114 during transportation, manufacturing, operation, etc. of the asset 114, as a result of a user removing the tracking tag 116 from the asset 114, as a result of malfunctioning fasteners used to couple the tracking tag 116 with the asset 114, or be separated from the asset 114 for any other reason. In some embodiments, after the tracking tag 116 is detached from the asset 114, the location of the asset 114 changes (e.g., the asset 114 is performing a task at a different location on the worksite, the asset 114 is sold and shipped, the asset 114 is manually relocated, etc.), while the location of the tracking tag 116 stays the same. In some embodiments, the after the tracking tag 116 is detached from the asset 114, the location of the tracking tag 116 changes (e.g., the tracking tag 116 is manually relocated), while the location of the asset 114 stays the same. Because of the discrepancy between the locations of the asset 114 and the tracking tag 116 (e.g., the asset 114 and the tracking tag 116 not being in the same location), the vision system 5400 may determine, based on the location of the tracking tag 116 in a respective location, that the asset 114 is located in the respective location (e.g., the location associated with the tracking tag 116) when in reality, the location of the asset 114 is not located in the respective location. In such an example, the vision system 5400 may undesirably determine that the asset 114 is present in the respective location when in reality, the asset 114 is not present in the respective location.

To correct (e.g., adjust for, account for, etc.) the undesirable determination that the asset 114 is present in the respective location as a result of the tracking tag 116 being separated from the asset 114, the vision system 5400 is configured to verify whether the asset 114 is or is not located in the same location as the location (e.g., the stored location or the detected location) of the tracking tag 116 using the asset verification module 5412. In some embodiments, after receiving a stored location of a tracking tag 116, the vision system 5400 is configured to acquire data of an FOV including the stored location, and determine, based on the acquired data (e.g., a characteristic associated with the asset 114 and/or the stored location) if an asset 114 is present in the FOV. In such embodiments, if the asset 114 is present in the FOV, the asset verification module 5412 may determine (e.g., calculate based on triangulation techniques between two or more vision agents 5450 and the asset 114) a calculated location of the asset 114 and compare the calculated location to the stored location to determine whether or not the calculated location is different than the stored location. By way of example, after receiving the stored location of the tracking tag 116, the vision system 5400 may (i) control operation of one or more of the vision agents 5450 (e.g., the drones 5452, the vehicles 5454, the robotic quadrupeds 5458, the robotic bipeds 5460, the robotic arms 5464) to navigate to the stored location or otherwise move to acquire data (e.g., using the sensors 5440) of an FOV including the stored location and/or (ii) gather data from one or more cameras 5456 of an FOV including the stored location. In some embodiments, after detecting a location of a tracking tag 116 the vision system 5400 is configured to acquire data of an FOV including the detected location, and determine, based on the acquired data if an asset 114 is present in the FOV. In such embodiments, if the asset 114 is present in the FOV, the asset verification module 5412 may determine (e.g., calculate based on triangulation techniques between two or more vision agents 5450 and the asset 114) a calculated location of the asset 114 and compare the calculated location to a stored location associated with the detected tracking tag 116 to determine whether or not the calculated location is different than the stored location. By way of example, if the asset location module 5410 detects a tracking tag 116 or receives location data of a tracking tag 116 in a respective location and the asset verification module 5412 detects an asset 114 in the respective location, the vision system 5400 may verify that the asset 114 is actually present in the respective location associated with the tracking tag 116. By way of another example, if the asset location module 5410 detects a tracking tag 116 in a respective location and the asset verification module 5412 does not detect an asset 114 in the respective location, the vision system 5400 may determine that the asset 114 is not present in the respective location associated with the tracking tag 116, thereby preventing a false-positive determination (e.g., a determination that the asset 114 is present in the respective location when in reality it is not).

According to an exemplary embodiment, if the asset verification module 5412 determines that the stored location of the tracking tag 116 is different than (e.g., not the same as) the calculated location of the asset 114, the asset verification module 5412 is configured to update the stored location to be the calculated location. By way of example, upon determining that the asset 114 is not in the stored location, the asset verification module 5412 may transmit a signal to the DALS application 5206, 5208 to update the stored location of the stored location with the calculated location. In some embodiments, if the asset verification module 5412 determines that the stored location of the tracking tag 116 is different than the calculated location of the asset 114, the vision system 5400 is configured to provide an indication of the discrepancy between the locations. In some embodiments, if the asset 114 is not present in the FOV, the vision system 5400 is configured to provide an indication of the asset 114 not being present in the FOV including the stored location or the detected location of the tracking tag 116. By way of example, the indication may include a warning, alert, message, etc. displayed on or audibly output by the vision agents 5450 (e.g., by the output devices 5422), the DALS application 5206, 5208, the smartphone 120, the tablet 124, etc. such that a user can take corrective actions to account for or otherwise resolve the discrepancy between the locations. In some embodiments, if the asset verification module 5412 determines that the stored location of the tracking tag 116 is the same as (e.g., not different than, substantially the same as, etc.) the calculated location of the asset 114, the vision system 5400 is configured to verify (e.g., by providing an indication) or otherwise confirm that the stored location is correct (e.g., that the asset 114 is located in the location indicated by the tracking tag 116 associated therewith).

In some embodiments, the asset verification module 5412 is configured to verify whether the type of the asset 114 detected in a respective location of a tracking tag 116 matches or otherwise corresponds with the type of asset 114 associated with the tracking tag 116. By way of example, a tracking tag 116 associated with a first asset 114 of a first type may be detected in a respective location, and the asset verification module 5412 may detect that a second asset 114 of a second type different than the first type is located in the respective location. By way of another example, the asset verification module 5412 may gather data of an FOV including the stored location of a tracking tag 116 associated with a first asset 114 of a first type, and determine, based on the gathered data of the FOV, that a second asset 114 of a second type different than the first type is located in the stored location. In such an example, the asset verification module 5412 may (i) detect that the type of the second asset 114 does not match the type of the first asset 114 associated with the tracking tag 116 (e.g., by querying through the data stored in the DALS application 5206, 5208 to determine whether the detected type of the asset 114 matches the type of the asset 114 corresponding to the detected tracking tag 116) and (ii) determine that the first asset 114 is not located in the respective location or the stored location. Further, in such an example, even though the asset verification module 5412 may detect an asset 114 in the respective location or the stored location, the asset verification module 5412 may analyze the data acquired from the sensors 5440 to determine whether the detected asset 114 matches the asset 114 associated with the tracking tag 116. In some embodiments, if the asset verification module 5412 determines that the detected asset 114 does not match the asset 114 associated with the tracking tag 116, the asset verification module 5412 is configured to provide an indication of such. In other embodiments, if the asset verification module 5412 determines that the detected asset 114 does not match the asset 114 associated with the tracking tag 116, the asset verification module 5412 is configured to update the asset 114 associated with the tracking tag 116 to be the detected asset 114. In some embodiments, if the asset verification module 5412 determines that the detected asset 114 does match the asset 114 associated with the tracking tag 116, the asset verification module 5412 is configured to verify (e.g., by providing an indication) or otherwise confirm the same.

As shown in FIG. 61, the tracking tag 116 is coupled with an enclosure (e.g., a tube, a canister, a box, etc.), shown as vessel 6100. The vessel 6100 may be selectively and removably coupled with an asset 114 (e.g., via one or more fasteners, cables, adhesives, etc.) such that the tracking tag 116 is coupled with the asset 114 via the vessel 6100. The vessel 6100 includes a housing (e.g., enclosure, walls, casing, shell, tube, etc.), shown as housing 6102, defining an interior volume, shown as interior chamber 6104. The housing 6102 includes a window (e.g., a transparent surface) by which to see inside of the vessel 6104 (e.g., to see the objects stored in the interior chamber 6104 from outside of the interior chamber 6104). In some embodiments, the housing 6102 does not include the window. As shown in FIG. 61, the vessel 6100 includes an end cap (e.g., door, hatch, etc.), shown as lid 6108, configured to selectively couple with the housing 6102 to provide selective access to the interior chamber 6104. The vessel 6100 is configured to contain (e.g., house, store, etc.) one or more objects within the interior chamber 6104. In some embodiments, the vessel 6100 is configured to protect the objects disposed within the interior chamber 6104 from the external environment (e.g., the vessel 6100 is waterproof, fireproof, dustproof, etc.). As shown in FIG. 61, the tracking tag 116 is disposed within the interior chamber 2104 of the housing 6102. In some embodiments, the tracking tag 116 is otherwise coupled with the vessel 6100. As shown in FIG. 61, the vessel 6100 is configured to receive one or more pieces of paperwork (e.g., asset identification information), shown as information 6110. The information 6110 may include information associated with the asset 114 with which the vessel 6100 is coupled. By way of example, the information 6110 may identify the type of the asset 114, part numbers, a company name, a company address, shipping information, a weight of the asset 114, dates (e.g., a date the asset 114 was received), maintenance logs, calibration records, operation instructions, barcodes, QR codes, or any other information associated with the asset 114. The information 6110 may be displayed on one or more pieces of paper, plastic, metal, etc. The information 6110 may be disposed within the interior chamber 6104 of the vessel 6100 such that the information 6110 is visible through the window of the housing 6102. By way of example, a user may be able to read the information 6110 while the information 6110 is stored withing the vessel 6100. By way of another example, the sensors 5440 may be configured to read the information 6110 while the information 6110 is stored withing the vessel 6100.

### Configuration of Exemplary Embodiments

As utilized herein, the terms “approximately,” “about,” “substantially”, and similar terms generally mean +/−10% of the disclosed values and are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality is shown in FIG. 1, it should be understood that the local controller 130 may include any number of circuits for completing the functions described herein. For example, the activities and functionalities of the asset management system 100 may be combined in multiple circuits or as a single circuit. Additional circuits with additional functionality may also be included. Further, the local controller 130 may further control other activity beyond the scope of the present disclosure.

As mentioned above and in one configuration, the “circuits” of the local controller 130, sensors 112, gateways 202, or smart devices may be implemented in machine-readable medium for execution by various types of processors. An identified circuit of executable code may, for instance, include one or more physical or logical blocks of computer instructions, which may, for instance, be organized as an object, procedure, or function. Nevertheless, the executables of an identified circuit need not be physically located together, but may include disparate instructions stored in different locations which, when joined logically together, form the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example, the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although this description may discuss a specific order of method steps, the order of the steps may differ from what is outlined. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system for locating an asset on a worksite, the system comprising:
one or more processing circuits configured to:
receive a stored location of a tracking tag;
capture data within a field of view including the stored location;
determine, based on the data, if an asset is present in the field of view;
upon determining that the asset is present in the field of view, compare the stored location to a calculated location of the asset;
upon determining that the stored location is different than the calculated location, at least one of (i) update the stored location to be the calculated location or (ii) provide an indication of a difference between the stored location and the calculated location; and
upon determining that the asset is missing from in the field of view, generate an indication indicating that the asset is missing from the field of view.

2. The system of claim 1, wherein the one or more processing circuits are configured to capture the data of the field of view including the stored location from at least one sensor.

3. The system of claim 2, wherein the at least one sensor is coupled with at least one vision agent, and wherein the at least one vision agent is one of a camera, an aerial drone, a ground vehicle, a robotic quadruped, or a robotic biped.

4. The system of claim 3, wherein the camera includes at least one of a stationary camera or a body camera.

5. The system of claim 4, wherein the one or more processing circuits are configured to gather the data acquired from the stationary camera or the body camera having a field of view including the stored location.

6. The system of claim 3, wherein the one or more processing circuits are configured to facilitate autonomous control and navigation of the aerial drone, the robotic quadruped, or the robotic biped to the stored location to capture the data of the field of view including the stored location.

7. The system of claim 3, wherein the one or more processing circuits includes at least one of (i) a first processing circuit located on the at least one vision agent or (ii) a second processing circuit located remote from the at least one vision agent.

8. The system of claim 3, wherein the calculated location is based on a triangulation between two vision agents and the asset.

9. The system of claim 2, wherein the one or more processing circuits are configured to detect a location of the tracking tag based on signals detected by the at least one sensor from the tracking tag, wherein the signals detected by the at least one sensor each comprise a received signal strength indicator (RSSI), and wherein determining the location of the asset comprises performing a geometrical calculation based on the location the at least one sensor and the RSSI detected by the at least one sensor.

10. The system of claim 1, wherein the tracking tag is configured to be coupled with the asset using a vessel, the vessel including a housing defining an interior chamber configured to receive the tracking tag and paperwork associated with the asset, and wherein the housing includes a window such that the paperwork within the interior chamber is visible to a user outside of the interior chamber.

11. The system of claim 1, wherein the one or more processing circuits are configured to at least one of (i) determine if the asset is present in the field of view or (ii) determine the calculated location based on a detection of a characteristic or an absence of the characteristic in the data.

12. The system of claim 11, wherein the characteristic includes at least one of a contour, edge, shape, texture, or color of the asset, and wherein the one or more processing circuits are configured to perform object recognition to at least one of (i) determine if the asset is present in the field of view or (ii) determine the calculated location.

13. The system of claim 11, wherein the characteristic includes infrared radiation or an audible sound.

14. The system of claim 1, wherein the one or more processing circuits are configured to determine a type of the asset, wherein the tracking tag is associated with and configured to be coupled with a first asset of a first type, and wherein, when the one or more processing circuits detect a second asset of a second type different than the first type at the stored location, the one or more processing circuits are configured to determine that the first asset is missing from the stored location.

15. A system for locating an asset on a worksite, the system comprising:
one or more processing circuits comprising one or more memory devices coupled to one or more processors, the one or more memory devices configured to store instructions thereon that, when executed by the one or more processors, cause the one or more processors to:
receive a stored location of a tracking tag;
capture data from a plurality of vision agents of a field of view including the stored location, the data including a characteristic indicative of a presence or absence of an asset in the field of view;
determine, based on the characteristic, if the asset is present in the field of view;
upon determining that the asset is present in the field of view, compare the stored location to a calculated location of the asset;
upon determining that the stored location is different than the calculated location, update the stored location to be the calculated location and provide an indication of a difference between the stored location and the calculated location; and
upon determining that the asset is missing from in the field of view, generate an indication indicating that the asset is missing from the field of view.

16. The system of claim 15, wherein each vision agent of the plurality of vision agents is one of a camera, an aerial drone, a ground vehicle, a robotic quadruped, or a robotic biped.

17. The system of claim 16, wherein the instructions cause the one or more processors to autonomously control navigation of the aerial drone, the robotic quadruped, or the robotic biped to the stored location to capture the data of the field of view including the stored location.

18. The system of claim 15, wherein the calculated location is based on a geometric calculation between two or more vision agents of the plurality of vision agents and the asset.

19. The system of claim 15, wherein the characteristic includes at least one of a contour, edge, shape, texture, color, infrared radiation, or audible sound.

20. A system for locating an asset on a worksite, the system comprising:
a non-transitory computer-readable medium having instructions stored thereon that, when executed by one or more processors, cause the one or more processors to:
receive a stored location of a tracking tag;
capture data from a plurality of vision agents of a field of view including the stored location, the data including a characteristic indicative of a presence or absence of an asset in the field of view;
determine, based on the characteristic, if the asset is present in the field of view;
upon determining that the asset is present in the field of view, compare the stored location to a calculated location of the asset;
upon determining that the stored location is different than the calculated location, at least one of (i) update the stored location to be the calculated location or (ii) provide an indication of a difference between the stored location and the calculated location; and
upon determining that the asset is missing from in the field of view, generate an indication indicating that the asset is missing from the field of view.
